(19) United States
(12) Patent Application Publication
(10) Pub. No.: US 2014/0284278 A1
(43) Pub. Date: Sep. 25, 2014

(54) CATIONIC DISPLACER MOLECULES FOR HYDROPHOBIC DISPLACEMENT CHROMATOGRAPHY

(71) Applicant: SACHEM, INC., Austin, TX (US)

(72) Inventor: Barry L. Haymore, Austin, TX (US)

(21) Appl. No.: 14/349,109

(22) PCT Filed: Oct. 3, 2012
(86) PCT No.: PCT/US2012/058546

§ 371 Date: Apr. 2, 2014

Related U.S. Application Data
(60) Provisional application No. 61/542,424, filed on Oct. 3, 2011.
(60) Provisional application No. 61/542,370, filed on Oct. 3, 2011.

(51) Int. Cl. B01D 15/42

(52) U.S. Cl. CPC B01D 15/426
USPC 210/656

(57) ABSTRACT

A process for separating organic compounds from a mixture by reverse-phase displacement chromatography, including providing a hydrophobic stationary phase; applying to the hydrophobic stationary phase a mixture comprising organic compounds to be separated; displacing the organic compounds from the hydrophobic stationary phase by applying thereto an aqueous composition comprising a non-surface active hydrophobic cationic displacer molecule and about 10 wt % or less of an organic solvent; and collecting a plurality of fractions eluted from the hydrophobic stationary phase containing the separated organic compounds; in which the non-surface active hydrophobic cationic displacer molecule comprises a hydrophobic cation and a counterion, CI, having the general formula A or B, as defined in the disclosure:

### BACKGROUND

Displacement chromatography (DC) in one of the three well-defined forms of column chromatography—elution, displacement, frontal. DC is principally a preparative method, but there are also analytical applications using “micropreparative” DC with packed “narrow-bore” or capillary columns.

Displacement chromatography may be carried out using any one of four general chromatographic methods when suitable, high-purity displacer molecules are available. DC is used in (a) ion-exchange chromatography (cation-exchange, anion-exchange), (b) hydrophobic chromatography (reversed-phase, hydrophobic-interaction, hydrophobic charge-induction, thiophilic), (c) normal-phase chromatography including hydrophilic-interaction chromatography (HILIC) and (d) immobilized metal-ion affinity chromatography (IMAC).

With optimized DC, one may obtain, simultaneously, high purity (high resolution), high recovery (high yield) and high column loading (high capacity)—the latter much higher than overloaded preparative elution chromatography. In most cases, these advantages more than compensate for the disadvantages of DC (slower flow-rates, longer run-times, need for high-purity displacers).

Displacement chromatography is carried out by choosing (a) an applicable chromatographic method, (b) a suitable chromatography column with proper dimensions, (c) proper mobile phase conditions, (d) a suitable displacer molecule and (e) suitable operation protocols with properly configured LC equipment. Initially, a suitable “weakly displacing mobile phase” (carrier) is chosen, and the column is equilibrated at a suitable flow-rate. The carrier may contain a pH-buffering compound adjusted to a useful pH value. Optimal displacement flow-rates tend to be low, typically in the range of 35-105 cm/hr, though sometimes higher. A suitable amount of the sample solution is loaded onto the column at the sample-loading flow-rate. The sample solution contains the material to be purified in the carrier along with the proper level of an ion-pairing agent if the sample or displacer molecules are charged. Typical sample loadings are 50-80% of the operative breakthrough capacity. Next, a displacer mobile phase (displacer buffer), prepared from a suitable displacer compound at the proper concentration in the carrier solution, is pumped onto the column at the displacement flow-rate until the displacer breakthrough is observed. The purified sample comes off the column before the displacer breakthrough front. Fractions from the column are collected and separately analyzed for content and purity. Finally, the displacer is removed from column using a “displacer removal solution”, and then the column is cleaned and regenerated to its original state for storage or for subsequent use.

Though different from elution chromatography, in some respects, displacement chromatography is easy to understand and easy to carry out. In DC, a sample is “displaced” from the column by the displacer, rather than “eluted” from the column by the mobile phase. When the output of the column is monitored online (e.g., via UV absorption, pH, or conductivity), a “displacement train” is obtained rather than an “elution chromatogram”. The displacement train is composed of side-by-side “displacement bands” rather than solvent-separated “elution peaks” in a chromatogram. When a displacement band is large enough to saturate the stationary phase, a trapezoidal “saturating band” is formed. When a displacement band is not large enough to saturate the stationary phase, a small, triangular “non-saturating band” is formed. The height of a saturating band is determined by the binding-isotherm at the point of operation; the area of a trapezoid-band or a triangle-band is proportional to the amount of the component.

Hydrophobic chromatography depends almost exclusively on the unique solvation properties of water that result from the highly structured, self-associated, hydrogen-bonded liquid. For conventional reversed-phase chromatography stationary phases (uncharged C₁₈ column), binding is usually driven by entropy (+TΔS), which often must overcome unfavorable enthalpy (+ΔH). Thus, over the temperature ranges often used by chromatographers (10-70° C.), analyte-binding and displacer-binding often become stronger with increasing temperature. Another useful feature of hydrophobic chromatography is the use of additives that modify both the structure and strength of the self-hydrogen-bonding of the aqueous-based solvent. These additives include: salts (NaCl, K₂HPO₄, (NH₄)₂SO₄), organic solvents (MeCN, MeOH, EtOH) and polar organic molecules (urea, oligo-ethyleneglycol) in chromatography buffers.

Hydrophobic displacement chromatography can be carried out using chiral analytes, chiral displacers and chiral chromatography matrices. Under these conditions, an achiral displacer may be used, but a racemic mixture of a chiral displacer cannot be used. Racemic chiral analytes can also be purified using an achiral chromatography column and an achiral displacer. In this case, impurities, including diastereomers, are removed from the racemic compound of interest, but there is no chiral resolution of the enantiomers. With the proper choice of chiral chromatography matrix, mobile phase and achiral displacer, enantiomers are routinely preparatively resolved (separated). Depending on the specific circumstances, a good, enantiomerically pure, chiral displacer can have performance advantages over a good achiral displacer when carrying out a displacement separation of enantiomers on a chiral stationary phase.

Development of useful, preparative hydrophobic displacement chromatography has been hampered by the unavailability of suitable, high-purity displacer molecules. We describe here new displacer molecules and methods to use them that have utility in various forms of hydrophobic displacement chromatography.

Hydrophobic displacer molecules should possess a unique combination of chemical and physical properties in order for them to function efficiently. Some soluble, hydrophobic molecules can function as displacers, but only a limited few function well. Many of the molecules described in this document fulfill the necessary requirements for well-functioning displacers.

Development of useful, reversed phase, preparative displacement chromatography has been hampered by the unavailability of suitable, high-purity displacer molecules. For example, U.S. Pat. No. 6,239,262 describes various reversed phase liquid chromatographic systems using low molecular weight surface-active compounds as displacers. U.S. Pat. No. 6,239,262 discloses an extremely wide range of possible charged moieties that may be coupled with hydrophobic moieties to form the disclosed surface active compounds used as displacers, but discloses that it is necessary to include a large proportion of organic solvent to mitigate the surface active properties of the disclosed displacers. The presence of such large proportions of organic solvents significantly alters the process, derogating from the benefits of reverse-phase hydrophobic displacement chromatography. In addition, the surface-active displacer compounds disclosed by U.S. Pat. No. 6,239,262 do not function well, resulting in relatively poor quality displacement trains in which a significant level of impurities may be present in the “purified” products.

### SUMMARY

The development of useful, preparative hydrophobic displacement chromatography has been hampered by the unavailability of suitable, high-purity displacer molecules that function well and can be easily detected. We describe here a new class of cationic displacer molecules and methods to use them that have utility in various forms of hydrophobic displacement chromatography.

Many commercial, small cationic molecules simply don't bind to hydrophobic stationary phases well enough, while many large cationic molecules that do bind well enough either lack sufficient solubility or are plagued with detergency problems that lead to lower resolution, lower column capacity for the analyte and unwanted foaming. We find that many intermediate-sized cationic molecules, when properly designed, possess the unique combination of chemical and physical properties, including proper UV absorption, in order for them to function efficiently as hydrophobic displacers. It is true enough that there are some soluble, cationic hydrophobic molecules that can function as displacers, but only a limited few function well. Many of the molecules described in this document fulfill the necessary requirements for well-functioning displacers when used according to established displacement protocols.

We have discovered and developed classes of charged hydrophobic organic compounds, either salts or zwitterions, that uniquely posses that combination of chemical and physical properties necessary for good displacer behavior in hydrophobic displacement chromatography.

Accordingly, the present invention, in one embodiment, relates to a process for separating organic compounds from a mixture by reverse-phase displacement chromatography, comprising:

providing a hydrophobic stationary phase;

applying to the hydrophobic stationary phase a mixture comprising organic compounds to be separated;

displacing the organic compounds from the hydrophobic stationary phase by applying thereto an aqueous composition comprising a non-surface active hydrophobic cationic displacer molecule and about 10 wt % or less of an organic solvent; and

collecting a plurality of fractions eluted from the hydrophobic stationary phase containing the separated organic compounds;

wherein the non-surface active hydrophobic cationic displacer molecule comprises a hydrophobic cation and a counterion, CI, having the general formula A or B:

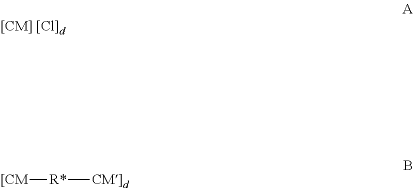

wherein in the general formulae A and B, each CM or CM′ is an independent hydrophobic chemical moiety with a formal charge selected from: quaternary ammonium (I), quaternary phosphonium (II), sulfonium (III), sulfoxonium (IV), imidazolinium (amidinium) (V), guanidinium (VI), imidazolium (VII), 1,2,3,4-tetrahydroisoquinolinium (VIII), 1,2,3,4-tetrahydroquinolinium (IX), isoindolinium (X), indolinium (XI), benzimidazolium (XII), pyridinium (XIIIa, XIIIb, XIIIc, XIIId), quinolinium (XIV), isoquinolinium (XV), carboxylate (XVI), N-acyl-α-amino acid (XVII), sulfonate (XVIII), sulfate monoester (XIX), phosphate monoester (XX), phosphate diester (XXI), phosphonate monoester (XXII), phosphonate (XXIII), tetraaryl borate (XXIV), boronate (XXV), boronate ester (XXVI); wherein the chemical moieties (I)-(XXVI) have the following chemical structures:

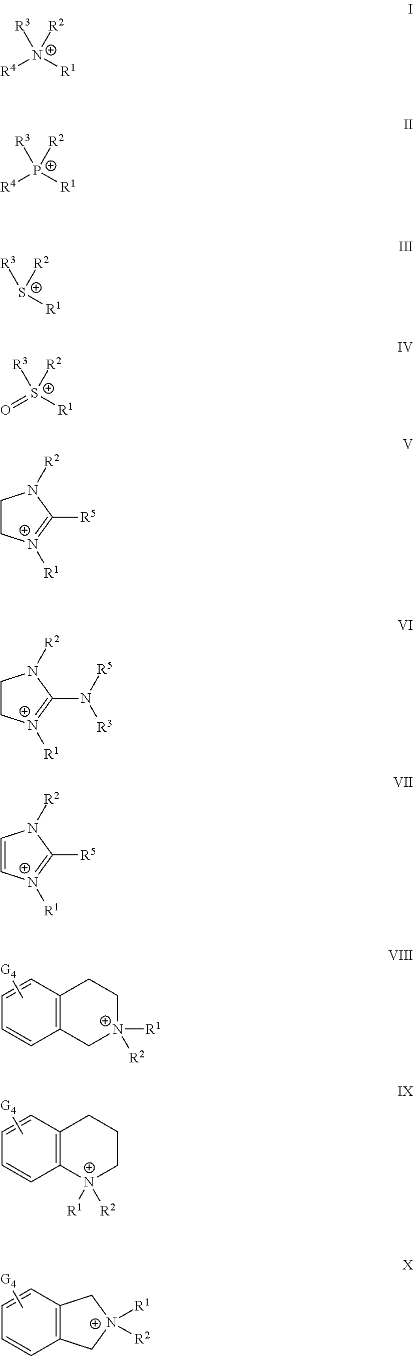

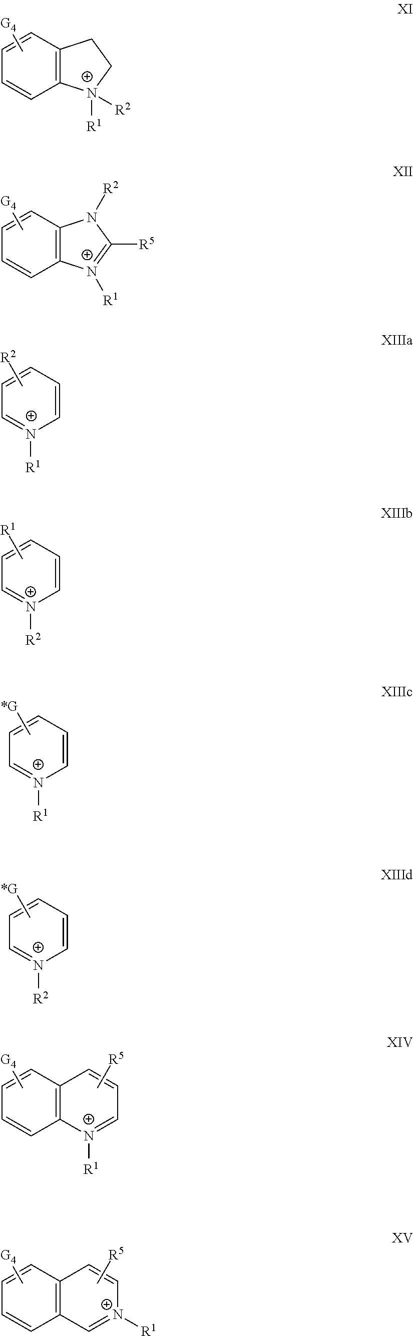

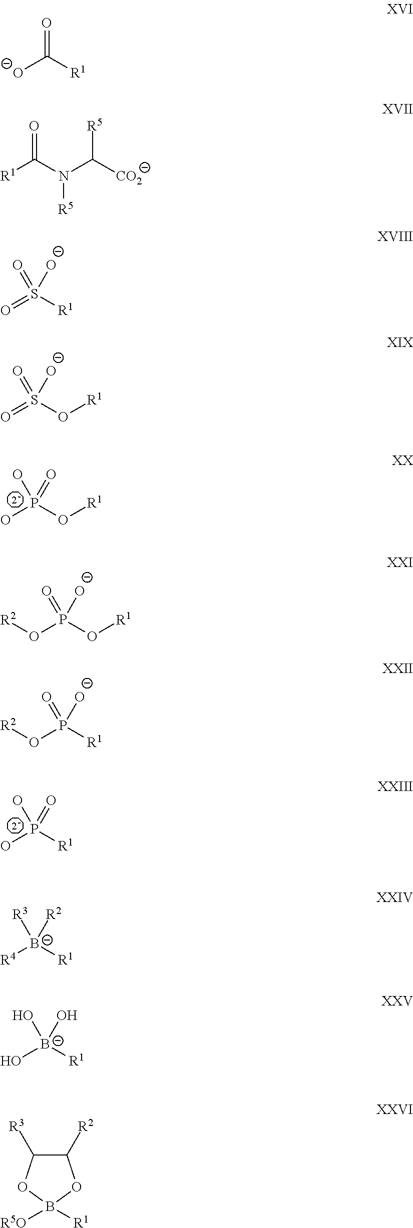

wherein in general formula B, CM and CM′ are independent charged chemical moieties having the same or opposite formal charge and are chemically attached to each other by a doubly connected chemical moiety, R*, which replaces one R¹, R² (if present), R³ (if present) or R⁴ (if present) chemical moiety on CM and replaces one R¹, R² (if present), R³ (if present) or R⁴ (if present) chemical moiety on CM′;

wherein each of R¹, R², R³ and R⁴ is a linear or branched chemical moiety independently defined by the formula,

—CₓX₂ₓ₋₂ᵣ-AR¹—CᵤX₂ᵤ₋₂ₛ-AR²,

R* is a direct chemical bond or is a doubly connected, linear or branched chemical moiety defined by the formula,

—CₓX₂ₓ₋₂ᵣ-AR¹—CᵤX₂ᵤ₋₂ₛ—,

and R⁵ is a linear or branched chemical moiety defined by the formula,

—CₓX₂ₓ₋₂ᵣ-AR²;

wherein each AR¹ independently is a doubly connected methylene moiety (—CX¹X²—, from methane), a doubly connected phenylene moiety (—C₆G₄-, from benzene), a doubly connected naphthylene moiety (—C₁₀G₆-, from naphthalene) or a doubly connected biphenylene moiety (—C₁₂G₈-, from biphenyl);

wherein AR² independently is hydrogen (—H), fluorine (—F), a phenyl group (—C₆G₅), a naphthyl group (—C₁₀G₇) or a biphenyl group (—C₁₂G₉);

wherein each X, X¹ and X² is individually and independently —H, —F, —Cl or —OH;

wherein any methylene moiety (—CX¹X²—) within any —CₓX₂ₓ₋₂ᵣ— or within any —CᵤX₂ᵤ₋₂ₛ— or within any —(CX¹X²)ₚ— may be individually and independently replaced with an independent ether-oxygen atom, —O—, an independent thioether-sulfur atom, —S—, or an independent ketone-carbonyl group, —C(O)—, in such a manner that each ether-oxygen atom, each thioether-sulfur atom or each ketone-carbonyl group is bonded on each side to an aliphatic carbon atom or an aromatic carbon atom;

wherein not more than two ether-oxygen atoms, not more than two thioether-sulfur atoms and not more than two ketone-carbonyl groups may be replaced into any —CₓX₂ₓ₋₂ᵣ— or into any —CᵤX₂ᵤ₋₂ₛ—;

wherein mₓ is the total number of methylene groups in each —CₓX₂ₓ₋₂ᵣ— that are replaced with ether-oxygen atoms, thioether-sulfur atoms and ketone-carbonyl groups, and mᵤ is the total number of methylene groups in each —CᵤX₂ᵤ₋₂ₛ— that are replaced with ether-oxygen atoms, thioether-sulfur atoms and ketone-carbonyl groups;

wherein G is individually and independently any combination of —H, —F, —Cl, —CH₃, —OH, —OCH₃, —N(CH₃)₂, —CF₃, —CO₂Me, —CO₂NH₂; —CO₂NHMe, —CO₂NMe₂;

wherein G* is individually and independently any combination of —F, —CI, —R², —OH, —OR², —NR²R³, —CF₃, —CO₂Me, —CO₂NH₂; —CO₂NHMe, —CO₂NMe₂;

wherein a pair of R², R³, and R⁴ may comprise a single chemical moiety such that R²/R³, R²/R⁴, R³/R⁴, R^{2′}/R^{3′}, R^{2′}/R^{4′} or R^{3′}/R^{4′} is individually and independently —(CX¹X²)ₚ— with p=3, 4, 5 or 6;

wherein the integer values of each of x, r, u, s, mₓ, mᵤ are independently selected for each R¹, R², R³, R⁴, R⁵ and R*, integer values r and s are the total number of contained, isolated cis/trans olefinic (alkene) groups plus the total number of contained simple monocyclic structures and fall in the ranges 0≦r≦2 and 0≦s≦2, the numeric quantity x+u−mₓ−mᵤ falls in the range 0≦x+u−mₓ−mᵤ≦11;

wherein at least one aromatic chemical moiety, heterocyclic aromatic chemical moiety, imidazoline chemical moiety, amidine chemical moiety or guanidine chemical moiety is contained within CM or CM′ of A or B;

wherein a group-hydrophobic-index for each R-chemical-moiety (n) is numerically equal to the sum of the number of aliphatic carbon atoms plus the number of olefinic carbon atoms plus the number of thioether-sulfur atoms plus the number of chlorine atoms plus one-fifth the number of fluorine atoms plus one-half the number of ether-oxygen atoms plus one-half the number of ketone-carbon atoms plus one-half the number of aromatic carbon atoms beyond the number six minus the number of hydroxyl-oxygen atoms beyond the number one;

wherein an overall-hydrophobic-index (N) for each [CM] or [CM-R*-CM′] is numerically equal to the sum of the number of aliphatic carbon atoms plus the number of olefinic carbon atoms plus the number of thioether-sulfur atoms plus the number of chlorine atoms plus one-fifth the number of fluorine atoms plus one-half the number of ether-oxygen atoms plus one-half the number of ketone-carbon atoms plus one-half the number of aromatic carbon atoms beyond the number six minus the number of hydroxyl-oxygen atoms beyond the number one;

wherein the group-hydrophobic-indices (¹n and ^{1′}n) for R¹ and R^{1′} fall in the range 4.0<¹n,^{1′}n<12.0, the group-hydrophobic-indices (²n, ^{2′}n, ³n, ^{3′}n, ⁵n, ^{5′}n and *n) for R², R^{2′}, R³, R^{3′}, R⁵, R^{5′}, R*, when present, fall in the range 0.0≦²n,^{2′}n,³n,^{3′}n ⁵n,^{5′}n,*n<12.0 and the group-hydrophobic-indices (⁴n and ^{4′}n) for R⁴ and R^{4′}, when present, fall in the range 0.0≦⁴n,^{4′}n≦5.0;

wherein the overall-hydrophobic-index (N) divided by the value of g falls in the range 10.0≦N/g<24.0;

wherein in A, when the charged moiety, CM, has a formal positive charge or a formal negative charge, g=1, and in B, when CM and CM′ have formal positive charges or when CM and CM′ have formal negative charges, g=2, and in B when CM has a formal positive charge and CM′ has a formal negative charge, g=1;

wherein the numeric value of the group-hydrophobic-index calculated for a cyclic chemical moiety is divided equally between the two respective R-chemical-moieties;

wherein R¹ is identified as that R-chemical-moiety when only one such chemical moiety is attached to CM or CM′; wherein R¹ is identified as that R-chemical-moiety having the largest value of the group-hydrophobic-index when there are more than one such chemical moieties attached to CM or CM′; wherein R⁴ is identified as that R-chemical-moiety having the smallest value of the group-hydrophobic-index when there are more than three such chemical moieties attached to CM or CM′; and

wherein CI is a non-interfering, oppositely-charged counter-ion or mixture of such counter-ions, and the value of d is zero, a positive whole number or a positive fraction such that electroneutrality of the overall hydrophobic compound is maintained.

In one embodiment, the aqueous composition comprising a non-surface active hydrophobic displacer molecule is free of added salt other than a pH buffer.

In one embodiment, CM has a general formula I or II:

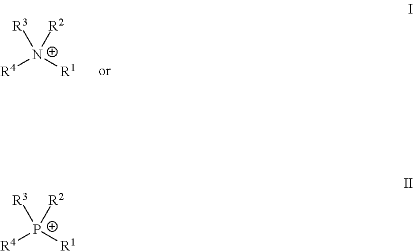

wherein in the general formula I or II, R¹ is a C₈-C₁₁ hydrocarbyl moiety, R² and R³ are independently a C₁-C₄ hydrocarbyl moiety or benzyl, and R⁴ is selected from benzyl, halo-substituted benzyl, 4-alkylbenzyl, 4-trifluoromethyl benzyl, 4-phenylbenzyl, 4-alkoxybenzyl, 4-acetamidobenzyl, H₂NC(O)CH₂—, PhHNC(O)CH₂—, dialkyl-NC(O)CH₂—, wherein alkyl is C₁-C₄, provided that no more than one benzyl group is present in the CM.

In one embodiment, CM has a general formula I or II:

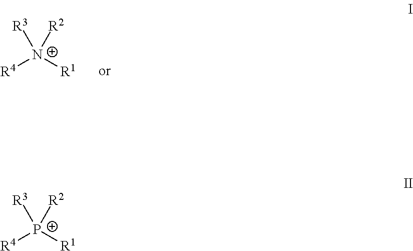

wherein in the general formula I or II, R¹ and R² are independently C₄-C₈ alkyl or cyclohexyl, R³ is C₁-C₄ alkyl, and R⁴ is phenyl, 2-, 3- or 4-halophenyl, benzyl, 2-, 3- or 4-halobenzyl, 2,3-, 2,4-, 2,5-, 2,6-, 3,4- or 3,5-dihalobenzyl, 2,4,6- or 3,4,5-trihalobenzyl, C₆H₅CH₂CH₂— or 2-, 3- or 4-trifluoromethylbenzyl.

In one embodiment, CM has a general formula VIII, IX, X or XI, R¹ is C₅-C₁₁ alkyl and R² is C₁-C₈ alkyl.

In one embodiment, CM has a general formula I or II:

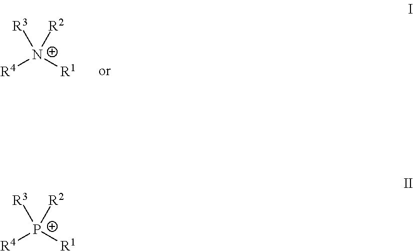

wherein in the general formula I or II, R¹ is C₆-C₁₁ alkyl, R² and R³ independently are C₁-C₄ alkyl, and R⁴ is PhC(O)CH₂—, 4-FC₆H₄C(O)CH₂—, 4-CH₃C₆H₄C(O)CH₂—, 4-CF₃C₆H₄C(O)CH₂—, 4-ClC₆H₄C(O)CH₂—, 4-BrC₆H₄C(O)CH₂—, dl-PhC(O)CH(Ph)-, Ph(CH₂)₂—, Ph(CH₂)₃—, Ph(CH₂)₄—, dl-PhCH₂CH(OH)CH₂—, t-PhCH═CHCH₂—, 1-(CH₂)naphthylene, 9-(CH₂)anthracene, 2-, 3- or 4-FC₆H₄CH₂— or benzyl.

In one embodiment, CM has a general formula I or II:

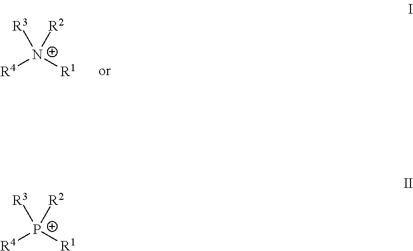

wherein in the general formula I or II, R¹ is C₆-C₁₁ alkyl, R² and R³ together are —(CH₂)₄—, and R⁴ is PhC(O)CH₂—, 4-FC₆H₄C(O)CH₂—, 4-CH₃C₆H₄C(O)CH₂—, 4-CF₃C₆H₄C(O)CH₂—, 4-ClC₆H₄C(O)CH₂—, 4-BrC₆H₄C(O)CH₂—, dl-PhC(O)CH(Ph)-, Ph(CH₂)₂—, Ph(CH₂)₃—, Ph(CH₂)₄—, dl-PhCH₂CH(OH)CH₂—, t-PhCH═CHCH₂—, 2-, 3- or 4-FC₆H₄CH₂—, benzyl, 3-ClC₆H₄CH₂—, 2,6-F₂C₆H₃CH₂—, 3,5-F₂C₆H₃CH₂—, 4-CH₃C₆H₄CH₂—, 4-CH₃CH₂C₆H₄CH₂—, 4-CH₃OC₆H₄CH₂—, (CH₃)₂NC(O)CH₂— or (CH₃CH₂)₂NC(O)CH₂—.

In one embodiment, CM has a general formula I or II:

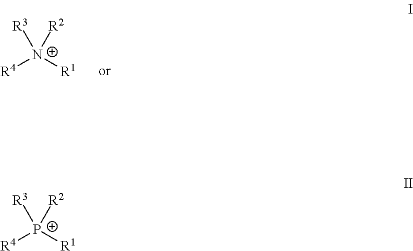

wherein in the general formula I or II, R¹ is C₄-C₆ alkyl, benzyl or 2-, 3- or 4-FC₆H₄CH₂—, R² and R³ independently are C₁-C₈ alkyl, CH₃(OCH₂CH₂)₂—, CH₃CH₂OCH₂CH₂OCH₂CH₂— or CH₃CH₂OCH₂CH₂—, and R⁴ is Ph(CH₂)₄—, 4-PhC₆H₄CH₂—, 4-FC₆H₄CH₂—, 4-CF₃C₆H₄CH₂—, PhC(O)CH₂—, 4-FC₆H₄C(O)CH₂—, 4-PhC₆H₄C(O)CH₂—, 4-PhC₆H₄CH₂—, naphthylene-1-CH₂—, anthracene-9-CH₂— or Ph(CH₂)ₙ—, where n=5-8.

In one embodiment, CM has a general formula [(R¹R²R³NCH₂)₂C₆H₃G]²⁺, wherein R¹ is C₄-C₁₁ alkyl, R² and R³ independently are C₁-C₆ alkyl or R² and R³ taken together are —(CH₂)₄—, and G is H or F.

In one embodiment, CM has a general formula [R¹R²R³NCH₂C₆H₄—C₆H₄CH₂NR¹R²R³]²⁺, wherein R¹ is C₄-C₁₁ alkyl, R² and R³ independently are C₁-C₆ alkyl or R² and R³ taken together are —(CH₂)₄—.

In one embodiment, CM has a general formula III or IV:

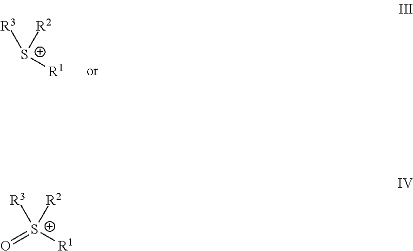

wherein in the general formula III or IV, R¹ is C₈-C₁₁ alkyl or 4,4′-CH₃(CH₂)₄C₆H₄—C₆H₄CH₂—, R² is C₁-C₆ alkyl or 4-FC₆H₄CH₂—, and R³ is C₁-C₆ alkyl.

In one embodiment, CM has a general formula XIV or XV:

wherein in the general formula XIV or XV, R¹ is C₈-C₁₁ alkyl, and each G and R⁵ are as defined above.

In one embodiment, CM has a general formula XIIIa, XIIIb, XIIIc, XIIId or XIIIe:

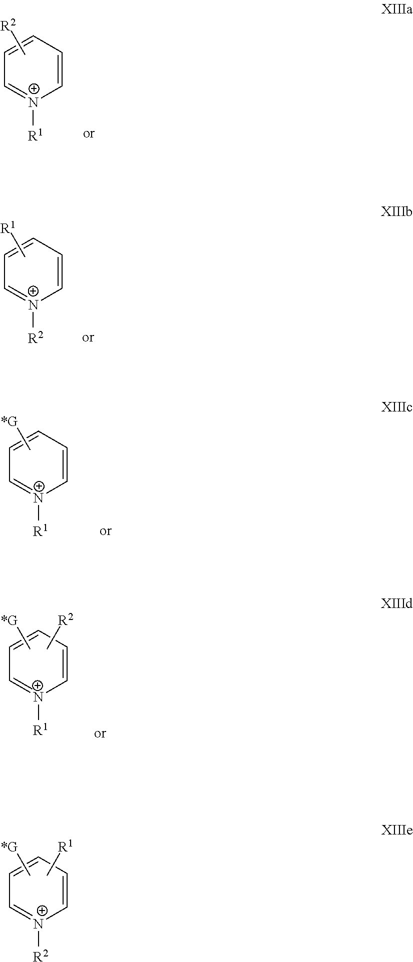

wherein in the general formula XIIIa, XIIIb, XIIIc, XIIId or XIIIe, R¹ is C₈-C₁₁ alkyl or C₈-C₁₁ 4-phenyl, R² is H, C₁-C₆ alkyl or alkoxy, 2-pyridyl, C₁-C₆ alkyl substituted 2-pyridyl, or pyrrolidinyl, and each G is as defined above.

In one embodiment, CM has a general formula VII:

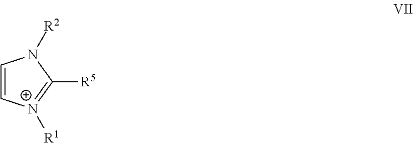

wherein in the general formula VII, R¹ is C₅-C₁₁ alkyl, R² and R⁵ are independently H or C₁-C₆ alkyl or phenyl.

In one embodiment, CM has a general formula XII:

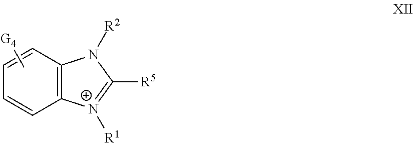

wherein in the general formula XII, R¹ is C₅-C₁₁ alkyl, R² and R⁵ are independently H or C₁-C₆ alkyl or phenyl, and G is as defined above.

In one embodiment, CM has a general formula XXIV or XXV:

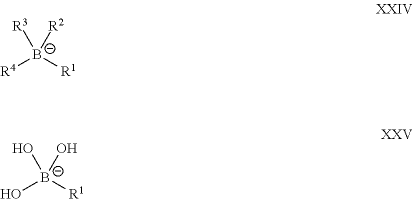

wherein in the general formula XXIV, R¹ is phenyl, 4-EtC₆H₄—, 4-ⁿPrC₆H₄—, 4-ⁿBuC₆H₄—, 4-MeOC₆H₄—, 4-FC₆H₄—, 4-MeC₆H₄—, 4-MeOC₆H₄—, 4-EtC₆H₄—, 4-ClC₆H₄—, or C₆F₅—; and each of R2, R3 and R4 independently are phenyl, 4-FC₆H₄—, 4-MeC₆H₄—, 4-MeOC₆H₄—, 4-EtC₆H₄—, 4-ClC₆H₄— or C₆F₅—; and
wherein in the general formula XXV, R1 is 4-(4-ⁿBuC₆H₄)C₆H₄— or 4-(4-ⁿBuC₆H₄)—3-ClC₆H₃—

In one embodiment, CM has a general formula selected from 4-R¹C₆H₄SO₃H, 5-R¹-2-HO—C₆H₃SO₃H, 4-R¹—C₆H₄—C₆H₃X-4′-SO₃H, and 4-R¹—C₆H₄—C₆H₃X-3′-SO₃H, wherein R1 is CH₃(CH₂)ₙ, wherein n=4-10 and X is H or OH.

In one embodiment, CM has a general formula XVIII or XXIII:

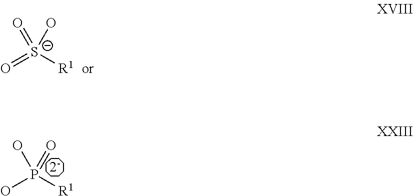

wherein in the general formula XVIII and in the general formula XXIII, R¹ is C₆H₅(CH₂)ₙ—, wherein n=5-11.

In one embodiment, CM has a general formula selected from 5-R¹-2-HO—C₆H₃CO₂H and R¹C(O)NHCH(C₆H₅)CO₂H, wherein R¹ is CH₃(CH₁₂)ₙ—, wherein n=4-10.

In one embodiment, CM has a general formula 4-R¹C₆H₄PO₃H₂ wherein R¹ is CH₃(CH₂)ₙ—, wherein n=4-10.

In one embodiment, CI is a non-interfering anion or mixture of non-interfering anions selected from: Cl⁻, Br⁻, I⁻, OH⁻, F⁻, OCH₃⁻, d,l-HOCH₂CH(OH)CO₂⁻, HOCH₂CO₂⁻, HCO₂⁻, CH₃CO₂⁻, CHF₂CO₂⁻, CHCl₂CO₂⁻, CHBr₂CO₂⁻, C₂H₅CO₂⁻, C₂F₅CO₂⁻, ⁿC₃H₇CO₂⁻, ⁿC₃F₇CO₂⁻, CF₃CO₂⁻, CCl₃CO₂⁻, CBr₃CO₂⁻, NO₃⁻, ClO₄⁻, BF₄⁻, PF₆⁻, HSO₄⁻, HCO₃⁻, H₂PO₄⁻, CH₃OCO₂⁻, CH₃OSO₃⁻, CH₃SO₃⁻, C₂H₅SO₃⁻, NCS⁻, CF₃SO₃⁻, H₂PO₃⁻, CH₃PO₃H⁻, HPO₃²⁻, CH₃PO₃²⁻, CO₃²⁻, SO₄²⁻, HPO₄²⁻, PO₄³⁻.

In one embodiment, CI is a non-interfering inorganic cation or mixture of such non-interfering cations selected from the groups: alkali metal ions (Li⁺, Na⁺, K⁺, Rb⁺, Cs⁺), alkaline earth metal ions (Mg²⁺, Ca²⁺, Sr²⁺, Ba²⁺), divalent transition metal ions (Mn²⁺, Zn²⁺) and NH₄⁺; wherein CI is a non-interfering organic cation or mixture of such non-interfering cations selected from the groups: protonated primary amines (1+), protonated secondary amines (1+), protonated tertiary amines (1+), protonated diamines (2+), quaternary ammonium ions (1+), sulfonium ions (1+), sulfoxonium ions (1+), phosphonium ions (1+), bis-quaternary ammonium ions (2+) that may contain C₁-C₆ alkyl groups and/or C₂-C₄ hydroxyalky groups.

### BRIEF DESCRIPTION OF THE DRAWINGS

FIGS. 1b, 2, 3, 4, 5, 6b(a)B and 7 are fraction analyses of the displacement data plotting fraction number (x-axis) against concentration (mg/mL) of each component in each fraction for the displacement chromatography process in accordance with exemplary embodiments of the present invention.

FIG. 6b(a)A is a displacement trace for the purification of a crude synthetic peptide plotting time (x-axis) against relative absorbance units (y-axis) for the displacement chromatography process in accordance with an exemplary embodiment of the present invention.

### DETAILED DESCRIPTION

As used herein, “non-surface-active”, with respect to a cationic non-surface-active displacer compound employed in accordance with the present invention, means that the compound so described has a critical micelle concentration (“CMC”) greater than the concentration of the compound employed in a displacement chromatography process in accordance with the present invention. In one embodiment, the concentration of the non-surface-active displacer compound is less than about 80% of the CMC for that compound in water in the absence of organic solvent, salt or other agent that would affect the CMC. In one embodiment, the concentration of the non-surface-active displacer compound is less than about 60% of the CMC for that compound in water in the absence of organic solvent, salt or other agent that would affect the CMC. In one embodiment, the concentration of the non-surface-active displacer compound is less than about 50% of the CMC for that compound in water in the absence of organic solvent, salt or other agent that would affect the CMC.

In one embodiment, the aqueous composition comprising a non-surface-active cationic hydrophobic displacer molecule employed in accordance with the present invention does not exhibit adverse surface-active characteristics due to one or a combination of two or more of (1) the cationic non-surface active displacer compound is present at a concentration lower than its CMC; (2) the overall-hydrophobic-index (N) for each [CM] or [CM-R*-CM′] divided by the value of g falls in the range 10≦N/g<24; (3) the group-hydrophobic-index (¹n) for each R¹ falls in the range 4<¹n<12, the group-hydrophobic-index (²n, ³n, ⁵n and *n) for each R², R³, R⁵ and R*, when present, falls in the range 0≦²n, ³n, ⁵n,*n<12, and the group-hydrophobic-index (⁴n) for each R⁴, when present, falls in the range 0≦⁴n≦5; (4) the composition contains greater than about 5 volume % or more of an organic solvent.

As used herein, “low organic solvent content” generally refers to an organic solvent content in, e.g., an aqueous “carrier” composition comprising a cationic non-surface-active displacer compound in accordance with the present invention, of less than about 25% by volume. In one embodiment, the organic solvent content of the aqueous “carrier” composition contains less than about 20% by volume of any organic solvent. In one embodiment, the organic solvent content of the aqueous “carrier” composition contains less than about 15% by volume of any organic solvent. In one embodiment, the organic solvent content of the aqueous “carrier” composition contains less than about 10% by volume of any organic solvent. In one embodiment, the organic solvent content of the aqueous “carrier” composition contains less than about 5% by volume of any organic solvent. In one embodiment, the aqueous “carrier” composition contains no organic solvent.

In one embodiment, the organic solvent is one or a mixture of two or more of methanol (CH₃OH or MeOH), ethanol (C₂H₅OH or EtOH) or acetonitrile (CH₃CN or MeCN). In one embodiment, the aqueous “carrier” composition contains a mixture of suitable organic solvents. In one embodiment, the aqueous “carrier” composition contains no organic solvent.

Hydrophobic displacement chromatography can be carried out using chiral analytes, chiral displacers and chiral chromatography matrices. Under these conditions, an achiral displacer may be used, but a racemic mixture of a chiral displacer cannot be used. Racemic chiral analytes can also be purified using an achiral chromatography column and an achiral displacer. In this case, impurities, including diastereomers, are removed from the racemic compound of interest, but there is no chiral resolution of the enantiomers.

Some of the cationic displacers described here have a quaternary nitrogen with four different groups attached and hence are inherently chiral; see for example racemic displacer compounds 43-45, 50-53, 58-59, 64-66 in Tables V-IX below. Furthermore, some of the cationic displacers contain a single chiral group attached to an achiral nitrogen atom; see for example racemic displacer compounds 203 and 206 as well as the enantiomerically pure displacer compound 67 that is derived from l-phenylalanine. With the proper choice of chiral chromatography matrix, mobile phase and achiral displacer, enantiomers are routinely preparatively resolved (separated). Depending on the specific circumstances, a good, enantiomerically pure, chiral displacer can have performance advantages over a good achiral displacer when carrying out a displacement separation of enantiomers on a chiral stationary phase.

Useful pH Ranges—Various classes of cationic hydrophobic displacers having the general formula A or B, have different useful pH ranges depending on the chemical nature of the charged moieties. Cationic hydrophobic displacers that contain deprotonatable cationic groups should be operated at a pH of 1-2 units or more below the actual pKa values. Cationic hydrophobic displacers that contain protonatable anionic groups should be operated at a pH of 1-2 units or more above the actual pKa values.
Onium Groups—Generally, quaternary ammonium, quaternary phosphonium, tertiary sulfonium, tertiary sulfoxonium and related cationic groups such as pyridinium, imidazolium, guanidinium have a wide useful pH range, 1-11 or greater, because they don't have deprotonatable N—H, S—H or P—H moieties under normal conditions.
Amine and Guanidine Groups—Tertiary aliphatic amines (pKa˜9.5) and related substituted quanidines (pKa˜13.5) with deprotonatable N—H moieties are useful cationic groups when operated at a pH of 1-2 units or more below the actual pKa values.

### Displacer Binding-Strength

The displacer should bind to the column more strongly than all of the components of the sample or at least more strongly than all of the major components of interest. A good rule-of-thumb is that no more than 1-4% of the sample mass should bind more strongly than the displacer.

An optimal displacer should not bind too strongly nor too weakly to the stationary phase. The proper binding strength depends on the analyte of interest and the associated binding-isotherms. Usually, a range of displacers with a range of binding strengths is needed for a variety of different columns and analytes to be purified. If a displacer binds too strongly, poor performance is obtained such as lower resolution, lower analyte binding capacity, difficulty in displacer removal and longer cycle-times. If a displacer binds too weakly, a poor displacement train may result with too much “tailing” of the displaced analytes underneath the displacer, or there may be only partial displacement or no displacement at all.

A convenient, rule-of-thumb method that helps in choosing displacers with the proper binding strength is to carry out simple gradient elution chromatography of potential displacers and analytes using similar columns and mobile phases that are to be used in the displacement experiment. As a first screen, the displacer should elute 5-15 minutes later than the analytes of interest in a 60 minute gradient. Ideally one would measure the isotherms of the single analytes and mixtures of analytes but this is time-consuming and often impractical. Because it operates early on the binding-isotherm, this rule-of-thumb method is not perfect, but provides a convenient starting point for further DC optimization.

### Displacer Binding-Strength

The displacer should bind to the column more strongly than all of the components of the sample or at least more strongly than all of the major components of interest. A good rule-of-thumb is that no more than 1-4% of the sample mass should bind more strongly than the displacer.

An optimal displacer should not bind too strongly nor too weakly to the stationary phase. The proper binding strength depends on the analyte of interest and the associated binding-isotherms. Usually, a range of displacers with a range of binding strengths is needed for a variety of different columns and analytes to be purified. If a displacer binds too strongly, poor performance is obtained such as lower resolution, lower analyte binding capacity, difficulty in displacer removal and longer cycle-times. If a displacer binds too weakly, a poor displacement train may result with too much “tailing” of the displaced analytes underneath the displacer, or there may be only partial displacement or no displacement at all.

A convenient, rule-of-thumb method that helps in choosing displacers with the proper binding strength is to carry out simple gradient elution chromatography of potential displacers and analytes using similar columns and mobile phases that are to be used in the displacement experiment. As a first screen, the displacer should elute 5-15 minutes later than the analytes of interest in a 60 minute gradient. Ideally one would measure the isotherms of the single analytes and mixtures of analytes but this is time-consuming and often impractical. Because it operates early on the binding-isotherm, this rule-of-thumb method is not perfect, but provides a convenient starting point for further DC optimization.

### Usable Binding-Isotherms

Apart from proper binding strength, useful hydrophobic displacers need to have binding-isotherms with certain other useful characteristics.

(1) Monomodal, convex upward isotherms (Langmuir-type isotherm behavior) for displacer and analyte molecules facilitate the orderly formation of isotactic displacement trains and simplify the method optimization process. This is a useful property of many cationic displacer molecules in contrast to binding-isotherms of many other uncharged hydrophobic displacer molecules (non-zwitterions) such as aromatic alcohols (e.g., substituted phenols, naphthols, hydroxybiphenyls), fatty alcohols (e.g., 1-dodecanol, 1,2-dodecanediol) and uncharged fatty carboxylic acids (e.g., myristic acid) behave normally at lower concentrations and then become bimodal and rise again at higher concentrations (BET-type isotherm behavior). This binding behavior often arises from deposition of multiple layers of the hydrophobic displacer, each layer having different binding characteristics. This binding behavior greatly complicates the displacement process and its useful implementation.

(2) Chromatographic results in DC are also complicated when displacer molecules undergo self-association in solution. As concentrations increase, problems with displacer self-association become worse. Again, the charged groups in cationic hydrophobic displacers inhibit self-association problems in aqueous solution.

(3) Further complications also arise when product and/or impurity isotherms cross the displacer isotherm in the higher, non-linear binding region. This behavior leads to reversal of displacement order, broadening of overlap regions between displacement bands and problems with co-displacement. In this case, minor variations in displacer concentration can lead to large changes in the displacement train thereby making method optimization very difficult.

We have found that properly designed cationic displacer molecules supplemented with the proper counter-ions and small amounts of useful organic solvents provide a family of effective hydrophobic displacers with Langmuir-type binding behavior and useful ranges of binding strengths.

### Ion-Pairing Anions for Cationic Displacers

With all of their many advantages, cationic hydrophobic displacer molecules have one extra requirement: choosing a good ion-pairing anion, CI. The ion-pairing anion significantly affects the binding-isotherm of the displacer and the functioning and utility of the displacer. The concentration of the ion-pairing agent is independently adjusted by adding appropriate amounts of K⁺, NH₄⁺, protonated amine salts of an ion-pairing anion or Cl⁻/HCO₂⁻ salts of an ion-pairing cation. The properties of an ion-pairing anion for a cationic hydrophobic displacer strongly affects its displacement properties. A few anions may be involved in ion-pairing in solution, and nearly all anions are involved in ion-pairing in the adsorbed state on the hydrophobic chromatography matrix. The same ion-pairing agent(s) for displacer and analyte should be used for good chromatographic resolution. Useful ion-pairing counter-ions are usually singly charged. Owing to their higher solvation energies, divalent ions (SO₄²⁻) and trivalent ions (PO₄³⁻) are generally less useful but may be used in some specialized cases. Exceptions to this general rule are multiple, singly-charged moieties spaced apart in a single organic ion such as ⁻O₃S(CH₂)₄SO₃⁻.

Anions with greater hydrophobic character tend to increase binding-strength and also decrease solubility. Furthermore, when using hydrophobic displacer salts, resolution of DC may decrease if the anion itself is either too hydrophobic or too hydrophilic. Typically, intermediate hydrophobic/hydrophilic character of the anion gives best results, but this varies depending on the molecule being purified. The optimal counter-ion for each purification should be determined experimentally. For example, a hydrophobic quaternary ammonium displacer with CH₃CO₂⁻ counter-ion gives good solubility and mediocre resolution, with CF₃CO₂⁻ gives mediocre, but acceptable, solubility and good resolution, and with CCl₃CO₂⁻ gives poor solubility and mediocre resolution. Volatile ion-pairing agents are conveniently removed under reduced pressure, while nonvolatile ones are readily removed by other means such as diafiltration, precipitation or crystallization. Table I gives a partial list of useful monovalent ion-pairing anions. When using anionic ion-pairing agents, the operating pH should be 1-2 pH units or more above the pKa of the respective acid. A notable exception to this guideline is trifluoroacetic acid that acts as both ion-pairing agent and pH buffer at the same time.

TABLE I
Monovalent Anions in Approximate Order of Ion-pairing Strength

| | |
|---|---|
| Weak | Fluoride < Hydroxide < Gluconate < Glycerate < |
| | Glycolate < Lactate |
| Moderate | Formate < Acetate < Bicarbonate < Propionate < Butyrate < |
| | Methanesulfonate < Ethanesulfonate < Difluoroacetate < |
| | Chloride |
| Medium Strong | Bromide < Trifluoroacetate < Dichloroacetate < Nitrate |
| Strong | Triflate < Iodide < Dibromoacetate < Thiocyanate < |
| | Trichloroacetate < Perchlorate < Hexafluoroisobutrate < |
| | Pentafluoropropionate < Tetrafluoroborate < |
| | Hexafluorophosphate < Tribromoacetate |

Mixed anions often lead to loss of chromatographic resolution and are generally to be avoided. However, there is one set of conditions when mixed anions may be used; that is, when both (a) the anion of interest has significantly stronger ion-pairing properties than the other anions that are present and (b) the anion of interest is present in stoichiometric excess in the sample loading mixture and in the displacer buffer.

The most commonly used ion-pairing anions are formate, acetate, chloride, bromide and trifluoroacetate. Owing to lower ion-pairing strength, formate and acetate require careful optimization in order to obtain good resolution. Bromide and trifluoroacetate seem to give the best results for peptides and small proteins. Generally, good chromatographic results can be obtained with chloride and bromide as ion-pairing anions, but two special precautions should be exercised. (1) Under acidic conditions, the chromatography solutions cannot be degassed by helium purging or by vacuum degassing owing to loss of gaseous HCl or HBr thereby changing the pH and changing the concentration of the anion. This problem is overcome by using degassed distilled water for preparing chromatography solutions and storing the solutions in closed containers to prevent reabsorption of air. (2) Chloride and bromide are potentially corrosive to stainless steel HPLC equipment, but equipment made from PEEK, Teflon, ceramic, glass and titanium is safe. The main problem is halide-catalyzed corrosion of stainless steel caused by air (oxygen) at low pH. If HPLC solutions are properly deoxygenated, halide-promoted corrosion of stainless steel is greatly reduced.

### Solubility

In “hydrophobic chromatography” or, more properly, “solvophobic chromatography”, where the principal solvent component is water, potential hydrophobic displacer molecules often have limited solubility. Hydrophobic molecules usually do not dissolve in water to any appreciable extent unless there are “hydrophillic groups” attached to the hydrophobic molecule, such as charged ionic-groups, hydrophillic counter-ions, polar groups or groups that function as hydrogen-bond donors or acceptors. Aromatic molecules interact with water in a unique fashion owing to the unique manner in which the pi-electrons act as weak hydrogen-bond acceptors. Furthermore, aromatic molecules can engage in face-to-face pi-stacking in aqueous solution. These small but important effects are reflected in the higher solubility in water of benzene (9 mM) and naphthalene (200 μM) compared with cyclohexane (˜10 μM) and trans-decalin (<1 μM) and in the higher solubility of phenol (960 mM) and β-naphthol (7 mM) compared with the unhydroxylated arenes. The molecular structure of a useful displacer molecule should facilitate a reasonable solubility (10-50 mM) in water or in water with low organic content yet at the same time be sufficiently hydrophobic that it binds strongly to the stationary phase. Generally, charged displacer molecules have better solubility properties than neutral ones owing to the increased solvation energies of charged species, especially counter-ions. It requires a unique balance of physical and chemical properties for neutral zwitterionic molecules to behave as good displacers. Cationic hydrophobic displacers display unique solubility properties.

It is important to note, generally speaking, that increasing the levels of the organic solvent in order to compensate for poor displacer solubility rarely leads to useful results. Best chromatographic results are obtained with 0-25% organic solvent, or more preferably, 2-15% organic solvent. Higher organic content (25-75%) of the mobile phase may be used in some cases but usually capacity and resolution often suffer badly.

### Reduced Product-Displacer Association

One potential problem with hydrophobic displacement chromatography is the possible association of a hydrophobic displacer with a hydrophobic analyte in solution. This can lead to significant loss of resolution and contamination. Displacer-analyte association in the adsorbed state on the stationary phase also can occur but is less problematic with proper amounts of suitable ion-pairing agents present. A good method to deal with this problem is to use charged analytes and charged hydrophobic displacers with the same charge.

### Displacer Self-Association and Micelle Formation

In some cases when the chemical structure and physical properties are conducive, cationic hydrophobic molecules can self-associate, forming micelles and micelle-like, self-associated structures in solution. This situation can lead to loss of resolution in DC as well as unwanted foaming of displacer solutions. The displacer in solution finds itself in various forms that are interrelated by various chemical equilibria. Furthermore, micelles can act as carriers for hydrophobic analyte molecules causing them to exist in solution in various forms. This unwanted phenomenon is concentration dependent and is effectively inhibited by the addition of small amounts of a suitable organic solvent such as methanol, ethanol or acetonitrile. Properly designed, cationic displacer molecules disenhance micelle formation and give better displacement results. Thus, keeping the group-hydrophobic-indices below 12.0 for R-groups, R¹-R³, reduces the problem of unwanted detergency.

### High Purity—Impurities in Displacers

A displacer should have adequate purity. The object of preparative chromatography is to remove the impurities from a component of interest. Contamination of the desired compound by the displacer itself is rarely a problem, but contamination by “early displacing” impurities in the displacer solution may be problematic in some cases depending on the amounts of the impurities and their binding properties. Thus, a good displacer should contain little or no early displacing impurities.

### Suitable UV Absorbance

In order to track the location and amounts of displacer throughout the DC experiment, to watch displacer breakthrough curves and to follow displacer removal during column regeneration procedures, it is useful to have a displacer with moderate ultraviolet absorption. High absorption is not needed nor is it preferred owing to the high concentrations of displacer and analyte. Generally, colorless displacers are preferred with a UV spectrum that has strategically located windows of low absorbance so that the analytes can be followed at some frequencies and the displacer monitored at other frequencies.

### Ease of Manufacturing and Cost

Convenient and cost-effective methods of chemical synthesis, production and manufacturing are important in order to produce useful displacers and reasonable costs. Furthermore, practical methods of purification, especially non-chromatographic purification, are needed in order to achieve the purity requirements in a cost-effective manner.

### Chemical Stability, Low Toxicity and Long Shelf-Life

Among all its other desired chemical and physical properties, a useful displacer molecule should be chemically stable. It should be inert toward analyte molecules and chemically stable (non-reactive) toward water, common organic solvents, mild bases, mild acids and oxygen (air). It should be photo-stable and thermally stable under typical use and storage conditions and have a reasonable shelf-life. It greatly preferred that displacer molecules be visually colorless, yet have the requisite levels of UV absorbance. Useful displacer molecules also need to have low toxicity, not only to protect workers but to protect biological and drug samples that may come into contact with the displacer.

### Suitable Chromatographic Columns:

While the most common type of reversed-phase column is octadecyl coated silica, many hydrophobic stationary phases find utility in DC (see Table III). Ultimately, the best choice of stationary phase is experimentally determined for each system under study.

TABLE II
Materials for Hydrophobic Stationary Phases

Coated Porous Silica (covanently bonded silanes)

| | |
|---|---|
| Octadecyl (C₁₈) | Docecyl (C₁₂) |
| Octyl (C₈) | Hexyl (C₆) |
| Butyl (C₄) | Pentafluorophenylpropyl (C₆F₅—C₃) |
| Phenylpropyl (Ph—C₃) | Phenylhexyl (Ph—C₆) |
| p-Biphenyl (Ph—Ph) | β-Naphthylethyl (Nap-C₂) |

Uncoated Porous Polystyrene/Divinylbenzene
Porous Fluorocarbon Polymer
Porous Polyoctadecylmethacrylate Polymer
Carbon-like Phases:

Porous Graphitized Carbon
Cleaned Charcoal
Carbon over Porous Zirconia
C₁₈ Bonded to Carbon over Porous Zircona

Organic Polymer Coatings over Inorganic Oxides
Mixed-Mode Hydrophobic Phases

C₁₈ with negative surface charge
C₁₈ with positive surface charge
C₁₈ with buried negative charge
C₁₈ with buried positive charge

Better results in displacement chromatography are obtained with longer, well-packed columns that give better recovery and yield. Table IV provides a guide for initial choices of column dimension and initial flow-rates.

TABLE III
Chromatography Column Dimensions

| Particle | Column | Column | Column | Initial | | Sample | |
|---|---|---|---|---|---|---|---|
| Size | Length | Dia. | Volume | Flow | | Injection | |
| (μm) | (mm) | (mm) | (mL) | Rate^{b} | | Method | |
| 2 | 100 | 2.1 | 0.3464 | 43.3 | μL/min | 3 | mL loop |
| 3 | 150 | 2.1 | 0.5195 | 43.3 | μL/min | 5 | mL loop |
| 3 | 150 | 3.0 | 1.060 | 88.4 | μL/min | 10 | mL loop |
| 3 | 150 | 4.6 | 2.493 | 208 | μL/min | 20 | mL loop/ |
| Pump | | | | | | | Inject. |
| 5 | 250 | 4.6 | 4.155 | 208 | μL/min | 40 | mL loop/ |
| Pump | | | | | | | Inject. |

| | | | | | | |
|---|---|---|---|---|---|---|
| 5 | 250 | 10.0 | 19.63 | 982 | μL/min | Inject. Pump |
| 5 | 250 | 20.0 | 78.54 | 3.93 | mL/min | Inject. Pump |
| 10 | 500^{a} | 10.0 | 39.27 | 982 | μL/min | Inject. Pump |
| 10 | 500^{a} | 20.0 | 157.1 | 3.93 | mL/min | Inject. Pump |
| 10 | 500^{a} | 30.0 | 353.4 | 8.84 | mL/min | Inject. Pump |
| 10 | 500^{a} | 50.0 | 981.7 | 24.5 | mL/min | Inject. Pump |

a) 500 mm or 2 × 250 mm
b) Initial flow-rate = 75 cm/hr (12.5 mm/min); needs to be optimized

Proper column length is important for good results. It should be long enough to fully sharpen the displacement train and give good resolution. Yet columns that are too long needlessly increase separation time and often lead to poorly packed beds and reduced resolution. In many cases, two well-packed columns can be attached end-to-end with good chromatographic results. Considerable experimentation with small molecules (MW<3 KDa) indicates that optimal column length falls in the range 15-45 cm for 5 μm particles and 20-60 cm for 10 μm particles. Porous particles with pore sizes of 80-100 Å are suitable for traditional drugs and small peptides, 120-150 Å are suitable for medium and large oligopeptides and oligonucleotides and 300-500 Å are suitable for most proteins and DNA. Non-porous particles can be used, but loading capacity will significantly decrease.

In cylindrical columns, it is important that a planar flow-front be established so that it is perpendicular to the axis of flow. Scaling up to purify larger amounts of sample is simple and straightforward in displacement chromatography once an optimized protocol has been developed on a smaller column. After the shortest acceptable column-length is found, scale-up is simply accomplished by increasing column diameter while maintaining a constant linear flow-rate. With proper modifications, displacement chromatography can be used with radial-flow columns and with axial-flow monolith columns. The principles of displacement chromatography can be applied in analytical and preparative thin-layer chromatography.

### Running Successful Displacement Chromatography Experiments

Though displacement chromatography of organic compounds, traditional drugs and peptides has been carried out for many years, mediocre-to-poor results are often obtained. Good displacers, good columns and good operational protocols lead to excellent reproducibility and remarkably good chromatographic performance.

### Displacer and Concentration

Initial evaluation is carried out using a good general purpose cationic displacer with proper binding strength. Cationic displacers can be used to purify cationic, neutral non-ionic and neutral zwitterionic analytes. The displacer should bind to the column more strongly than the material to be purified, but the displacer should not bind too strongly. Typical displacer concentrations are in the range 10-50 mM. Initially, displacer concentration is set at 10-15 mM. As needed, pH buffer and ion-pairing anion are added to the displacer solution. The displacer solution and carrier solution should have identical compositions (including pH), except for the presence of displacer and the level of the ion-pairing anion. Displacers 14, 198 and 318 (below) are examples of good general-purpose cationic displacers. During method optimization, it may be helpful to increase displacer concentration up to 20-30 mM or higher.

Choosing an Ion-Pairing Agent

Not using an ion-pairing agent, using an ineffective ion-pairing agent, using mixed ion-pairing agents and using insufficient levels of a good ion-pairing agent are some of the major causes of poor chromatographic performance in displacement chromatography experiments. This is not generally appreciated or understood by those who carry out hydrophobic displacement chromatography. This is amply demonstrated in Example 8 below. Table I contains lists of useful, monovalent, ion-pairing anions that are useful for hydrophobic chromatography. They are needed when the analyte or displacer is charged. For charged analytes and displacers, binding-isotherms strongly depend on the chemical properties of the counter-ion and its concentration. Those ion-pairing agents with moderate to moderately strong binding properties are usually the best to use. When starting experimentation with ion-pairing agents, try bromide or trifluoroacetate (free acid or NH₄⁺ salt) as ion-pairing anions. When the analyte requires an ion-pairing anion, it usually dictates the choice of ion-pairing anion for the cationic displacer in the DC experiment. The ion-pairing anion for the analyte and the displacer should be the same.

### Concentration of Ion-Pairing Agent

As noted earlier, using insufficient levels of a good ion-pairing agent is one of the major causes of poor chromatographic performance in displacement chromatography experiments. The formula for calculating the suitable concentration of the ion-pairing agent in the sample solution (C_{IPS}, mM)) is given by,

C_{IPS}=Eₛ×Cₛ(mM)×Gₛ

where Eₛ is the excess factor for the sample, Cₛ is the concentration of the sample (mM) and Gₛ is the absolute value of the net charge of the sample at the operative pH. The optimal value of Eₛ is a parameter that needs to be determined experimentally. The formula for calculating the suitable concentration of the ion-pairing agent in the displacer solution (C_{IPD}, mM) is given by,

C_{IPD}=E_{d}×C_{d}(mM)×G_{d}

where E_{d} is the excess factor for the displacer, C_{d} is the concentration of the displacer (mM) and G_{d} is the absolute value of the net charge of the displacer at the operative pH. The optimal value of E_{d} is a parameter that needs to be determined experimentally. It is essential that at least a stoichiometric amount of the ion-pairing agent be present in the solutions (Eₛ≧1.0 and E_{d}≧1.0). In practice, it is our experience that Eₛ should be in the range 1.1-10.0, more preferably in the range 1.2-6.0, more preferably yet in the range 1.5-4.5. Furthermore, it is our experience that E_{d} should be in the range 1.1-10.0, more preferably in the range 1.2-4.0. Serious deterioration in chromatographic performance results when the ion-pairing concentrations are unoptimized or too low, that is Eₛ<1.0 and/or E_{d}<1.0.

### Choosing a Good RP Column

For initial reversed-phase work, several good quality octadecyl on silica or phenylhexyl on silica columns should be evaluated (5 μm spherical particles with dimensions 4.6×250 mm). Scaleup to larger preparative columns can come later and is relatively straightforward. A critical issue is to choose a suitable pore size. Matrices with pores that are too large or too small often lead to reduced capacity and sometimes reduced resolution. See Tables II and III above.

### Flow-Rates

Because displacement chromatography is a “quasi-equilibrium technique”, relatively slow flow-rates are often needed. The optimal flow-rate is the fastest flow-rate possible without losing resolution. Sample loading flow-rate and displacement flow-rate should be about the same, both in the range of 35-105 cm/hr. Start at 75 cm/hr for traditional drugs, oligopeptides and oligonucleotides or 40 cm/hr for proteins and DNA. Regeneration flow-rates should be 2-8 times the displacement flow-rate. When purifying drugs, peptides or oligonucleotides at elevated temperatures on reversed-phase columns, faster flow-rates might be used.

### Temperature

Because reversed-phase chromatography and other forms of hydrophobic chromatography are largely driven by +TΔS with +ΔH, higher temperature often leads to stronger binding, faster binding kinetics and distinctly different resolution. As a consequence, the temperature of the column and, to some extent, displacement buffers should be carefully regulated (+/−0.5° C.) in order to prevent band broadening. Initial work is often carried out at 25° C., and then elevated temperatures (45, 65° C.) are tried if the sample will tolerate it, and the boiling point of the organic solvent is suitable.

### Choosing an Organic Solvent

Although most water-miscible organic solvents will function, acetonitrile, methanol and ethanol are most commonly used. Some DC purifications are carried out with little or no organic solvent at all. This allows practical RPC and HIC purification of undenatured proteins with low salt and low organic solvent. Operating without organic solvent may also be helpful when there are safety issues associated with volatile, flammable solvents. When experimenting, first try acetonitrile for peptides, low molecular-weight organic drugs and small proteins or methanol for large proteins oligonucleotides and DNA. If solubility of the sample in water is acceptable, start with 3% v/v MeCN, 4% v/v EtOH or 5% v/v MeOH in the carrier buffer, the displacer buffer and sample loading solution; the organic content of these three solutions should be the same. Organic solvent content is an important parameter that needs to be optimized for each sample, column and displacer. For general purpose operation, organic solvent should be less than about 15 volume %, more preferably less than about 10 volume %, more preferably yet about 5 volume %. When Octadecyl columns are used, 2-3% acetonitrile, 3-4% ethanol or 4-5% methanol is usually needed for optimal functioning of the matrix. Phenylhexyl and Octyl columns can usually tolerate the absence of organic solvent.

### Choice of pH and pH Buffer

pH buffers are needed when there are ionizable protons in

the sample, displacer, ion-pairing agent or on the stationary phase. Some samples are only stable within certain pH ranges. For some samples, chromatographic resolution is strongly pH-dependent. Generally, cationic samples are purified using cationic displacers and cationic buffers. The anions associated with the cationic buffers should be the same as the ion-pairing anion. In some cases, a different anion can be used as long as it has significantly weaker ion-pairing properties. Likewise, an anionic pH-buffer may be used if it has much weaker ion-pairing properties than the principle ion-pairing anion; thus, formic acid and acetic acid can be used as pH buffers when trifluoroacetate is the ion-pairing anion. For obvious reasons, neutral and cationic amines with low pKₐ values are useful pH-buffers: N,N,N′,N′-tetramethylethylene-diamine (5.9, TMEDA), N-ethylpiperazine (5.0, NEP), N,N-dimethypiperazine (4.2, DMP), diazobicyclooctane (3.0, DABCO).

TABLE IV
Buffering Systems for 10 mM [D⁺] [O₂CF₃] Displacer

| pH | Buffer | IP Agent^{a} | Adjust pH |
|---|---|---|---|
| 2.0 | 12 mM CF₃CO₂H | CF₃CO₂⁻ | NH₄OH |
| 2.0 | 18 mM H₃PO₄ + | CF₃CO₂⁻ | NH₄OH |
| | 10 mM CF₃CO₂H | | |
| 3.0 | 20 mM DABCO + | CF₃CO₂⁻ | HCO₂H |
| | 10 mM CF₃CO₂H | | |
| 3.5 | 20 mM HCO₂H + | CF₃CO₂⁻ | NH₄OH |
| | 10 mM CF₃CO₂H | | |
| 4.2 | 20 mM DMP + | CF₃CO₂⁻ | HCO₂H |
| | 10 mM CF₃CO₂H | | |
| 4.6 | 20 mM CH₃CO₂H + | CF₃CO₂⁻ | NH₄OH |
| | 10 mM CF₃CO₂H | | |
| 5.9 | 20 mM TMEDA + | CF₃CO₂⁻ | HCO₂H |
| | 10 mM CF₃CO₂H | | |

### Co-Displacement

When working with samples that contain hundreds components and impurities, co-displacement is an almost unavoidable phenomenon because there are likely to be several minor components that co-displace with the major component of interest no matter where on the binding isotherms the DC experiments take place. Fortunately, co-displacement in displacement chromatography is a far less serious problem than co-elution in preparative elution chromatography. Co-displacement occurs under two, conditions: (1) when binding-isotherms are so similar that there is poor resolution and (2) when there is crossing of binding-isotherms near the operating region of the binding-isotherm. Fortunately, there are simple ways to deal with this issue: carry out a second DC experiment under different conditions by operating at a different point on the binding-isotherms by,
a. changing the concentration of the displacer,
b. changing to a different displacer with different binding properties.

Alternatively, the isotherms themselves can be changed by,
c. changing the chromatography matrix (stationary phase),
d. changing the concentration of the organic solvent,
e. changing to a different organic solvent,
f. changing to a different ion-pairing agent,
g. changing the temperature.

A second “orthogonal” IP-RP DC step typically gives excellent purity (˜99.5%) with excellent yield (90-95%).

### Method of Sample Loading

A sample is loaded onto the column through a sample injection valve using one of two methods. The sample should be loaded under frontal chromatography conditions at the same point on the binding-isotherm at which the DC experiment takes place. The carrier is not passed through the column after the sample is loaded. Method 1: A sample loading pump is used; Method 2: An injection loop is used. Usually, only partial loop injection is used. The sample in the loop should be driven out of the loop onto the column first by the carrier and then the displacer solution. Not more that 85-95% of the loop volume should be loaded onto the column so that sample diluted by carrier is not loaded.

### Column Loading

DC experiments are carried out at relatively high loading, typically in the range 60-80% of maximum loading capacity. The operative column loading capacity is not a fixed number; rather, it depends upon where on the binding-isotherm the DC experiment operates.

Not all of the column capacity is available for use (see “Exception” below). In practice, only 90-98% of the column capacity can is usable. Once the sample has been loaded onto the column, the displacer buffer is then pumped onto the column. There are three fronts that develop each traveling at different velocities down the column: (1) the liquid front (T₁, displacer buffer minus displacer), (2) the sample front (T₂) and (3) the displacer saturation front itself (T₃). The first front travels faster than the second and third fronts and limits the useable column capacity because the first front should exit the column before the displacement train (T₂) begins to exit. The actual velocities of the fronts depend directly on the displacement flow-rate. The ratio, α, of the front velocities, Vel₁/Vel₂, is given by the formula:

α=Kₘ/(R×C_{d})

where Kₘ is the displacer binding capacity of the matrix (mg displacer per mL packed matrix) at displacer concentration of C_{d}, where C_{d} is the displacer concentration in the displacer buffer (mg displacer per mL displacer buffer), R is the ratio of the volume of the liquid in the column to the total volume of the column (mL liquid per mLₘ bed volume). The maximum % usable column capacity is given by,

(100×(α−1))/α.

In examples 1 b and 6b(a) below, the respective α-values are 22.24 and 21.49, and the respective maximum column capacities are 95.5% and 95.3%. Note that as C_{d} increases, Kₘ will also increase, but not as much if operating high on the nonlinear part of the isotherm. Thus, α will decrease and maximum % usable column capacity will decrease.

Exception—If significant levels of unwanted, early-displacing impurities are present in the sample, one can increase the usable capacity of the column, even beyond 100% by overloading the column and spilling out these impurities during sample loading before the displacer flow is started. Thus, the column loading could be 105% of maximum based on the whole sample, but the column loading would be only 80% based on the amount of main product plus late-displacing impurities.

### Concentration and Volume of Sample Solution

The concentration of the load sample is an important operating parameter. The optimal sample loading concentration (mg/mL) is the same as the output concentration of the purified product from the displacement experiment—the plateau region of the displacement train. Binding-isotherms, the column binding capacities and the output concentrations are initially unknown. Simply carry out the first displacement experiment with the sample solution loaded onto the column using initial estimates as shown below:

(1) Pick an initial column loading percentage at which the one wishes to work, say 75%.

Sample loading time=displacer breakthrough time (T₃−T₁)×0.75=(586 min−270 min)×0.75=237 min (for Example 6b(a))

(2) Pick an initial concentration for the sample by one of two methods:

(a) Initial sample conc. (mg/mL)=0.25×disp. conc. (mM)×formula wt. (mg/μmole)
=0.12×10 mM×1.7466 mg/μmole=2.10 mg/mL (for Example 6b(a))

(b) Pick an estimated column binding capacity for the sample, say 50 mg sample/mL matrix. Assume displacement flow-rate and sample loading flow-rate are the same:
Initial sample conc. (mg/mL)=(col. binding capacity (mg/mLₘ)×col. volume (mLₘ)/((T₂−T₁)×sample flow-rate (mL/min))=(50 mg/mLₘ×4.155 mLₘ)/((586 min−270 min)×0.208 mL/min)=3.16 mg/mL (for Example 6b(a))

If the first DC experiment with loaded sample leads to overloaded conditions (>100% loading), rerun the experiment at one-half the sample concentration. From the results of the first successful DC experiment while using a sample, actual loading concentration and actual column loading capacity are readily calculated, and those values are then used in adjusting sample concentration and loading for the second DC experiment.

### Sample Preparation

The loading sample solution is prepared at the concentration and amount described above. Enough excess solution is needed for overfilling the loop or filling the dead volume of a sample loading pump and delivery lines. The pH, amount of pH buffer and amount of organic solvent are the same as the carrier and displacer buffer. Dissolving the sample in the carrier changes its pH, so the pH of the sample solution will have to be re-adjusted after dissolution. However, the amount of ion-pairing agent may be different. The ion-pairing agent used in the sample solution must be the same one used in the displacer buffer. In this regard, the ion-pairing requirements of the sample dictate which ion-pairing agent is used in the sample solution and in the displacer solution. Based on the formal chemical charge at the operating pH and the concentration of the main analyte, the concentration of the concentration is the ion-pairing agent or ion-pairing salt is calculated. See “Concentration of Ion-Pairing Agent” above.

The composition and history of the sample should be known. If the sample contains an anion, its chemical nature and amount (concentration) should also be known. (a) Obviously, if no anion is present, then no adjustment is made in sample preparation. (b) If the anion in the sample is the same as the ion-pairing anion used in the DC, then the amount of added ion-pairing anion to the sample solution is reduced accordingly. (c) If the anion in the sample has significantly weaker ion-pairing properties than the ion-pairing anion used in the DC, then its presence is ignored. (d) If the anion in the sample has stronger ion-pairing properties than the ion-pairing agent used in the DC, then the anion should be exchanged or removed before proceeding.

### Collecting Fractions

Displacement chromatography gives excellent chromatographic resolution, especially with optimized protocols using a good C₁₈-reversed-phase column. However, the resolution is difficult to see because all of the bands come off the column together as back-to-back bands in the displacement train. Many of the small impurity triangle-bands are less than 30 seconds wide (<100 μL). Thus, an experiment with a displacer breakthrough time of 250 minutes and 80% sample loading, the displacement train would be about 200 minutes wide, and more that 400 fractions would have to be taken so that chromatographic resolution is not lost during the fraction-collection process. Analyzing 400 fractions is truly enlightening and interesting but also a daunting task. This is when online real-time fraction analysis would be useful. In practice, we throw away resolution and collect only 100-130 larger fractions. Even this number of fractions represents a lot of work.

In the circumstance in which a preparative DC experiment is conducted and only the purified main component is of interest, the fraction collecting process is greatly simplified. Based on the shape of the displacement train observed at various frequencies (UV), the beginning and ending of main band of interest is judged and then about 10 fractions are analyzed in both regions in order to determine which fractions to pool. Analyzing 20 fractions instead of 100-130 fractions is an easier task.

### Displacer Removal and Column Regeneration

The displacer is removed using 5-10 column volumes of 95/5 (v/v) ethanol-water or 80/10/10 (v/v/v) acetonitrile-ⁿpropanol-water without any pH buffer or ion-pairing agent. The object is to efficiently remove >99.9% or more of the displacer from the column in the shortest amount of time. The flow-rate is increased (100-400 cm/hr) in order to speed up the column regeneration process if the matrix will tolerate the increased back-pressure. Observing the displacer removal near the absorption maximum of the displacer (see displacer instructions) allows the regeneration process to be carefully monitored and optimized by UV detection.

### Effects of Added Salt

Salts in aqueous solvents lead to solvents that are less hospitable to dissolved hydrophobic analytes and hydrophobic displacers resulting in stronger binding to hydrophobic chromatographic matrices. This is the principle behind hydrophobic-interaction chromatography (HIC). So long as solubility of the analyte is sufficient in the salt solution, the addition of salt is a good way to modulate analyte binding and selectivity to a hydrophobic matrix.

In some cases, analyte binding to a hydrophobic matrix is so weak that added salt is needed in order to obtain sufficient analyte binding. Commonly used salt solutions are 0.5-2.5M (NH₄)₂SO₄, K₂SO₄, Na₂SO₄, NaCl, KCl. With the help of many different salts at various concentrations, HIC in displacement mode offers many options for useful chromatographic separations of proteins.

### Instrument Protocols

See example protocol for Example 1 (dual pump operation). Because residual displacer from previous experiments is a potential problem, the protocol has line purging operations, a quick column regeneration and equilibration operations in order to make sure that the HPLC system and column are completely clean and properly equilibrated just before sample loading. These steps are simply precautionary and not always necessary. The protocol includes the (a) a pre-equilibration sequence, (b) an equilibration sequence, (c) a sample loading sequence (d) a displacement sequence and (e) a regeneration sequence in a single protocol. In order to overcome problems with dead-volume in the system, all loading buffers, displacer buffers and sample solutions are purged through the system to waste just prior to pumping onto the column. This way, the column sees a sharp front of undiluted solutions immediately upon valve switching. The sample solutions should be degassed so that gas bubbles do not form in them. When injection loops are used, they need to be overfilled by about 10%. The overfill can be collected for further use. Full loop injections should not be used, only partial loop injections. Experience dictates that only 85-95% of the loop volume can be used depending on the inner diameter of the loop tubing because the sample solution mixes with the driver solution and dilutes it. The sample in the loop is driven onto the column by the loading buffer, but toward the end of the sample loading process, the driving solution is changed to the displacer buffer. This allows the displacer buffer to be purged through the system just prior to the displacer buffer itself being pumped directly onto the column. During the initial part of the regeneration process, slower flow-rates are used Thus, problems with high backpressure rarely occur. Once most of the displacer has been removed, higher flow-rates can be used.

### Method Optimization

As with all forms of preparative chromatography, optimization of the chromatographic methods and procedures is important, but it requires some effort. The benefits of displacement chromatography come with a price-time. The time-consuming factors are minimized during method optimization.
Determine near optimal conditions for the displacement purification without regard for the time of the separation.
Increase the displacer concentration and the concentration of the sample loading solution until resolution decreases.
Increase the displacement flow-rate and the sample loading flow-rate until resolution decreases.
Shorten the pre-equilibration sequence and the displacer removal/column regeneration sequences.

Existing protocols provide a useful starting point for method optimization, but they will need modification for the specific sample under study. A sample protocol (Example 1) is shown below that has been optimized for purity without regard to time. It is important to carry out method optimization adapted for the specific physical properties and chromatographic properties of the sample of interest. Upon optimization, longer methods (600-800 min) often can be reduced to 200-300 minutes and in some cases reduced to 100-150 minutes.

Hydrophobic chromatography used in displacement mode has (a) high matrix productivity (gram of product per liter matrix over the lifetime of the matrix), (b) high volume productivity (gram of product per liter of column volume), (c) high solvent productivity (gram of product per liter of solvent used) yet (d) may have mediocre time productivity (gram of product per liter of unit time). Proper method optimization mitigates the time factor.

### Properly Configured Instrumentation:

A typical instrumental configuration for a small preparative HPLC system is given below.
Main Pump: stainless steel, titanium, ceramic, PEEK; accurate 0.01-10 mL/min flow-rate; 3000-4500 psi pressure.
Optional Column Bypass Valve: two-position, six-port switching valve (stainless steel, PEEK); column inline or bypass column. This is a convenience option.
Required Sample Injection Valve: two-position, six-port injection valve (stainless steel, PEEK) for injection loop or sample injection pump.
Injection Loop: 20-40 mL injection loop (stainless steel, PEEK). Loop should be overloaded (˜10%). Only partial loop injection is used, typically no more than 85-95% of loop volume. Use one, either an injection loop or a sample pump.
Sample Pump: this is similar to main pump for sample injection. Sample should be compatible with flow path of pump head. Use one, either an injection loop or a sample pump. With a two-pump operation, the flow-rates of the two pumps should be calibrated so that their flows can be matched.
No Gradient Mixer: bypass or remove the gradient mixer in displacement chromatography.
UV Detector: Multiple wavelength or photo-diode-array detector, 200-400 nm frequency range, with short-path, low-volume quartz flow-cell (0.2-2.0 mm flowpath, <10 μL flow-volume).
Optional Conductivity Detector: conductivity detector with flow cell, 0.1-200 mS, <100 μL flow-volume after UV detector; bypass conductivity flow-cell when collecting fractions for analysis at displacement flow-rate <500 μL/min.
Fraction Collector: 10 μL to 10 mL per fraction by time or by number of drops.
Column Cooler/Heater: 0-100° C.+/−0.5° C. If the column is operated at a temperature substantially different from ambient temperature, arrangements for heating or cooling the buffer solutions need to be made.

### Example 1a

### Example Protocol. Displacement Chromatography Purification of Crude Synthetic Angiotensin I

### Equipment Configuration:

Single Main Pump with 4 solvent lines, Sample Injection Valve with 40 mL Loop, Column Bypass Valve

Sample Injection Valve: 6-port valve controlled by single-channel toggle logic (S3=0, bypass loop, S3=1 loop inline)

Column Bypass Valve: 6-port valve controlled by single-channel toggle logic (S6=0, column inline, S6=1 bypass column)

UV photodiode array detector after column (flow-cell: 0.5 mm pathlength, 10 μL volume) followed by conductivity detector (flow-cell: 170 μL volume). Conductivity cell bypassed when collecting fraction for analysis.

Loading Buffer=A-Buffer (S1=1, flow on, S1=0 flow off); Displacer Buffer=B-Buffer (S2=1, flow on, S2=0 flow off);

Displacer Removal Buffer=C-Buffer (S4=1, flow on, S4=0 flow off); Column Storage Buffer=D-Buffer (S5=1, flow on, S5=0 flow off)

Before sequence begins, cleaned column briefly purged with A-buffer to remove column storage buffer. About 44 mL of degassed sample solution in a syringe is loaded into the sample injection loop; air is prevented from entering loop.

See Example 7b for description of column, details about initial sample and contents of Loading Buffer/Displacer Buffer/Sample Solution.

Displacer Removal Buffer (C-Buffer)=10% (v/v) 1-propanol, 10% (v/v) DI water in acetonitrile.

Column Storage Buffer (D-Buffer)=50/50 (v/v) acetonitrile/water with formic acid (15 mM) and ammonium formate (15 mM).

| Pump1 | Flow- | Switch | | | |
|---|---|---|---|---|---|
| Time | Rate | (S1-S6) | | | |
| (min.) | mL/min | 123456 | Operations-Functions | Comments | Volumes |
| 0.00 | 0.208 | 100000 | start Buffer A | Stabilize/Purge system | (2 min.) |
| 1.98 | 0.208 | 100000 | continue | | |
| 2.00 | 1.039 | 100001 | set column-bypass; flow-rate = 1.039 | purge A-line | (0.25 CV Buffer D) |
| 3.00 | 1.039 | 000011 | start storage Buffer D | purge D-line | (0.25 CV Buffer A) |
| 4.00 | 1.039 | 000101 | start regeneration Buffer C | purge C-line | (0.25 CV Buffer C) |
| 5.00 | 1.039 | 000100 | set column-inline; C-buffer | Start pre-equilibration | (2.0 CV Buffer C) |
| 13.00 | 1.039 | 100000 | start load buffer A | equilibrate Buffer A | (3.0 CV Buffer A) |
| 24.98 | 1.039 | 100000 | continue Buffer A | | |
| 25.00 | 0.208 | 100000 | flow-rate = 0.208 | equilibrate Buffer A | (1.0 CV Buffer A) |
| 45.00* | 0.208 | 101000 | set loop-inline; pump Buffer A into loop | Start Sample load-Loop | (27.04 mL Buffer A into loop) |
| 175.00 | 0.208 | 011000 | purge Buffer B into back of loop | 35.38/40 mL load (88.5%) | (8.34 mL Buffer B into loop) |
| 215.10* | 0.208 | 010000 | set loop-bypass; Buffer B thru column | Start Displacement | (18.1 CV buffer B) |
| 593.00* | 0.208 | 010000 | continue | | |
| 593.02 | 0.780 | 100000 | start Buffer A | Start regeneration | (0.5 CV Buffer A) |
| 595.72 | 0.780 | 000010 | start storage Buffer D | | (0.5 CV Buffer D) |
| 598.40 | 0.780 | 000100 | start regeneration Buffer C | | (1.8 CV Buffer C) |
| 608.00 | 0.780 | 000100 | continue | | |
| 608.02 | 1.039 | 000100 | set flow-rate = 1.039 | | (7.5 CV Buffer C) |
| 638.00 | 1.039 | 000010 | start storage Buffer D | | (8.5 CV Buffer D) |
| 671.96 | 1.039 | 000010 | continue storage Buffer D | | |
| 671.98 | 0.000 | 000010 | stop flow | | |
| 672.00 | 0.000 | 000000 | close all valves | Stop | |

### Example 1b

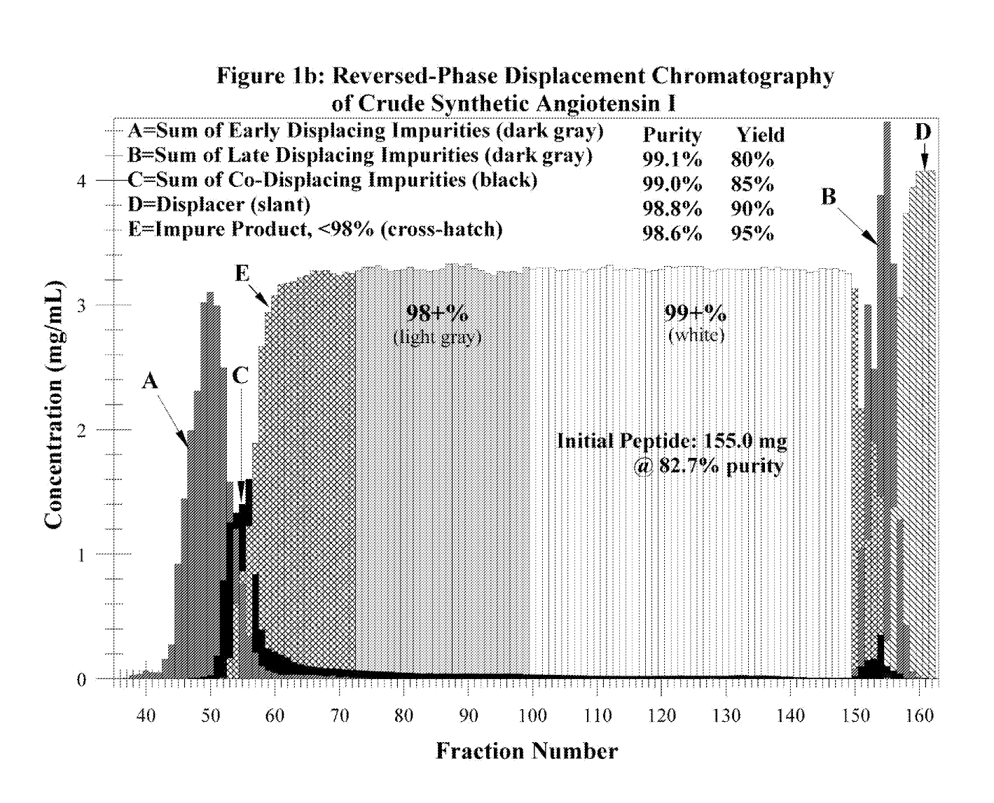

### Displacement Chromatography Purification of Crude Angiotensin I Using Displacer 14—Higher Loading at Lower Concentration (See FIG. 1b—Analysis)

### Operating Conditions:

Starting Peptide: Desalted crude synthetic Angiotensin I, 82.7% purity, FW˜1.296 mg/μmole,
charge=+4

Column: Waters Xbridge BEH130, 5 μm, 135 Å, 4.6×250 mm SS, —C₁₈ on silica

Flow-Rates: Loading=208 μL/min; Displacement=208 μL/min

Ion-Pairing Agent: Trifluoroacetate (CF₃CO₂⁻)

Temperature: 23° C.

pH: 2.0

Displacer Buffer: 10.0 mM Displacer 14+12 mM CF₃CO₂H in DI water w/ 3% (v/v) MeCN, pH=2.0
w/ NH₄OH

Loading Buffer: 12 mM TFA in water w/ 3% (v/v) MeCN, pH=2.0 w/ NH₄OH

Sample Solution: 4.38 mg/mL peptide in water with 3% (v/v) MeCN and 27 mM CF₃CO₂⁻; pH=2.0
w/ NH₄OH

Load Amount: 155.0 mg, 35.4 mL from 40 mL loop;

Loading Time: 170.1 min. (2.84 hr)

Fraction Size: 416 μL

### Results:

| Fraction | Fractions diluted (20 μL sample + 40 μL loading | | | |
|---|---|---|---|---|
| Analysis: | buffer) and analyzed (25 μL injection) by analytical | | | |
| | elution HPLC at 215 nm; calculations based on area %. | | | |
| Total Run | 8.4 hr | | | |
| Time: | | | | |
| Output | 3.29 mg/mL | | | |
| Concentration: | | | | |
| Column | 71.2% of maximum capacity | | | |
| Loading: | | | | |
| Column | ~52.4 mg peptide/mL matrix @ 3.29 mg peptide/mL | | | |
| Capacity: | solution ~167 μmole displacer/mL matrix @ | | | |
| | 10.0 μmole displacer/mL solution | | | |
| Purity %: | 99.1% | 99.0% | 98.8% | 98.6% |
| Yield %: | 80% | 85% | 90% | 95% |

### Comments: Sample Conc./Output Conc.=1.3

Amount CF₃CO₂⁻ in sample=2.0 times stoichiometric.

Excellent results are obtained. Good loading (37.3 g/L), good purity and good yield (>99% purity @ 80% yield; >98.5% purity @ 95% yield) are all obtained at the same time in this example where a small “analytical-type” column is used. This illustrates the power of optimized reversed-phase displacement chromatography.

### Example 2

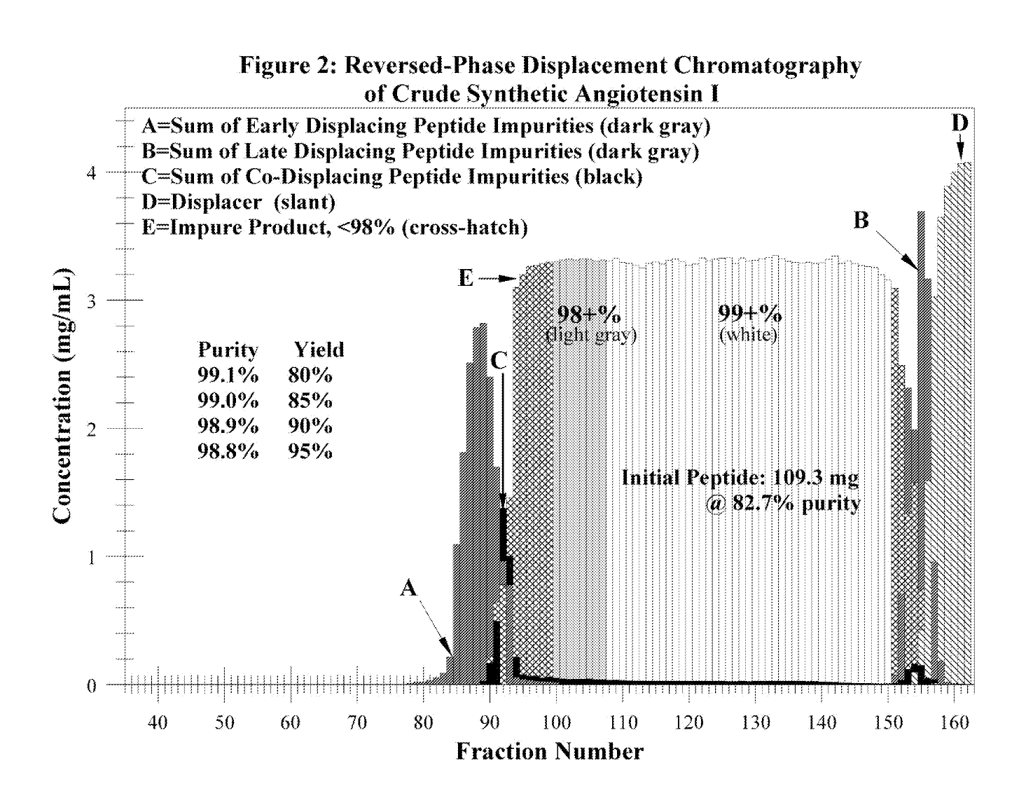

### Displacement Chromatography Purification of Crude Angiotensin I Using Displacer 14—Lower Loading at Higher Concentration (See FIG. 2—Analysis)

### Operating Conditions:

Starting Peptide: Desalted crude synthetic Angiotensin I, 82.7% purity, FW˜1.296 mg/μmole,
charge=+4

Column: Waters Xbridge BEH130, 5 μm, 135 Å, 4.6×250 mm SS, —C₁₈ on silica

Flow-Rates: Loading=208 μL/min; Displacement=208 μL/min

Ion-Pairing Agent: Trifluoroacetate (CF₃CO₂⁻)

Temperature: 23° C.

pH: 2.0

Displacer Buffer: 10.0 mM Displacer 14+12 mM CF₃CO₂H in DI water w/ 3% (v/v) MeCN, pH=2.0
w/ NH₄OH

Loading Buffer: 12 mM TFA in water w/ 3% (v/v) MeCN, pH=2.0 w/ NH₄OH

Sample Solution: 24.0 mg/mL peptide in water with 3% (v/v) MeCN and 140 mM CF₃CO₂⁻; pH=2.0
w/ NH₄OH

Load Amount: 109.3 mg, 4.56 mL from 5 mL loop

Loading Time: 21.9 min. (0.37 hr)

Fraction Size: 458 μL

### Results:

| Fraction | Fractions diluted (20 μL sample + 40 μL loading | | | |
|---|---|---|---|---|
| Analysis: | buffer) and analyzed (25 μL injection) by analytical | | | |
| | elution HPLC at 215 nm; calculations based on area %. | | | |
| Total Run | 5.9 hr | | | |
| Time: | | | | |
| Output | 3.30 mg/mL | | | |
| Concentration: | | | | |
| Column | 50.1% of maximum capacity | | | |
| Loading: | | | | |
| Column | ~52.5 mg peptide/mL matrix @ 3.30 mg | | | |
| Capacity: | peptide/mL solution ~167 μmole displacer/mL matrix @ | | | |
| | 10.0 μmole displacer/mL solution | | | |
| Purity %: | 99.1% | 99.0% | 98.9% | 98.8% |
| Yield %: | 80% | 85% | 90% | 95% |

### Comments: Sample Conc./Output Conc.=7.3

Amount CF₃CO₂⁻ in sample=1.9 times stoichiometric.

Good results are obtained with moderate loading (26.3 g/L), good purity and good yield (>99% purity @ 85% yield; >98.5% purity @ 95% yield) using a small “analytical-type” column. Total run-time is shortened (5.9 hr) because sample loading time is shortened (2.84 hr to 0.37 hr). Similar results at ˜70% sample loading give inferior purities (data not shown) so loading percentage is reduced to about 50% at which point purity levels are improved. These data show that lower percent column loading can effectively compensate for reduced resolution caused by loading the sample at concentrations that are too high (7.3×). Thus, there is a tradeoff if high purity and high yield are to be maintained: (a) higher sample loading and longer time or lower sample loading and shorter time. For some samples that contain easy to remove impurities, high sample loading and shorter time can still lead to high purity and high yield.

### Example 3

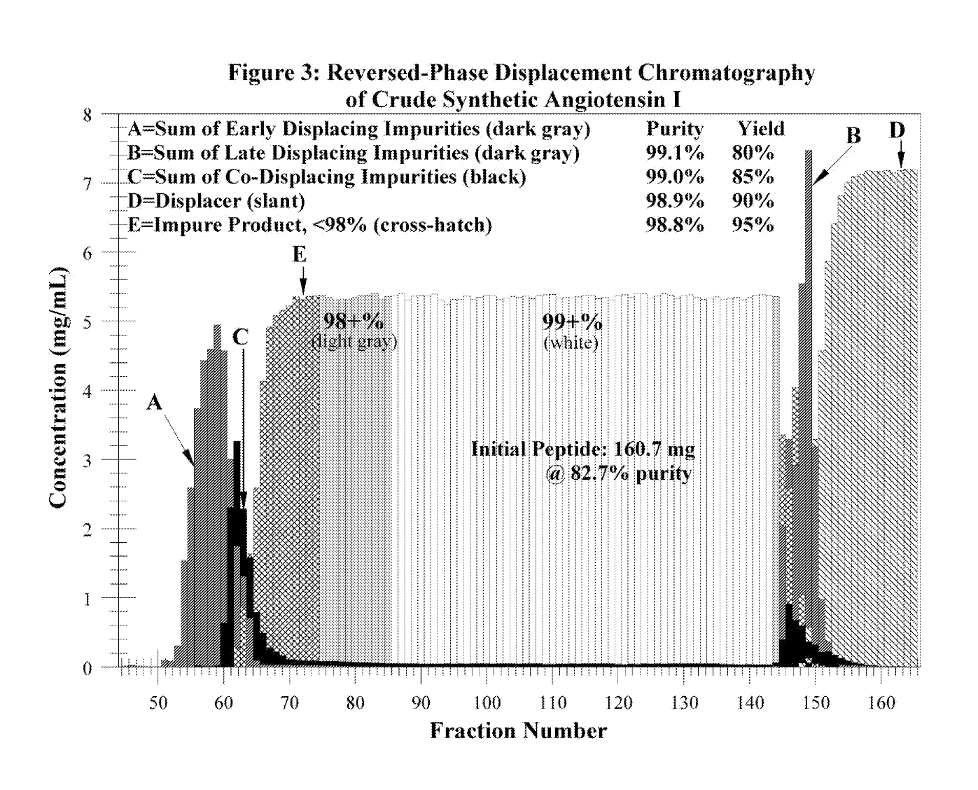

### Displacement Chromatography Purification of Crude Angiotensin I Using Displacer 413—Different Displacer with “Lower Binding-Isotherm” (See FIG. 3—Analysis)

### Operating Conditions:

Starting Peptide: Desalted crude synthetic Angiotensin I, 82.7% purity, FW˜1.296 mg/μmole, charge=+4

Column: Waters Xbridge BEH130, 5 μm, 135 Å, 4.6×250 mm SS, —C₁₈ on silica

Flow-Rates: Loading=208 μL/min; Displacement=208 μL/min

Ion-Pairing Agent: Trifluoroacetate (CF₃CO₂⁻)

Temperature: 23° C.

pH: 2.0

Displacer Buffer: 10.0 mM Displacer 413+12 mM CF₃CO₂H in DI water w/ 3% (v/v) MeCN, pH=2.0
w/ NH₄OH

Loading Buffer: 12 mM TFA in water w/ 3% (v/v) MeCN, pH=2.0 w/ NH₄OH

Sample Solution: 7.27 mg/mL peptide in water with 3% (v/v) MeCN and 43 mM CF₃CO₂⁻; pH=2.0
w/ NH₄OH

Load Amount: 160.7 mg, 22.1 mL from 30 mL loop

Loading Time: 106.3 min. (1.77 hr)

Fraction Size: 312 μL

### Results:

| Fraction | Fractions diluted (10 μL sample + 40 μL loading | | | |
|---|---|---|---|---|
| Analysis: | buffer) and analyzed (25 μL injection) by analytical | | | |
| | elution HPLC at 215 nm; calculations based on area %. | | | |
| Total Run | 5.6 hr | | | |
| Time: | | | | |
| Output | 5.38 mg/mL | | | |
| Concentration: | | | | |
| Column | 66.7% of maximum capacity | | | |
| Loading: | | | | |
| Column | ~58.0 mg peptide/mL matrix @ 5.38 mg | | | |
| Capacity: | peptide/mL solution ~115 μmole displacer/mL matix @ | | | |
| | 10.0 μmole displacer/mL solution | | | |
| Purity %: | 99.1% | 99.0% | 98.9% | 98.8% |
| Yield %: | 80% | 85% | 90% | 95% |

### Comments: Sample Conc./Output Conc.=1.3

Amount CF₃CO₂⁻ in sample=1.9 times stoichiometric.

Excellent results are obtained with good loading (38.7 g/L), excellent purity and excellent yield (>99% purity @ 85% yield; >98.5% purity @ 95% yield) using a small “analytical-type” column. Run-time is shortened (5.6 hr) because both sample loading time and displacement time are shortened owing to the higher sample loading and higher operating concentrations which are, in turn, caused by the “lower binding-isotherm” of Displacer 413. In this example, the same column and same peptide is used, but the displacer is changed (compare Example 1 b). These results show that equally good purities and yields are obtained when working higher on the binding-isotherms of the product and impurities. Because less Displacer 413 is needed to saturate the column at 10 mM (115 vs 167 μmole displacer/mL matrix), the peptide comes off the column at higher concentration (5.38 vs 3.19 mg/mL), and the experiment operates higher on the peptide binding-isotherm (58.0 vs 52.5 mg peptide/mL matrix).

### Example 4

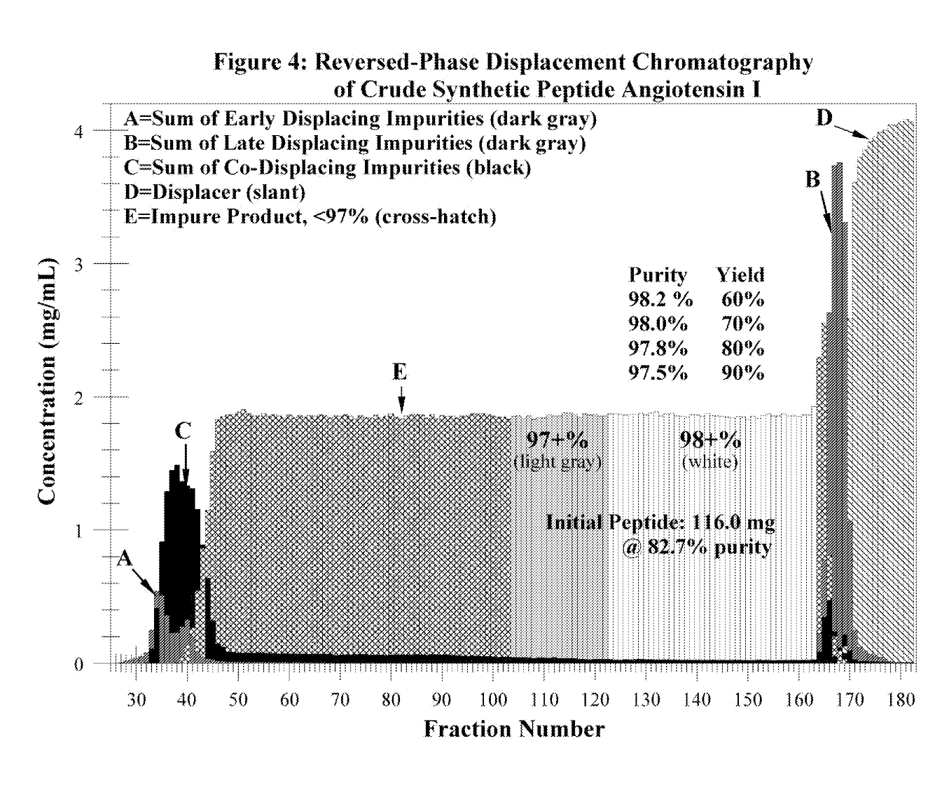

### Displacement Chromatography Purification of Crude Angiotensin I Using Displacer 14—Different Reversed-Phase Column (See FIG. 4—Analysis)

### Operating Conditions:

Starting Peptide: Desalted crude synthetic Angiotensin I, 82.7% purity, FW˜1.296 mg/μmole, charge=+4

Column: Varian/Polymer Labs PLRP-S, 5 μm, 100 Å, 4.6×250 mm SS, uncoated porous
polystyrene/divinylbenzene

Flow-Rates: Loading=208 μL/min; Displacement=208 μL/min

Ion-Pairing Agent: Trifluoroacetate (CF₃CO₂⁻)

Temperature: 23° C.

pH: 2.0

Displacer Buffer: 10.0 mM Displacer 14+12 mM CF₃CO₂H in DI water w/ 3% (v/v)

MeCN, pH=2.0 w/ NH₄OH

Loading Buffer: 12 mM TFA in water w/ 3% (v/v) MeCN, pH=2.0 w/ NH₄OH

Sample Solution: 3.50 mg/mL peptide in water with 3% (v/v) MeCN and 22 mM CF₃CO₂⁻; pH=2.0 w/ NH₄OH

Load Amount: 116.0 mg, 33.2 mL from 40 mL loop

Loading Time: 159.4 min. (2.66 hr)

Fraction Size: 458 μL

### Results:

| Fraction | Fractions diluted (30 μL sample + 20 μL loading | | | |
|---|---|---|---|---|
| Analysis: | buffer) and analyzed (25 μL injection) by analytical | | | |
| | elution HPLC at 215 nm; calculations based on area %. | | | |
| Total Run | 9.7 hr | | | |
| Time: | | | | |
| Output | 1.86 mg/mL | | | |
| Concentration: | | | | |
| Column | 73.2% of maximum capacity | | | |
| Loading: | | | | |
| Column | ~38.1 mg peptide/mL matrix @ 1.86 mg peptide/mL | | | |
| Capacity: | solution ~212 μmole displacer/mL matrix @ | | | |
| | 10.0 μmole displacer/mL solution | | | |
| Purity %: | 98.2% | 98.0% | 97.8% | 97.5% |
| Yield %: | 60% | 75% | 80% | 90% |

### Comments: Sample Conc./Output Conc.=2.0

Amount CF₃CO₂⁻ in sample=2.0 times stoichiometric.

Good results are obtained with low-to-moderate loading (27.9 g/L), moderate purity and reasonable yield (>97.5% purity @ 90% yield) using a small “analytical-type” column. This example is designed to show a side-by-side comparison of two columns using the same peptide and same displacer (compare Example 1b). Generally speaking, the results for the polystyrene column are good, but not as good as those for the C₁₈-on-silica column. Total run time is somewhat longer, column binding capacity is lower and final purity is somewhat lower (97.5% vs 98.5-99.0%). By adjusting the type of displacer, its concentration and the ion-pairing agent (data not shown), total run-times are shortened, and binding capacities are increased approaching those for the C₁₈-on-silica columns. However, product purities largely remain about the same as this run on the polystyrene column. These results generally correspond to data from preparative elution chromatography that suggest that polystyrene columns give reduced chromatographic resolution compared to C₁₈-on-silica columns.

### Example 5

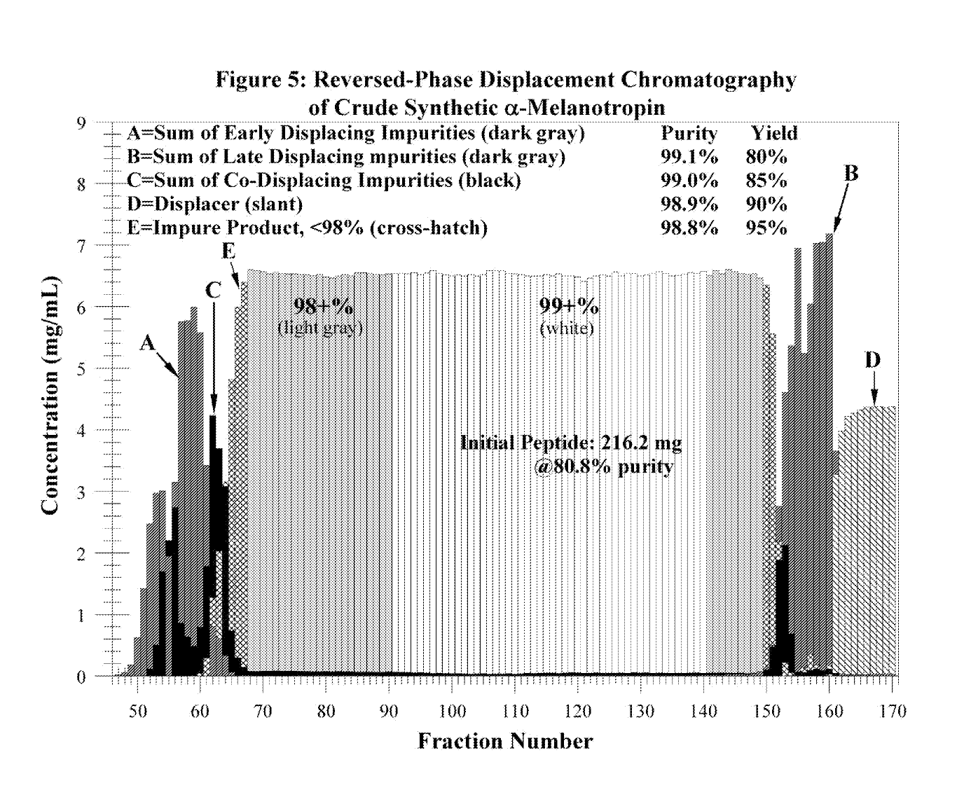

### Displacement Chromatography Purification of Crude α-Melanotropin Using Displacer 318—Different Peptide and Different Displacer (See FIG. 5—Analysis)

### Operating Conditions:

Starting Peptide: Desalted crude synthetic α-Melanotropin, 80.8% purity, FW˜1.665 mg/μmole, charge=+3

Column: Waters Xbridge BEH130, 5 μm, 135 Å, 4.6×250 mm SS, —C₁₈ on silica

Flow-Rates: Loading=208 μL/min; Displacement=208 μL/min

Ion-Pairing Agent: Trifluoroacetate (CF₃CO₂⁻)

Temperature: 23° C.

pH: 2.0

Displacer Buffer: 10.0 mM Displacer 318+12 mM CF₃CO₂H in DI water w/ 3% (v/v) MeCN, pH=2.0 w/ NH₄OH

Loading Buffer: 12 mM TFA in water w/ 3% (v/v) MeCN, pH=2.0 w/ NH₄OH

Sample Solution: 9.04 mg/mL peptide in water with 3% (v/v) MeCN and 33 mM

CF₃CO₂⁻; pH=2.0 w/ NH₄OH

Load Amount: 216.2 mg, 23.9 mL from 30 mL loop

Loading Time: 115.0 min.

Fraction Size: 312 μL

### Results:

| Fraction | Fractions diluted (10 μL sample + 50 μL loading | | | |
|---|---|---|---|---|
| Analysis: | buffer) and analyzed (25 μL injection) by analytical | | | |
| | elution HPLC at 215 nm; calculations based on area %. | | | |
| Total Run | 6.2 hr | | | |
| Time: | | | | |
| Output | 6.52 mg/mL | | | |
| Concentration: | | | | |
| Column | 66.7% of maximum capacity | | | |
| Loading: | | | | |
| Column | ~79.3 mg peptide/mL matrix @ 6.52 mg | | | |
| Capacity: | peptide/mL solution ~129 μmole displacer/mL matrix | | | |
| | @ 10.0 μmole displacer/mL solution | | | |
| Purity %: | 99.1% | 99.0% | 98.9% | 98.8% |
| Yield %: | 80% | 85% | 90% | 95% |

### Comments: Sample Conc./Output Conc.=1.4

Amount CF₃CO₂⁻ in sample=2.0 times stoichiometric amount.

Excellent results are obtained with good loading (52.0 g/L), good purity and good yield (>99% purity @ 85% yield; >98.5% purity @ 95% yield) using small “analytical-type” column. This example is designed to show a side-by-side comparison (see Example 1 b) on the same column (C₁₈-on-silica) using a different peptide and a different displacer. α-Melanotropin has a higher intrinsic binding capacity, and less Displacer 318 is needed to saturate the column (129 vs 167 μmole displacer/mL). Both of these factors together lead to a higher binding capacity for the peptide (79.3 vs 52.4 g peptide/L matrix), yet the displacement train sharpens nicely giving both high purity and high yield.

### Example 6a

### Example Protocol and Displacement Train. Displacement Chromatography Purification of Crude Synthetic α-Endorphin

### Equipment Configuration:

Main Pump(1) with 4 solvent lines, Sample Loading Pump(2) with 2 solvent lines, Pump Selector Valve

Pump Selector Valve: 6-port valve controlled by single-channel toggle logic (S3=0, Pump1 to column-Pump2 to waste, S3=1 Pump1 to waste-Pump2 to column)

UV photodiode array detector after column (flow-cell: 0.5 mm pathlength, 9 □L volume) followed by conductivity detector (flow-cell: 170 □L volume).

Loading Buffer=A-Line on Pump1 (S1=1, flow on, S1=0 flow off); Displacer Buffer=B-Line on Pump 1 (S2=1, flow on, S2=0 flow off); Displacer Removal Buffer=C-Line on Pump1 (S4=1, flow on, S4=0 flow off); Column Storage Buffer=D-Line on

Pump1 (S5=1, flow on, S5=0 flow off); Loading Buffer=A-Line on Pump2 (S6=1, flow on, S6=0, flow off); Sample Solution=B-Line on Pump2 (S7=1, flow on, S7=0 flow off).

Before sequence begins, cleaned column briefly purged with A-buffer to remove column storage buffer.

See Example 12b for description of column, details about initial sample and contents of Loading Buffer/Displacer Buffer/Sample Solution.

Displacer Removal Buffer (C-Buffer)=10% (v/v) 1-propanol, 10% (v/v) DI water in acetonitrile.

Column Storage Buffer (D-Buffer)=50/50 (v/v) acetonitrile/water with formic acid (15 mM) and ammonium formate (15 mM).

| | Flow- | Control | Flow- | | | | |
|---|---|---|---|---|---|---|---|
| Time | Rate-1 | Switches | Rate-2 | Pump 1 | Pump 2 | | |
| (min.) | (mL/min) | 1234567 | (mL/min) | Operations - Functions | Operations - Functions | Comments | Volumes |
| 0.00 | 4.909 | 1010010 | 1.061 | purge Buffer A to waste | Buffer A to column | Purge System (A-line) | 1,.5 min. |
| 1.50 | 4.909 | 0010110 | 1.061 | purge Buffer D to waste | | purge D-line | (0.37 CV Buffer D |
| | | | | | | | to waste) |
| 3.00 | 4.909 | 0011010 | 1.016 | purge Buffer C to waste | | purge C-line | (0.50 CV Buffer A |
| | | | | | | | to wasste) |
| 5.00 | 4.909 | 0001010 | 1.016 | Buffer C to column | purge Buffer A to waste | Start pre-equilibration | (2.0 CV Buffer C |
| | | | | | | | to column) |
| 5.50 | 4.909 | 0001010 | 1.016 | | continue | | |
| 5.52 | 4.909 | 0001010 | 0.000 | | flow-rate = 0.000 | | |
| 13.00 | 4.909 | 1000010 | 0.000 | Buffer A to column | | equilibrate Buffer A | (3.0 CV Buffer A) |
| 24.98 | 4.909 | 1000010 | 0.000 | continue | | | |
| 25.00 | 0.961 | 1000010 | 0.000 | flow-rate = 0.961 | | equilibrate Buffer A | (1.03 CV Buffer A) |
| 42.98 | 0.961 | 1000010 | 0.000 | | continue | | |
| 43.00 | 0.961 | 1000001 | 1.016 | | purge Sample to waste | purge Sample to waste | |
| 46.00 | 0.961 | 1010001 | 1.016 | purge Buffer A to waste | load Sample to column | Start Sample load-Pump2 | |
| 46.10 | 0.010 | 1010001 | 1.016 | set flow-rate to 0.010 | | slow purge Pump1 | |
| 243.98 | 0.010 | 1010001 | 1.016 | | | | |
| 246.80 | 0.961 | 0110001 | 1.016 | purge Buffer B to waste | purge B-line | | (4.0 mL Buffer B) |
| 251.00 | 0.961 | 0100001 | 1.016 | B-buffer to column | purge Sample to waste | Start Displacement-Pump1 | (17.96 CV Buffer B) |
| 251.50 | 0.961 | 0100010 | 1.016 | | purge Buffer A to waste | wash Pump2 | 6.1 mL Buffer A to |
| | | | | | | | waste) |
| 257.00 | 0.961 | 0100010 | 1.016 | | continue | | |
| 257.02 | 0.961 | 0100010 | 0.000 | | stopflow-Pump2 | | |
| 257.04 | 0.961 | 0100000 | 0.000 | | close valves-Pump2 | stop Pump2 | |
| 618.00 | 0.961 | 0100000 | 0.000 | continue | | | |
| 618.02 | 3.682 | 1000000 | 0.000 | Buffer A to column | | Start Reqeneration-Pump1 | (0.5 CV Buffer A |
| | | | | | | | slow flow) |
| 620.72 | 3.681 | 0000100 | 0.000 | Buffer D to column | | | (0.5 CV Buffer D |
| | | | | | | | slow flow) |
| 623.40 | 3.682 | 0001000 | 0.000 | Buffer C to column | | | (1.8 CV Buffer C |
| | | | | | | | slow flow) |
| 633.00 | 3.682 | 0001000 | 0.000 | continue | | | |
| 633.02 | 4.909 | 0001000 | 0.000 | flow-rate = 4.909 | | | (7.5 CV Buffer C |
| | | | | | | | fast flow) |
| 663.00 | 4.909 | 0000100 | 0.000 | start storage buffer D | | | (8.5 CV Buffer D |
| | | | | | | | fast flow) |
| 696.96 | 4.909 | 0000100 | 0.000 | continue storage D-buffer | | | |
| 696.98 | 0.000 | 0000100 | 0.000 | stop flow | | | |
| 697.00 | 0.000 | 0000000 | 0.000 | close all valves | | Stop Pump1 | |

### Example 6b

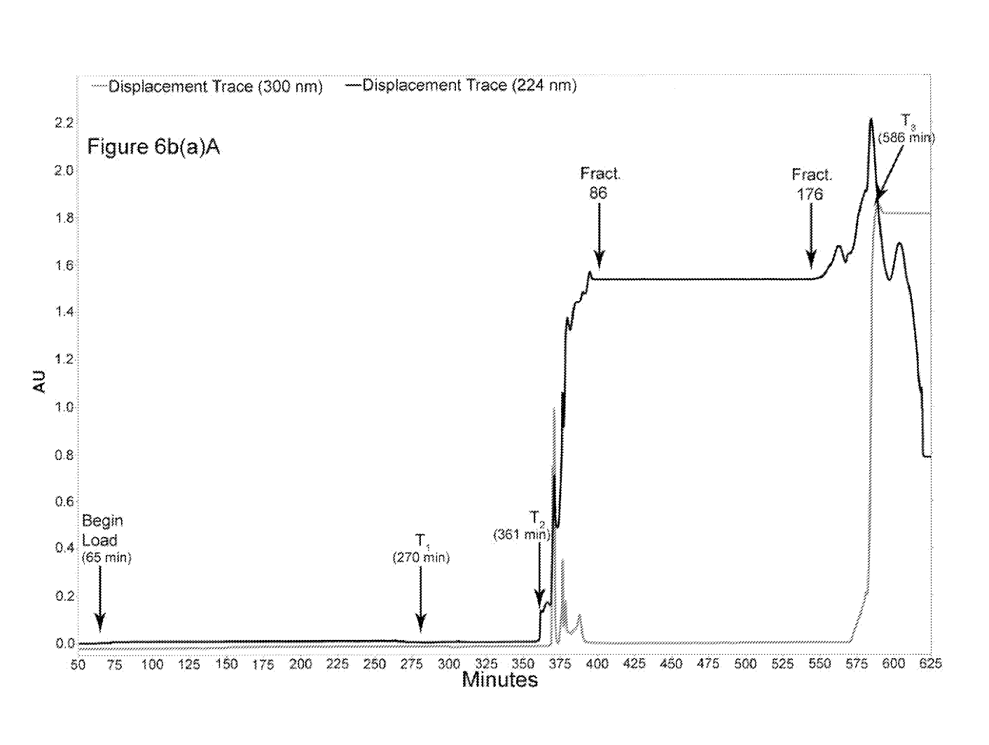

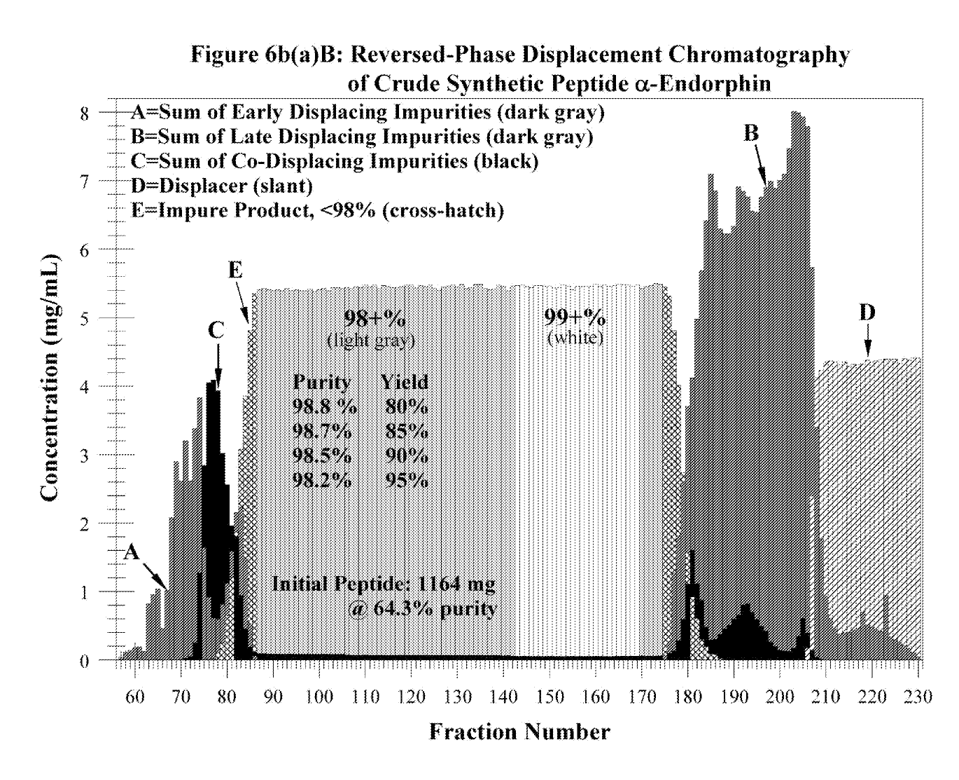

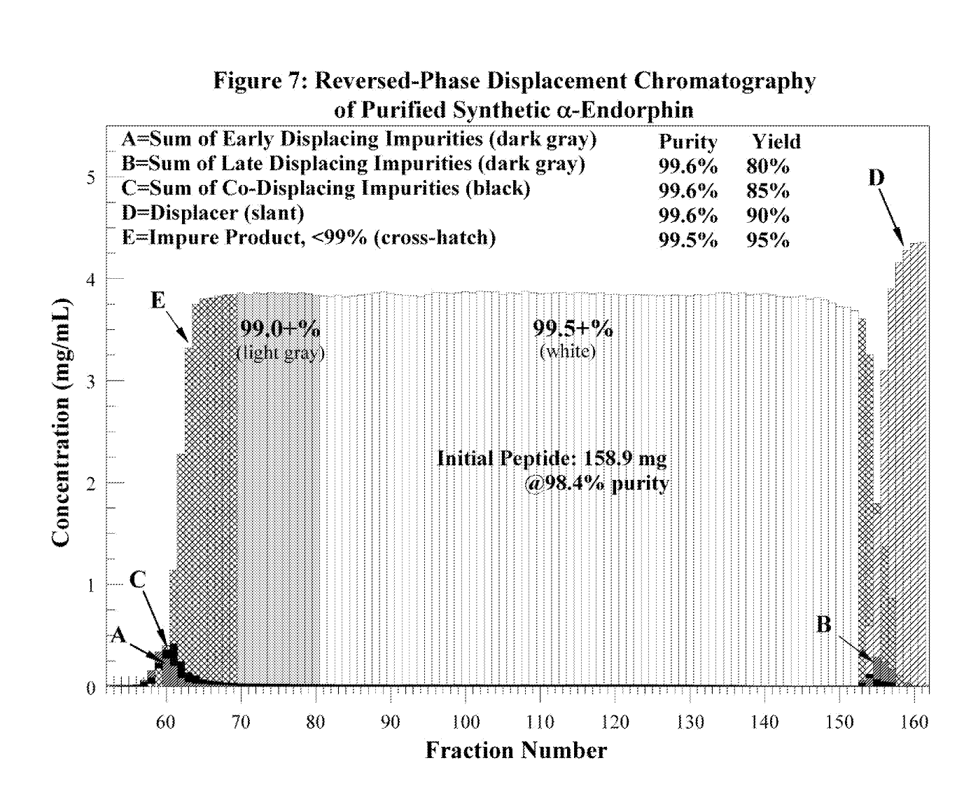

### Displacement Chromatography Purification of Crude Synthetic α-Endorphin Using Displacer 198—Larger Particles, Larger Columns and Lower Initial Purity (See FIG. 6b(a)A—Displacement Trace; FIG. 6b(a)B—Analysis)

### Operating Conditions:

Starting Peptide: Desalted crude synthetic α-Endorphin, 64.3% purity, FW˜1.746 mg/μmole, charge=+2 all on —C₁₈ on silica

Column: 6b(a): Waters Xbridge BEH130, 5 μm, 135 Å, 10.0×250 mm SS, —C₁₈ on silica
6b(b): Waters Xbridge BEH130, 10 μm, 135 Å, 10.0×250 mm SS, —C₁₈ on silica
6b(c): Waters Xbridge BEH130, 10 μm, 135 Å, 10.0×500 (2×250) mm SS, —C₁₈ on silica

Flow-Rates: Loading=1016 μL/min; Displacement=961 μL/min for all three experiments.

Ion-Pairing Agent: Trifluoroacetate (CF₃CO₂⁻)

Temperature: 23° C.

pH: 2.0

Displacer Buffer: 10.0 mM Displacer 198+12 mM CF₃CO₂H in DI water w/ 3% (v/v) MeCN, pH=2.0

Loading Buffer: 12 mM TFA in water w/ 3% (v/v) MeCN, pH=2.0 w/ NH₄OH

Sample Solution:
(a) 5.59 mg/mL peptide in water with 3% (v/v) MeCN and 26 mM CF₃CO₂⁻; pH=2.0
(b) 5.59 mg/mL peptide in water with 3% (v/v) MeCN and 26 mM CF₃CO₂⁻; pH=2.0
(c) 11.18 mg/mL peptide in water with 3% (v/v) MeCN and 52 mM CF₃CO₂⁻; pH=2.0

Load Amount:
(a) 1164 mg, 208.3 mL from loading pump; Loading Time=205.0 min.
(b) 1164 mg, 208.3 mL from loading pump; Loading Time=205.0 min. (3.42 hr)
(c) 2329 mg, 208.3 mL from loading pump; Loading Time=205.0 min. (3.42 hr)

Fraction Sizes: (a) 1.49 mL (b) 1.49 mL (c) 2.98 mL

Results-6b(a) (see FIGS. 6b(a)A and 6b(a)B)

| Fraction | Fractions diluted (10 μL sample + 40 μL loading | | | |
|---|---|---|---|---|
| Analysis: | buffer) and analyzed (25 μL injection) by analytical | | | |
| | elution HPLC at 215 nm; calculations based on area %. | | | |
| Total Run | 8.9 hr | | | |
| Time: | | | | |
| Output | 5.47 mg/mL | | | |
| Concentration: | | | | |
| Column | 70.5% of maximum capacity | | | |
| Loading: | | | | |
| Column | ~84.1 mg peptide/mL matrix @ 5.47 mg | | | |
| Capacity: | peptide/mL solution ~161 μmole displacer/mL matrix | | | |
| | @ 10.0 μmole displacer/mL solution | | | |
| Purity %: | 98.8% | 98.7% | 98.5% | 98.2% |
| Yield %: | 80% | 85% | 90% | 95% |

Results-6b(b) (no Figure):

| Fraction | Fractions diluted (10 μL sample + 40 μL loading | | | |
|---|---|---|---|---|
| Analysis: | buffer) and analyzed (25 μL injection) by analytical | | | |
| | elution HPLC at 215 nm; calculations based on area %. | | | |
| Total Run | 9.1 hr | | | |
| Time: | | | | |
| Output | 5.27 mg/mL | | | |
| Concentration: | | | | |
| Column | 71.3% of maximum capacity | | | |
| Loading: | | | | |
| Column | ~83.2 mg peptide/mL matrix @ 5.27 | | | |
| Capacity: | mg peptide/mL solution ~165 μmole displacer/mL | | | |
| | matrix @ 10.0 μmole displacer/mL solution | | | |
| Purity %: | 98.2% | 98.1% | 97.9% | 97.5% |
| Yield %: | 80% | 85% | 90% | 95% |

Results-6b(c) (no Figure):

| Fraction | Fractions diluted (10 μL sample + 40 μL loading | | | |
|---|---|---|---|---|
| Analysis: | buffer) and analyzed (25 μL injection) by analytical | | | |
| | elution HPLC at 215 nm; calculations based on area %. | | | |
| Total Run | 14.5 hr | | | |
| Time: | | | | |
| Output | 5.41 mg/mL | | | |
| Concentration: | | | | |
| Column | 70.7% of maximum capacity | | | |
| Loading: | | | | |
| Column | ~83.7 mg peptide/mL matrix @ 5.41 mg peptide/mL | | | |
| Capacity: | solution ~162 μmole displacer/mL matrix | | | |
| | @ 10.0 μmole displacer/mL solution | | | |
| Purity %: | 98.8% | 98.7% | 98.5% | 98.2% |
| Yield %: | 80% | 85% | 90% | 95% |

Comments: Sample Conc./Output Conc.: 1.0 (6b(a)); 1.1 (6b(b)); 2.1 (6b(c)).
Amount CF₃CO₂⁻ in sample=4.0 times stoichiometric amount (6b(a), 6b(c) & 6b(c)).

Excellent results are obtained from all three runs with good loading (59.2-59.3 g/L), high purities and good yields (>98.5% purity @ 90% yield) using “semiprep-type” columns with both 5 μm and 10 μm particle sizes. Percent loadings (70.5-71.3%) and output concentrations (5.27-5.47 mg/mL) are uniform and reproducible. These examples illustrate power and utility of optimized preparative displacement chromatography. (1) There is little difference in preparative resolution between 4.6 mm and 10.0 mm ID columns of the same length packed with the same reversed-phase matrix. (2) At 25 cm column length, both 5 μm and 10 μm matrices give good results with the 10 μm material giving slightly inferior resolution as demonstrated by slightly reduced purity (˜0.6%). (3) At 50 cm column length, the 10 μm matrix regains full resolution; simple calculations suggest that a 30-40 cm bed length is sufficiently long. (4) Two well-packed columns properly attached end-to-end function effectively in displacement chromatography experiments. (5) The best pooled purity (98.8%) for a peptide (α-Endorphin) with 60+% initial purity is not much worse than the best pooled purity (99.1%) for a peptide (Angiotensin I, α-Melanotropin) with 80 μm initial purity. (6) In many cases, 1.5-2.0 times the stoichiometric amount of ion-pairing agent is used in the sample loading solution with good results; however, with α-Endorphin, significantly better resolution is obtained with 3.5-4.0 times the stoichiometric amount of CF₃CO₂⁻.

### Example 7

### Displacement Chromatography Purification of Prepurified α-Endorphin Using Displacer 198—Different Binding-Isotherms Lead to Improved Purity (See FIG. 7—Analysis)

### Operating Conditions:

Starting Peptide: Prepurified α-Endorphin, 98.4% purity, FW˜1.746 mg/μmole, charge=+2

Column: Waters Xbridge BEH130, 5 μm, 135 Å, 4.6×250 mm SS, —C₆Ph on silica

Flow-Rates: Loading=208 μL/min; Displacement=208 μL/min

Ion-Pairing Agent: Trifluoroacetate (CF₃CO₂⁻);

Temperature: 23° C.

pH: 2.0

Displacer Buffer: 10.0 mM Displacer 198+12 mM CF₃CO₂H in DI water w/ 3% (v/v) MeCN, pH=2.0 w/ NH₄OH

Loading Buffer: 12 mM TFA in water w/ 3% (v/v) MeCN, pH=2.0 w/ NH₄OH

Sample Solution: 5.26 mg/mL peptide in water with 3% (v/v) MeCN and 21 mM CF₃CO₂⁻; pH=2.0 w/ NH₄OH

Load Amount: 158.9 mg, 30.2 mL from 40 mL loop

Loading Time: 145.2.0 min.

Fraction Size: 437 μL

### Results:

| Fraction | Fractions diluted (15 μL sample + 35 μL loading | | | |
|---|---|---|---|---|
| Analysis: | buffer) and analyzed (25 μL injection) by analytical | | | |
| | elution HPLC at 215 nm; calculations based on area %. | | | |
| Total Run | 7.3 hr | | | |
| Time: | | | | |
| Output | 3.85 mg/mL | | | |
| Concentration: | | | | |
| Column | 71.1% of maximum capacity | | | |
| Loading: | | | | |
| Column | ~53.8 mg peptide/mL matrix @ 3.85 mg | | | |
| Capacity: | peptide/mL solution ~147 μmole displacer/mL matrix | | | |
| | @ 10.0 μmole displacer/mL solution | | | |
| Purity %: | 99.6% | 99.6% | 99.6% | 99.5% |
| Yield %: | 80% | 85% | 90% | 95% |

### Comments: Sample Conc./Output Conc.=1.3

Amount CF₃CO₂⁻ in sample=3.6 times stoichiometric amount.

Excellent results are obtained with good loading (38.3 g/L), excellent purity and excellent yield (>99.5% purity @ 95% yield) using a small “analytical-type” column. This example is designed to show how purifying a prepurified sample under suitable conditions can efficiently lead to high purity peptides. (1) The sum of the impurities drops significantly from 1.6% to 0.4-0.5% with minimal loss (5-10%) in product. (2) The reduction in impurities is primarily caused by changes in binding-isotherms of product and impurities, not by improved resolution of the column. In the starting material, the 1.6% impurity is composed of 12 minor impurities 8 of which are effectively removed during this purification. The levels of the remaining 4 co-displacing components are somewhat reduced during the purification. (3) Because co-displacement of the 4 remaining impurity is the principal factor limiting final purity, the purity profile is nearly invariant from 60% recovery to 95% recovery. (4) The success of this purification results from the choice of a phenylhexyl column with different binding-isotherms. An attempt to carry out a similar displacement chromatography purification of the same sample on an octaadecyl (C₁₈) column failed to yield significant improvement (data not shown). This is likely the case because the octadecyl column is used to purify the sample from crude material in the first step. (5) These results show that two back-to-back displacement purifications can routinely lead to high-yield production of high-purity peptides.

### Example 8

### Displacement Chromatography Purification of Crude Angiotensin I Using Displacer 14—Using Different Ion-Pairing Anions, Concentrations and Mixtures

All operating conditions for the seven experiments in Example 7 are the same except that the counter-ion for the displacer and the added amounts of ion-pairing anion (acid). In all cases, the operating pH is the same (pH=2.0). In order to reduce the amount of analytical work, comparative purity data is given for a pool of the center 15 fractions. Because the level of co-displacement is nearly invariant across the major displacement band for a given displacement experiment, analytical data from this method of pooling gives representative and comparable results.

### Results:

| | | | Center-cut |
|---|---|---|---|
| Displacer Buffer | Load Buffer | Sample SoIn. | Purity |
| A^{a} 10 mM [D][CF₃CO₂] + | 12 mM CF₃CO₂H | 27 mM CF₃CO₂H | 99.1% |
| 12 mM CF₃CO₂H | | | |
| B 10 mM [D][Br] + | 12 mM HBr | 27 mM HBr | 99.0% |
| 12 mM HBr | | | |
| C 10 mM [D][Cl] + | 12 mM HCl | 27 mM HCl | 98.6% |
| 12 mM HCl | | | |
| D 10 mM [D][Br] + | 12 mM CF₃CO₂H | 27 mM CF₃CO₂H | 98.1% |
| 12 mM CF₃CO₂H | | | |
| E 10 mM [D][Cl] + | 12 mM CF₃CO₂H | 27 mM CF₃CO₂H | 99.0% |
| 12 mM CF₃CO₂H | | | |
| F 10 mM [D][Cl] + | 24 mM CF₃CO₂H | 27 mM CF₃CO₂H | 99.1% |
| 24 mM CF₃CO₂H | | | |
| G 10 mM [D][Cl] + | 6 mM CF₃CO₂H | 27 mM CF₃CO₂H | 96.7% |
| 6 mM CF₃CO₂H | | | |

Note:
a) Example 1

### Comments:

Generally good results are obtained under most conditions except experiment “G”. There are clear results from this study regarding types, mixtures and levels of ion-pairing anions.
1. Trifluoroacetate-only (A) and bromide-only (B) experiments yield similar results (0.9-1.0% impurity) while those for the chloride-only (C) experiment gives higher impurity levels (1.4% inpurity). Thus, trifluoroacetate and bromide are better ion-pairing agents than chloride.
2. Mixed trifluoroacetate-chloride (E, F) experiments give about the same impurity levels as trifluoroacetate-only experiments as long as enough trifluoroacetate is present (0.9-1.0% impurity). In contrast, the mixed trifluoroacetate-bromide (D) experiment gives worse results; the impurity level increases from 0.9% to 1.9%. While trifluoroacetate-only (A) and bromide-only (B) experiments give good results, the mixture of anions does not. Apparently, a mixture of two ion-pairing anions of similar (but no the same) ion-pairing strength interfere with each other resulting in band broadening and higher impurity levels. The presence two ion-pairing anions of significantly different ion-pairing strength results in the stronger one dominating (as long there is enough of it present) and lower impurity levels result.
3. The worst results (G) are obtained when two ion-pairing agents are present (Cl⁻, CF₃CO₂⁻) and the stronger one is present in substiochiometric amounts. This results in “double-banding” where the displacer and many components of the mixture come off the column as two bands, the first one as the chloride salt and the second as the trifluoroacetate salt. This leads to significant band broadening and overlap of each double-banded component thereby increasing the overall impurity level from 0.9% to 3.3%. Adding insufficient amounts of trifluoroacetate (stronger ion-pairing anion) gives worse results than having no trifluoroacetate at all (3.3% impurity vs 1.4% impurity). Adding higher levels of trifluoroacetate in excess of the stoichiometric amount causes the impurity levels to decrease again (3.3% to 0.9%).
4. Note that the above results apply only to the levels of trifluoroacetate (ion-pairing anion) in the displacer buffer. There was sufficient trifluoroacetate in the sample loading solution. When there is a deficiency of trifluoroacetate in the sample solution, impurity levels become even higher (data not shown).

### Example 9

### HPLC Analyses

Methods 9a, 9b—Reversed-Phase for Cations:

Analyses were carried out using Waters Corp. (Milford, Mass.) gradient HPLC equipped with a Waters 996 PDA detector in tandem with a Dionex/ESA Biosciences (Chelmsford, Mass.) Corona Plus CAD detector and a Waters Xbridge BEH130, 5 μm, 135 Å, 4.6×250 mm SS, —C₁₈ on silica, reversed-phase chromatography column (Chelmsford, Mass.).

Sample Injection: 25 μL of ˜1 mM sample solution in A buffer

UV detection: 208-220 nm depending on compounds to be analyzed

Flow-Rate: 1.0 mL/min.

A buffer: 5% CH₃CN (v/v) in HPLC-grade dist. water with 0.1% (v/v) trifluoroacetic acid

B buffer: 5% H₂O (v/v) in HPLC-grade CH₃CN with 0.1% (v/v) trifluoroacetic acid. Survey Gradient Method:

| | |
|---|---|
| 100% A | 0-2 min |
| 100% A to 100% B | 2-62 min |
| 100% B | 62-70 min |

### Analytical Gradient Method

| | |
|---|---|
| 10% B | 0-2 min |
| 10% B to 50% B | 2-57 min |
| 50% B to 100% B | 57-62 min |
| 100% B | 62-67 min |

Method 9c—Reversed-Phase for Long-Chain Alkyl Halides:

Sample Injection: 25 μL of ˜1 mM sample solution in A buffer

UV detection: 200-220 nm depending on compounds to be analyzed

Flow-Rate: 1.0 mL/min.

A buffer: 5% CH₃CN (v/v) in HPLC-grade distilled water with 0.1% (v/v) trifluoroacetic acid.

B buffer: 5% H₂O (v/v) in HPLC-grade CH₃CN with 0.1% (v/v) trifluoroacetic acid. Gradient Method:

| | |
|---|---|
| 50% A/50% B | 0-2 min |
| 50% A/50% B to 100% B | 2-62 min |
| 100% B | 62-70 min |

### Example 10

### Preparation of N-Decylpyrrolidine (fw=211.39)

426.7 g Freshly distilled pyrrolidine (6.0 mole, fw=71.12, ˜500 mL) is added to 500 mL stirring acetonitrile in a 2 L 4-neck round-bottom flask that is equipped with a heating mantle, mechanical stirrer, 500 mL addition funnel, reflux condensor and teflon-coated thermocouple. The reaction is carried out under a nitrogen atmosphere with a slow N₂ purge. 442.4 g Freshly distilled 1-bromodecane (2.0 mole, fw=221.19, ˜415 mL) is added to the stirring mixture in a dropwise fashion at such a rate that the reaction exotherm maintains the reaction temperature in the range 45-55° C. Under these conditions, the bromodecane addition requires about 2 hours. After the entire bromodecane is added and the reaction temperature drops below 45° C., the stirring reaction mixture is heated to 80° C. for 1 hr and then allowed cool. The reaction mixture is periodically monitored by HPLC (Method 10g) in order to ensure that the bromodecane is entirely consumed. During the reaction, a less dense upper layer of the product begins to form that increases in volume as the reaction mixture cools to ambient temperature. Upon cooling as the reaction temperature reaches about 50° C., 100 mL distilled water is added portionwise to the stirring mixture in order to facilitate phase separation and prevent crystallization of pyrrolidine hydrobromide. When the reaction temperature is below 30° C., it is transferred to a 2 L separatory funnel and allowed to stand for about 3 hours in order to allow for full phase separation. The upper phase is retained in the funnel, 1.0 L 10% w/w NaOH in distilled water is added, the mixture is thoroughly mixed and then allowed to settle overnight. The phases are separated, the upper product phase is retained, 1.0 L 1% w/w NaOH in distilled water is added, the mixture is through mixed and then allowed again to settle overnight. The phases are separated, and the upper product phase is placed in a beaker along with 80 g anhydrous magnesium sulfate powder. The viscous mixture is manually mixed for about 15 minutes and then filtered through fine-porosity sintered-glass filter. Once, the product is filtered, the magnesium sulfate is washed with a small amount of n-pentane and then filtered. The pentane solution is combined with the filtered product and placed on a rotary evaporator. Most of the volatile components (pentane, residual acetonitrile, pyrrolidine, water) are removed under reduced pressure. Using the rotary evaporator, the viscous product is stirred and heated (70° C., glycol-water bath) under vacuum (˜10 torr) overnight (18 hr) while the volatiles are trapped at liquid N₂ temperature. Finally, the mixture is again stirred and heated overnight on a vacuum-line (0.5 torr, 100° C.) to remove the last traces of volatiles. This procedure yields 399 g (94%) of a pale yellow viscous liquid with a purity of 99.0-99.6% (GC, HPLC). This material is sufficiently pure for most applications. If needed, this material is distilled (118-122° C., 3 torr) giving a 90% distillation yield of a colorless liquid (99.8% purity).

This is a clean reaction that produces pure product if the starting secondary amine and primary alkyl halide are themselves pure. Primary alkyl chlorides function quite well in this reaction, and the reaction time needs to be slightly extended for complete reaction. This reaction is also successfully carried out using various secondary amines: 50% aqueous dimethylamine, N-methylethylamine, diethylamine, di-n-propylamine, di-n-butylamine, pyrrolidine, piperidine, N-methylbenzylamine, N-ethylbenzylamine, N-methylaniline while using various ⁿC₅-ⁿC₁₂ alkyl halides. For the above reaction, a ratio of 1:3 is chosen to minimize the production of the didecyl pyrrolidinium bromide byproduct. The excess secondary amine can be regenerated and recycled by addition of inorganic base (NaOH pellets, 50% aqueous NaOH, LiOH, anhydrous Na₂CO₃, Na₃PO₄) to the spent reaction mixture in order to regenerate the free amine followed by distillation to recover the amine or amine/solvent mixture.

### Example 11

### Preparation of N-(4-Fluorobenzyl)-N-decylpyrrolidinium Chloride (fw=355.97)

380.5 g Purified N-decylpyrrolidine (1.8 mole, fw=211.39) is added to 720 mL stirring acetonitrile in a 2 L, 4-neck round-bottom flask that is equipped with a heating mantle, mechanical stirrer, 500 mL addition funnel, reflux condensor and teflon-coated thermocouple. The reaction is carried out under a nitrogen atmosphere with a slow N₂ purge. The stirring mixture is heated to 50° C., and 289.1 g freshly distilled 4-fluorobenzyl chloride (2.0 mole, fw=144.58) is added in a dropwise fashion over a period of about 60 minutes. The reaction mixture is then heated to about 80° C. for 8-12 hours and periodically monitored by HPLC (Method 10a) in order to ensure that the starting amine is entirely consumed. The reaction mixture is cooled to room temperature, filtered through sintered-glass and placed on a rotary evaporator to remove the solvent (acetonitrile). 1.0 L Methyl t-butyl ether (MTBE) is added portionwise with mechanical stirring to the sticky orange-yellow reaction residue. Once this mixture is fully suspended in the solvent, it is transferred to a clean 4 L Erlenmeyer flask, and an additional amount of MTBE (1.9 L) is slowly added with stirring. The mixture is allowed to stand at ambient temperature overnight, filtered through a large sintered-glass filter, twice washed with MTBE and then dried by passing dry N₂ through the product. Note: this crystalline substance is very hygroscopic and rapidly absorbs moisture from the air turning white crystals into a puddle of colorless liquid within a few minutes. Thus, ordinary filtrations are difficult and should be carried out in a dry-box or under a blanket of dry N₂ or dry air. The product is finally dried in a vacuum oven (55° C., 20 torr, 3 hr; 95° C., 20 torr, 15 hr), cooled and stored in a sealed container in a desiccator over P₂O₅. This procedure yields about 576 g (90%) of a white crystalline product (platelets) with >99% purity. A sharp melting point in a glass capillary is measured at 137-138° C. when measured between 90-140° C. at the heating rate of 1.0° C./minute. This compound appears to exist in multiple polymorphic crystalline forms with different melting points. This crystallized material from acetonitrile/MTBE forms crystals that will melt at or below 120° C., recrystallize and remelt at about 137° C. Slow heating seems to promote thermal interconversion of polymorphs. If allowed to age long enough at 90° C. (several days), the material is converted to the higher melting form. Note that the apparent melting points are significantly lowered by the presence of small amounts of moisture.

Recrystallization is accomplished using hot DME/MTBE. 100 g of the above product is dissolved in 450 g hot (˜75° C.) peroxide-free 1,2-dimethoxyethane (DME) and quickly filtered through a sintered glass filter into a clean 1 L filter-flask. 55 g hot DME is used to wash the filter. The arm of the filter flask is plugged, and the mixture in the flask is heated to about 75° C. and then allowed to cool to about 50° C. About 270 g MTBE is then added to the stirring mixture, and the mixture is briefly heated again to 50° C. The flask is then covered, and the warm solution is allowed to cool to room temperature undisturbed. Within three hours at ambient temperature copious amounts of large, white platelets crystallize from solution. Finally, the mixture is allowed to stand at 4° C. overnight (15-18 hr) in order to complete the crystallization. Taking proper precautions to protect from atmospheric moisture (see above), the cold mixture is filtered through a sintered-glass filter, twice washed with MTBE (ambient temperature) and dried on the filter as above. The product is again dried in a vacuum oven overnight, cooled and stored in a sealed container in a desiccator over P₂O₅. This procedure yields about 76 g (76%) of the white, crystalline salt (99.7-99.9% purity by HPLC). The filtrate solution contains substantial amounts of pure product. The solvent is completely removed, and the white residue is recrystallized again using the same method or combined with the next batch of product for recrystallization. Overall yield of recrystallization is 87-95%.

### Example 12

### Preparation of N-(4-Fluorobenzyl)-N-decylpyrrolidinium Hydroxide (fw=337.53)

178 g Recrystallized N-(4-fluorobenzyl)-N-decylpyrrolidinium chloride (500 mmole, fw=355.97) is dissolved in 445 mL degassed, deionized water under a CO₂-free, N₂ atmosphere in a polypropylene flask. 61.4 g Silver (I) oxide (265 mmole, fw=231.74) is added to the solution, and it is vigorously stirred with a mechanical polypropylene propeller at room temperature for 48 hours. The mixture is filtered through a polypropylene filter/felt in a polypropylene Buechner filter into a polypropylene receiving flask under a blanket of nitrogen gas. The water-clear solution is placed on a rotary evaporator, and the water is partially removed under vacuum over a period of 36-48 hours while the product (viscous liquid) is maintained at about 50° C. using an external heating bath. Acid-Base titration (hydroxide) and HPLC analysis (cation) show the final solution to contain about 41% of the quat hydroxide; atomic absorption shows residual Cl⁻ to be less than 2 ppm. The solution is stored at ambient temperature in a sealed, clean, polypropylene container. Yield is nearly quantitative.

Modifications: This method is generally applicable to most quaternary ammonium chloride/bromide salts described here. Compounds that have base-sensitive groups (alcohols, amides, esters etc), of course, are often unstable as hydroxide salts. Stable quaternary ammonium salts are also converted to hydroxide salts using other methods such as ion-exchange, electrolysis or electrodialysis.

### Example 13

### Preparation of N-(4-Fluorobenzyl)-N-decylpyrrolidinium Trifluoroacetate (fw=433.53)

Method A.

35.6 g Purified and recrystallized N-(4-fluorobenzyl)-N-decylpyrrolidinium chloride (100 mmole, fw=355.97) is placed in a 100 mL separatory funnel followed by 35.6 g degassed, deionized water. The flask is shaken until a clear, viscous solution is formed (˜1.5 M solution). 17.1 g Trifluoroacetic acid (150 mmole, fw=114.02) is added to the mixture which is vigorously mixed. Immediately two phases form which fully separate after 60 minutes. The quat trifluoroacetate is contained in the lower layer, and the water, HCl and excess CF₃CO₂H is in the upper layer. The layers are separated, the product in the lower layer is placed on a rotary evaporator in order to remove the residual water, HCl and CF₃CO₂H under vacuum (bath temperature=50° C., vacuum=20 torr). This procedure yields 40.8 g (94%) of a pure, clear, viscous oil (ionic liquid). This material is suitable for use a displacer. HPLC purity of the quat cation is essentially identical to the starting material. Residual chloride content is about 1 mole % (chloride titration) and excess trifluoroacetate as free trifluoroacetic acid is 2-5 mole % (acid titration). A second extraction with equal weight of 30% (w/w) trifluoroacetic in water following the same procedure yields the same product with the same amount of residual trifluoroacetic acid but with chloride content reduced to <0.1 mole %. While the solubility of the trifluoroacetate (TFA) salt (˜120 mM) in pure water is lower than the solubility of the chloride salt (2.0 M), the TFA salt is nonetheless adequately soluble for displacer use (10-50 mM).

Method B.

This is a modification of Method A based on the partitioning behavior in a two-phase diethyl ether-water extraction. The quat chloride salt strongly partitions into the water layer while the quat trifluoroacetate salt strongly partitions into the ether layer. 53.4 g Purified and recrystallized N-(4-fluorobenzyl)-N-decylpyrrolidinium chloride (150 mmole, fw=355.97) is placed in a 250 mL separatory funnel followed by 53.4 g degassed, deionized water. The flask is shaken until a clear, viscous solution is formed (˜1.5 M solution). 25.6 g Trifluoroacetic (225 mmole, fw=114.02) is added to the mixture which is vigorously mixed. Immediately two phases form with the product in the lower layer. 110 mL peroxide-free diether ether is added to the separatory funnel and the mixture is vigorously mixed again. After 2 hours, the phases fully separate with the product in the upper ether phase. The lower phase is discarded and the upper is retained. 55 mL 1% trifluoroacetic acid in distilled water is added, the mixture is vigorously mixed and phases are again allowed to separate. Again, the upper phase is retained, dried over anhydrous magnesium sulfate, filtered and placed on a rotary evaporator in order to remove the ether along with residual HCl, trifluoroacetic acid and water. This procedure yields 59.2 g (91%) of a pure, clear, viscous oil (ionic liquid). This material is suitable for use as a displacer. HPLC purity of the quat cation is essentially identical to the starting material. Residual chloride content is <0.1 mole % (chloride titration) and excess trifluoroacetate as free trifluoroacetic acid is 1-3 mole % (acid titration).

Method C.

35.6 g Purified and recrystallized N-(4-fluorobenzyl)-N-decylpyrrolidinium chloride (100 mmole, fw=355.97) is dissolved in 75 mL distilled water in a 250 mL Erlenmeyer flask. 23.1 g Silver (I) trifluoroacetate (105 mmole, fw=220.88) and 100 mL peroxide-free diethyl ether are added to the solution, and it is vigorously stirred magnetically for 48 hours at room temperature. The mixture is filtered in order to remove silver salts, the two liquid phases are separated, the upper product phase is dried and then filtered again. The ether solution is placed on a rotary evaporator in order to remove the ether along with residual water. This procedure yields 41.2 g (95%) of a pure, clear, viscous oil (ionic liquid). This material is suitable for use a displacer. HPLC purity of the quat cation is essential identically to that of the starting material. Residual chloride content is <0.01 mole %.

Method D.

84.6 g N-(4-Fluorobenzyl)-N-decylpyrrolidinium hydroxide solution (100 mmole, 39.9%, fw=337.53) is placed in a calibrated 1000 mL volumetric flask and about 800 mL CO₂-free distilled water is added and mixed. Without delay, trifluoroacetic acid (˜11.4 g, fw=114.2) is carefully added dropwise with stirring and pH-monitoring. When 95% of the acid has been added, small droplets of the acid are added one-at-a-time until the unbuffered endpoint (pH=5-8) is attained. Additional CO₂-free distilled water is added until the volume is exactly 1000 mL). This 100 mM stock solution is suitable for use a displacer.

A wide range of salts are readily prepared using this method including, formate, acetate, bromide, nitrate, iodide, methanesulfonate, trifluoromethanesulfonate (triflate), trichloroacetate and perchlorate.

Method E.

84.6 g N-(4-Fluorobenzyl)-N-decylpyrrolidinium hydroxide solution (100 mmole, 39.9%, fw=337.53) and 100 mL peroxide-free diethyl ether are placed in a 250 mL Erlenmeyer flask. Without delay, the mixture is vigorously stirred magnetically, and trifluoroacetic acid (˜11.4 g, fw=114.2) is carefully added dropwise at an addition rate so that there is a minimal temperature rise. The room-temperature mixture is separated into two liquid phases, the upper product phase is dried and filtered, the ether solution is placed on a rotary evaporator in order to remove the ether along with residual trifluoroacetic acid and water. This procedure yields 42.0 g (97%) of a pure, clear, viscous oil (ionic liquid). This material is suitable for use a displacer. HPLC purity of the quat cation is essential identical to the starting material. Residual chloride content is <0.01 mole %.

Method F.

38.1 g Purified N-decylpyrrolidine (0.18 mole, fw=211.39) is added to 75 mL stirring acetonitrile in a 250 mL 4-neck round-bottom flask that is equipped with a heating mantle, magnetic stirrer, 50 mL addition funnel and reflux condensor. The reaction is carried out under a nitrogen atmosphere. The stirring mixture is warmed to about 50° C., and 44.4 g freshly distilled 4-fluorobenzyl trifluoroacetate⁴ (0.20 mole, fw=222.14) is added in a dropwise fashion over a period of about 60 minutes. The reaction mixture is then heated under refluxing conditions for about 24 hours and periodically monitored by HPLC in order to ensure that the starting amine is entirely consumed. The reaction mixture is cooled to room temperature, filtered through sintered-glass and placed on a rotary evaporator to remove the solvent (acetonitrile). 100 mL n-pentane is added portionwise with mechanical stirring to the yellow reaction residue. Once this mixture is fully mixed with the solvent, the upper layer is completely removed and discarded. To the oily product layer is added an equal volume of peroxide-free diethyl ether and thoroughly mixed. 100 mL n-Pentane is added, the mixture is thoroughly mixed and allowed to settle and the upper layer is separated and discarded. This trituration process with diethyl ether and pentane is repeated two more times in order to remove as much color and organic impurities as possible. Finally, the mixture is heated over night on a vacuum-line (0.5 torr, 80° C.) to remove the last traces of volatiles. This procedure yields about 55 g (71%) of a pale yellow, oily product with purity of 98.5-99.0% (HPLC). This oily product is easily purified using chromatography, but difficult to purify by other methods; for this reason, this method of preparation is less preferred.

### Example 14

### Preparation of N,N-Diheptyl-1,2,3,4-tetrahydroisoquinolinium Bromide (fw=410.49)

48.0 g Freshly distilled 1,2,3,4-tetrahydroisoquinoline (360 mmole, fw=133.19) and 49.1 g diisopropylethylamine (380 mmole, fw=129.25) are added to 120 mL acetonitrile in a 500 mL, 3-neck, round-bottom flask that is equipped with a magnetic stirring bar, heating mantle, 250 mL addition funnel, reflux condenser and teflon-coated thermocouple. The reaction is carried out under a nitrogen atmosphere with a slow N₂ purge. The stirring mixture is heated to 50° C., and 143.3 g freshly distilled 1-bromoheptane (0.80 mole, fw=179.11) is added in a dropwise fashion over a period of about 60 minutes. The reaction mixture is then heated to about 80° C. for 10-12 hours and periodically monitored by HPLC in order to ensure that the starting amine is entirely consumed. The reaction mixture is cooled to room temperature, and 50% aqueous sodium hydroxide is added dropwise with strong agitation. The pH of the aqueous layer is monitored with pH paper. When the mixture becomes sufficiently basic (˜29 g NaOH), the lower aqueous phase is removed, and the organic solution is filtered and placed in a rotary evaporator in order to partially remove the volatile components (acetonitrile, water, diisopropylethylamine) under vacuum. When the product begins to crystallize from solution, about 300 mL diethyl ether is added portionwise with stirring. The mixture is allowed to stand at 4° C. overnight. The cold mixture is filtered through sintered glass, the solid is washed with diethyl ether and dried on the filter by passing dry nitrogen through it. It is finally dried in a vacuum oven (50° C., 20 torr) overnight. This crude product is recrystallized by dissolving it in a minimum amount of hot (70° C.) acetonitrile, quickly filtering the hot solution through sintered-glass and the allowing it to cool. Crystallization occurs on standing at room temperature and is completed by the addition of diethyl ether with cooling. The product is worked up as before. This procedure yields about 102 g (69%) of a white, crystalline product with >99% purity (HPLC).

### Example 15

### Preparation of 3,5-Bis(N,N-dimethyldecylammoniummethyl)-1-fluorobenzene Dibromide (fw=652.68)

77.9 g Freshly distilled N,N-dimethyldecylamine (420 mmole, fw=185.36) is added to 1 L stirring acetonitrile in a 2 L, 4-neck round-bottom flask that is equipped with a heating mantle, mechanical stirrer, 500 mL addition funnel, reflux condenser and teflon-coated thermocouple. The reaction is carried out under a nitrogen atmosphere with a slow N₂ purge. The stirring mixture is heated to 50° C., and 56.4 g freshly recrystallized 3,5-bis(bromomethyl)-1-fluorobenzene⁵ (200 mmole, fw=281.96) in 200 mL acetonitrile is added in a dropwise fashion over a period of about 60 minutes; the reaction is mildly exothermic. The reaction mixture is then heated to about 80° C. for 3-5 hours and then rapidly filtered while hot through a sintered-glass filter into a 2 L clean filter-flask. On cooling to room temperature, copious amounts of white crystals form in solution. The product is allowed to crystallize from solution by standing at room temperature for about 3 hours, and then the mixture is allowed to stand at 4° C. overnight. The cold mixture is filtered through a sintered-glass filter, washed with cold acetonitrile, then n-pentane and finally dried by passing dry N₂ through the product. The product is finally dried in a vacuum oven (50° C., 20 torr) overnight, cooled and stored in a sealed container. This procedure yields about 125 g (96%) of a white, crystalline product. It is recrystallized from hot acetonitrile (9-10 g solvent per gram of product) yielding 120 g of the purified product (99.5-99.8% pure, HPLC).

TABLE V
Cationic Displacer Compounds

| | | | | | | | | | | | HPLC | |
|---|---|---|---|---|---|---|---|---|---|---|---|---|
| | | | | | | | | | | | Method 9a | |
| [R¹R²R³R⁴N] ⁺[X] ⁻ | | | | | | | | | | | Form. | Ret. |
| Nu. | R¹ | R² | R³ | R⁴ | X⁻ | Amine | CAS Num. | Alkylating Agent | CAS Num. | Formula | Weight | Time |
| 1 | ⁿDecyl | Methyl | Methyl | Benzyl | Cl⁻ | NR¹R²R³ | 1120-24-7 | R⁴X | 100-44-7 | C₁₉H₃₄NCl | 311.938 | 41.2 |
| 2 | ⁿDecyl | Methyl | Methyl | Benzyl | Br⁻ | NR¹R²R³ | 1120-24-7 | R⁴X | 100-39-0 | C₁₉H₃₄NBr | 356.390 | 41.2 |
| 3 | ⁿDecyl | Methyl | Methyl | Benzyl | Br⁻ | NR²R³R⁴ | 103-83-3 | R¹X | 112-29-8 | C₁₉H₃₄NBr | 356.390 | 41.2 |
| 4 | ⁿDecyl | Methyl | Methyl | Benzyl | OH⁻ | — | — | — | — | C₁₉H₃₅NO | 293.493 | 41.2 |
| 5 | ⁿDecyl | Methyl | Methyl | Benzyl | CF₃CO₂⁻ | — | — | — | — | C₂₁H₃₄NO₂F₃ | 389.502 | 41.2 |
| 6 | ⁿDecyl | Methyl | Ethyl | Benzyl | Br⁻ | NR²R³R⁴ | 4788-37-8 | R¹X | 112-29-8 | C₂₀H₃₆NBr | 370.417 | 42.2 |
| 7 | ⁿDecyl | Methyl | ⁿPropyl | Benzyl | Br⁻ | NR²R³R⁴ | 2532-72-1 | R¹X | 112-29-8 | C₂₁H₃₈NBr | 384.443 | 44.2 |
| 8 | ⁿDecyl | Methyl | ⁿButyl | Benzyl | Br⁻ | NR²R³R⁴ | 31844-65-2 | R¹X | 112-29-8 | C₂₂H₄₀NBr | 398.470 | 46.5 |
| 9 | ⁿDecyl | Methyl | Methyl | 2-FC₆H₄CH₂— | Cl⁻ | NR¹R²R³ | 1120-24-7 | R⁴X | 345-35-7 | C₁₉H₃₃NClF | 329.929 | 41.3 |
| 10 | ⁿDecyl | Methyl | Methyl | 3-FC₆H₄CH₂— | Cl⁻ | NR¹R²R³ | 1120-24-7 | R⁴X | 456-42-8 | C₁₉H₃₃NClF | 329.929 | 41.3 |
| 11 | ⁿDecyl | Methyl | Methyl | 4-FC₆H₄CH₂— | Cl⁻ | NR¹R²R³ | 1120-24-7 | R⁴X | 352-11-4 | C₁₉H₃₃NClF | 329.929 | 41.4 |
| 12 | ⁿDecyl | Methyl | Methyl | 4-FC₆H₄CH₂— | Br⁻ | NR¹R²R³ | 1120-24-7 | R⁴X | 23915-07-3 | C₁₉H₃₃NBrF | 374.380 | 41.4 |
| 13 | ⁿDecyl | Methyl | Methyl | 4-FC₆H₄CH₂— | OH⁻ | — | — | — | — | C₁₉H₃₄NOF | 311.484 | 41.4 |
| 14 | ⁿDecyl | Methyl | Methyl | 4-FC₆H₄CH₂— | CF₃CO₂⁻ | — | — | — | — | C₂₁H₃₃NO₂F₄ | 407.492 | 41.4 |
| 15 | ⁿDecyl | Methyl | Methyl | 2-ClC₆H₄CH₂— | Cl⁻ | NR¹R²R³ | 1120-24-7 | R⁴X | 611-19-8 | C₁₉H₃₃NCl₂ | 346.383 | 42.8 |
| 16 | ⁿDecyl | Methyl | Methyl | 3-ClC₆H₄CH₂— | Cl⁻ | NR¹R²R³ | 1120-24-7 | R⁴X | 620-20-2 | C₁₉H₃₃NCl₂ | 346.383 | 42.9 |
| 17 | ⁿDecyl | Methyl | Methyl | 3-ClC₆H₄CH₂— | Br⁻ | NR¹R²R³ | 1120-24-7 | R⁴X | 766-80-3 | C₁₉H₃₃NBrCl | 390.834 | 42.9 |
| 18 | ⁿDecyl | Methyl | Methyl | 4-ClC₆H₄CH₂— | Cl⁻ | NR¹R²R³ | 1120-24-7 | R⁴X | 104-83-6 | C₁₉H₃₃NCl₂ | 346.383 | 43.2 |
| 19 | ⁿDecyl | Methyl | Methyl | 3-BrC₆H₄CH₂— | Cl⁻ | NR¹R²R³ | 1120-24-7 | R⁴X | 93277-4 | C₁₉H₃₃NBrCl | 390.834 | 43.6 |
| 20 | ⁿDecyl | Methyl | Methyl | 3-BrC₆H₄CH₂— | Br⁻ | NR¹R²R³ | 1120-24-7 | R⁴X | 823-78-9 | C₁₉H₃₃NBr₂ | 435.286 | 43.6 |
| 21 | ⁿDecyl | Methyl | Methyl | 4-BrC₆H₄CH₂— | Br⁻ | NR¹R²R³ | 1120-24-7 | R⁴X | 823-78-9 | C₁₉H₃₃NBr₂ | 435.286 | 44.0 |
| 22 | ⁿDecyl | Methyl | Methyl | 2,4-F₂C₆H₃CH₂— | Cl⁻ | NR¹R²R³ | 1120-24-7 | R⁴X | 452-07-3 | C₁₉H₃₂NClF₂ | 347.919 | 41.7 |
| 23 | ⁿDecyl | Methyl | Methyl | 2,6-F₂C₆H₃CH₂— | Cl⁻ | NR¹R²R³ | 1120-24-7 | R⁴X | 67-73-4 | C₁₉H₃₂NClF₂ | 347.919 | 41.4 |
| 24 | ⁿDecyl | Methyl | Methyl | 3,5-F₂C₆H₃CH₂— | Cl⁻ | NR¹R²R³ | 1120-24-7 | R⁴X | 220141-71-9 | C₁₉H₃₂NClF₂ | 347.919 | 42.0 |
| 25 | ⁿDecyl | Methyl | Methyl | 2,4,6-F₃C₆H₂CH₂— | Br⁻ | NR¹R²R³ | 1120-24-7 | R⁴X | 151411-98-2 | C₁₉H₃₁NBrF₃ | 410.361 | 41.8 |
| 26 | ⁿDecyl | Methyl | Methyl | 3,4,5-F₃C₆H₂CH₂— | Cl⁻ | NR¹R²R³ | 1120-24-7 | R⁴X | 732306-27-3 | C₁₉H₃₁NClF₃ | 365.910 | 42.8 |
| 27 | ⁿDecyl | Methyl | Methyl | 4-MeC₆H₄CH₂— | Cl⁻ | NR¹R²R³ | 1120-24-7 | R⁴X | 104-82-5 | C₂₀H₃₆NCl | 325.965 | 43.7 |
| 28 | ⁿDecyl | Methyl | Methyl | 4-CF₃C₆H₄CH₂— | Cl⁻ | NR¹R²R³ | 1120-24-7 | R⁴X | 939-99-1 | C₂₀H₃₃NClF₃ | 379.937 | 44.1 |
| 29 | ⁿDecyl | Methyl | Methyl | 4-EtC₆H₄CH₂— | Cl⁻ | NR¹R²R³ | 1120-24-7 | R⁴X | 1467-05-6 | C₂₁H₃₈NCl | 339.992 | 45.9 |
| 30 | ⁿDecyl | Methyl | Methyl | 4-tuC₆H₄CH₂— | Cl⁻ | NR¹R²R³ | 1120-24-7 | R⁴X | 19692-45-6 | C₂₃H₄₂NCl | 368.039 | 48.7 |
| 31 | ⁿDecyl | Methyl | Methyl | 4-PhC₆H₄CH₂— | Cl⁻ | NR¹R²R³ | 1120-24-7 | R⁴X | 1667-11-4 | C₂₅H₃₈NCl | 388.036 | 47.7 |
| 32 | ⁿDecyl | Methyl | Methyl | 4-MeOC₆H₄CH₂— | Cl⁻ | NR¹R²R³ | 1120-24-7 | R⁴X | 824-94-2 | C₂₀H₃₆NOCl | 341.965 | 42.1 |
| 33 | ⁿDecyl | Methyl | Methyl | 4-AcNHC₆H₄CH₂— | Cl⁻ | NR¹R²R³ | 1120-24-7 | R⁴X | 54777-65-0 | C₂₁H₃₇N₁₂OCl | 368.990 | 36.6 |
| 34 | ⁿDecyl | Methyl | Methyl | 4-MeO₂CC₆H₄CH₂— | Br⁻ | NR¹R²R³ | 1120-24-7 | R⁴X | 2417-72-3 | C₂₁H₃₆NO₂Br | 414.426 | 40.2 |
| 35 | ⁿDecyl | Methyl | Methyl | H₂NC(O)CH₂— | Cl⁻ | NR¹R²R³ | 1120-24-7 | R⁴X | 79-07-2 | C₁₄H₃₁N₂OCl | 278.866 | 32.1 |
| 36 | ⁿDecyl | Methyl | Methyl | PhHNC(O)CH₂— | Cl⁻ | NR¹R²R³ | 1120-24-7 | R⁴X | 587-65-5 | C₂₀H₃₅N₂OCl | 354.963 | 41.5 |
| 37 | ⁿDecyl | Methyl | Methyl | Me₂NC(O)CH₂— | Cl⁻ | NR¹R²R³ | 1120-24-7 | R⁴X | 2675-89-0 | C₁₆H₃₅N₂OCl | 306.915 | 35.5 |
| 38 | ⁿDecyl | Methyl | Methyl | Et₂NC(O)CH₂— | Cl⁻ | NR¹R²R³ | 1120-24-7 | R⁴X | 2315-36-8 | C₁₈H₃₉N₂OCl | 334.968 | 39.8 |
| 39 | ⁿNonyl | Methyl | Methyl | Benzyl | Cl⁻ | NR¹R²R³ | 17373-27-2 | R⁴X | 100-44-7 | C₁₈H₃₂NCl | 297.912 | 38.0 |
| 40 | ⁿNonyl | Methyl | Methyl | Benzyl | Br⁻ | NR¹R²R³ | 17373-27-2 | R⁴X | 100-39-0 | C₁₈H₃₂NBr | 342.363 | 38.0 |
| 41 | ⁿNonyl | Methyl | Methyl | Benzyl | OH⁻ | — | — | — | — | C₁₈H₃₃NO | 279.466 | 38.0 |
| 42 | ⁿNonyl | Methyl | Methyl | Benzyl | CF₃CO₂⁻ | — | — | — | — | C₂₀H₃₂NO₂F₃ | 375.475 | 38.0 |
| 42b | ⁿNonyl | Methyl | Methyl | 4-FC₆H₄CH₂— | Cl⁻ | NR¹R²R³ | 17373-27-2 | R⁴X | 352-11-4 | C₁₈H₃₁NClF | 315.904 | 38.3 |
| 42c | ⁿNonyl | Methyl | Methyl | 4-FC₆H₄CH₂— | CF₃CO₂⁻ | — | — | — | — | C₂₀H₃₁NO₂F₄ | 393.456 | 38.3 |
| 43 | ⁿNonyl | Methyl | Ethyl | Benzyl | Br⁻ | NR²R³R⁴ | 4788-37-8 | R¹X | 693-58-3 | C₁₉H₃₄NBr | 356.390 | 39.7 |
| 44 | ⁿNonyl | Methyl | ⁿPropyl | Benzyl | Br⁻ | NR²R³R⁴ | 2532-72-1 | R¹X | 693-58-3 | C₂₀H₃₆NBr | 370.417 | 41.7 |
| 45 | ⁿNonyl | Methyl | ⁿButyl | Benzyl | Br⁻ | NR²R³R⁴ | 31844-65-2 | R¹X | 693-58-3 | C₂₁H₃₈NBr | 384.443 | 44.0 |
| 46 | ⁿOctyl | Methyl | Methyl | 4-CH₃C₆H₄CH₂— | Cl⁻ | NR¹R²R³ | 7378-99-6 | R⁴X | 104-82-5 | C₁₈H₃₂NCl | 297.912 | 37.7 |
| 47 | ⁿOctyl | Methyl | Methyl | 4-tuC₆H₄CH₂— | Cl⁻ | NR¹R²R³ | 7378-99-6 | R⁴X | 19692-45-6 | C₂₁H₃₈NCl | 339.986 | 43.6 |
| 47b | ⁿOctyl | Methyl | Methyl | 4-FC₆H₄CH₂— | Cl⁻ | NR¹R²R³ | 7378-99-6 | R⁴X | 352-11-4 | C₁₇H₂₉NClF | 301.877 | 34.9 |
| 48 | ⁿOctyl | Methyl | Methyl | Benzyl | Cl⁻ | NR¹R²R³ | 7378-99-6 | R⁴X | 100-44-7 | C₁₇H₃₀NCl | 283.885 | 34.7 |
| 49 | ⁿOctyl | Methyl | Methyl | Benzyl | CF₃CO₂⁻ | — | — | — | — | C₁₉H₃₀NO₂F₃ | 361.448 | 34.7 |
| 49b | ⁿOctyl | Methyl | Methyl | 4-FC₆H₄CH₂— | Cl | NR¹R²R³ | 7378-99-6 | R⁴X | 352-11-4 | C₁₇H₂₉NClF | 301.867 | 35.2 |
| 49c | ⁿOctyl | Methyl | Methyl | 4-FC₆H₄CH₂— | CF₃CO₂⁻ | — | — | — | — | C₁₉H₂₉NO₂F₄ | 379.430 | 35.2 |
| 50 | ⁿOctyl | Methyl | Ethyl | Benzyl | Br⁻ | NR²R³R⁴ | 4788-37-8 | R¹X | 111-83-1 | C₁₈H₃₂NBr | 342.363 | 35.7 |
| 51 | ⁿOctyl | Methyl | ⁿPropyl | Benzyl | Br⁻ | NR²R³R⁴ | 2532-72-1 | R¹X | 111-83-1 | C₁₉H₃₄NBr | 356.390 | 37.7 |
| 52 | ⁿOctyl | Methyl | ⁿButyl | Benzyl | Br⁻ | NR²R³R⁴ | 31844-65-2 | R¹X | 111-83-1 | C₂₀H₃₆NBr | 370.417 | 40.0 |
| 53 | ⁿOctyl | Methyl | ⁿPentyl | Benzyl | Br⁻ | NR²R³R⁴ | 77223-58-6 | R¹X | 111-83-1 | C₂₁H₃₈NBr | 384.443 | 42.5 |
| 53b | ⁿHeptyl | Methyl | Methyl | Benzyl | Cl | NR¹R²R³ | 5277-11-2 | R⁴X | 100-44-7 | C₁₆H₂₈NCl | 269.850 | 31.8 |
| 53c | ⁿHeptyl | Methyl | Methyl | Benzyl | CF₃CO₂⁻ | — | — | — | — | C₁₈H₂₈NO₂F₃ | 347.413 | 31.8 |
| 53d | ⁿHeptyl | Methyl | Methyl | 4-FC₆H₄CH₂— | Cl | NR¹R²R³ | 5277-11-2 | R⁴X | 352-11-4 | C₁₆H₂₇NClF | 287.840 | 32.0 |
| 53e | ⁿHeptyl | Methyl | Methyl | 4-FC₆H₄CH₂— | CF₃CO₂⁻ | — | — | — | — | C₁₈H₂₇NO₂F₄ | 365.404 | 32.0 |
| 54 | ⁿUndecyl | Methyl | Methyl | Benzyl | Cl⁻ | NR¹R²R³ | 17373-28-3 | R⁴X | 100-44-7 | C₂₀H₃₆NCl | 325.965 | 44.3 |
| 55 | ⁿUndecyl | Methyl | Methyl | Benzyl | Br⁻ | NR¹R²R³ | 17373-28-3 | R⁴X | 100-39-0 | C₂₀H₃₆NBr | 370.417 | 44.3 |
| 56 | ⁿUndecyl | Methyl | Methyl | Benzyl | OH⁻ | — | — | — | — | C₂₀H₃₇NO | 307.520 | 44.3 |
| 57 | ⁿUndecyl | Methyl | Methyl | Benzyl | CF₃CO₂⁻ | — | — | — | — | C₂₂H₃₆NO₂F₃ | 403.529 | 44.3 |
| 58 | ⁿUndecyl | Methyl | Ethyl | Benzyl | Br⁻ | NR²R³R⁴ | 4788-37-8 | R¹X | 693-67-4 | C₂₁H₃₈NBr | 384.443 | 45.3 |
| 59 | ⁿUndecyl | Methyl | ⁿPropyl | Benzyl | Br⁻ | NR²R³R⁴ | 2532-72-1 | R¹X | 693-67-4 | C₂₂H₄₀NBr | 398.470 | 47.3 |
| 60 | ⁿUndecyl | Methyl | Methyl | 4-FC₆H₄CH₂— | Cl⁻ | NR¹R²R³ | 17373-28-3 | R⁴X | 352-11-4 | C₂₀H₃₅NClF | 343.956 | 44.5 |
| 61 | ⁿUndecyl | Methyl | Methyl | 4-FC₆H₄CH₂— | Br⁻ | NR¹R²R³ | 17373-28-3 | R⁴X | 459-46-1 | C₂₀H₃₅NBrF | 388.407 | 44.5 |
| 62 | ⁿUndecyl | Methyl | Methyl | 4-FC₆H₄CH₂— | OH⁻ | — | — | — | — | C₂₀H₃₆NOF | 325.510 | 44.5 |
| 63 | ⁿUndecyl | Methyl | Methyl | 4-FC₆H₄CH₂— | CF₃CO₂⁻ | — | — | — | — | C₂₂H₃₅NO₂F₄ | 421.519 | 44.5 |
| 64 | ⁿDecyl | Methyl | Benzyl | NH₂C(O)CH₂— | Cl⁻ | NR¹R²R³ | 112778-25-3 | R⁴X | 79-07-2 | C₂₀H₃₅N₂OCl | 354.963 | 36.5 |
| 65 | ⁿDecyl | Methyl | Benzyl | PhNHC(O)CH₂— | Cl⁻ | NR¹R²R³ | 112778-25-3 | R⁴X | 587-65-5 | C₂₆H₃₉N₂OCl | 431.061 | 41.6 |
| 66 | ⁿDecyl | Methyl | Benzyl | Me₂NC(O)CH₂— | Cl⁻ | NR¹R²R³ | 112778-25-3 | R⁴X | 2675-89-0 | C₂₂H₃₉N₂OCl | 383.017 | 39.9 |
| 67 | ⁿDecyl | Methyl | Methyl | l-Me₂NC(O)CH(Bz)— | Br⁻ | NR²R³R⁴ | 91904-44-8^{r} | R¹X | 112-29-8 | C₂₃H₄₁N₂OBr | 441.488 | 41.5 |
| 67b | ⁿDecyl | Methyl | Methyl | d-Me₂NC(O)CH(Bz)— | Br⁻ | NR²R³R⁴ | 91904-44-8^{r} | R¹X | 112-29-8 | C₂₃H₄₀N₂OBr | 440.487 | 41.5 |
| 68 | ⁿDecyl | Methyl | Benzyl | Et₂NC(O)CH₂— | Cl⁻ | NR¹R²R³ | 112778-25-3 | R⁴X | 2315-36-8 | C₂₄H₄₃N₂OCl | 411.071 | 44.2 |
| 69 | Phenyl | Methyl | ⁿPentyl | ⁿButyl | Br⁻ | NR¹R³R⁴ | 138374-52-4 | R²X | 74-83-9 | C₁₆H₂₈NBr | 314.309 | 29.7 |
| 70 | Phenyl | Methyl | ⁿPentyl | ⁿPentyl | Br⁻ | NR¹R³R⁴ | 6249-76-9 | R²X | 74-83-9 | C₁₇H₃₀NBr | 328.336 | 32.5 |
| 71 | Phenyl | Methyl | ⁿPentyl | ⁿHexyl | Br⁻ | NR¹R³R⁴ | 138374-53-5 | R²X | 74-83-9 | C₁₈H₃₂NBr | 342.363 | 35.1 |
| 72 | Phenyl | Methyl | ⁿHexyl | ⁿHexyl | Br⁻ | HNR¹R² | 100-61-8 | 2xR⁴X + base | 111-25-1 | C₁₉H₃₄NBr | 356.390 | 37.7 |
| 73 | Phenyl | Methyl | ⁿHexyl | ⁿHexyl | Br⁻ | NR¹R³R⁴ | 4430-09-5 | R²X | 74-83-9 | C₁₉H₃₄NBr | 356.390 | 37.7 |
| 74 | Phenyl | Methyl | ⁿHeptyl | ⁿHexyl | Br⁻ | NR¹R³R⁴ | 288572-97-4 | R²X | 74-83-9 | C₂₀H₃₆NBr | 370.417 | 40.2 |
| 75 | Phenyl | Methyl | ⁿHeptyl | ⁿHeptyl | Br⁻ | NR¹R³R⁴ | 100-61-8 | R²X | 74-83-9 | C₂₁H₃₈NBr | 384.443 | 42.7 |
| 76 | Phenyl | Methyl | ⁿHeptyl | ⁿHeptyl | Br⁻ | NR¹R³R⁴ | 16341-05-2 | R²X | 74-83-9 | C₂₁H₃₈NBr | 384.443 | 42.7 |
| 77 | Phenyl | Methyl | ⁿHeptyl | ⁿHeptyl | CF₃CO₂⁻ | — | — | — | — | C₂₃H₃₈NO₂F₃ | 417.555 | 42.7 |
| 78 | 4-FC₆H₄— | Methyl | ⁿHeptyl | ⁿHeptyl | Br⁻ | HNR¹R² | 405-66-3 | 2xR⁴X + base | 629-04-9 | C₂₁H₃₇N₁BrF | 402.434 | 42.9 |
| 79 | 4-FC₆H₄— | Methyl | ⁿHeptyl | ⁿHeptyl | CF₃CO₂⁻ | — | — | — | — | C₂₃H₃₇NO₂F₄ | 435.546 | 42.9 |
| 80 | Phenyl | Methyl | ⁿHeptyl | ⁿOctyl | Br⁻ | NR¹R²R⁴ | 13063-61-1 | R³X | 629-04-9 | C₂₂H₄₀NBr | 398.470 | 45.1 |
| 81 | Phenyl | Methyl | ⁿOctyl | ⁿOctyl | Br⁻ | NR¹R³R⁴ | 3007-75-8 | R²X | 74-83-9 | C₂₃H₄₂NBr | 412.497 | 47.5 |
| 82 | R¹ + R² = IN^{w} | | ⁿButyl | ⁿPentyl | Br⁻ | NR¹R²R³ | 5878-10-8 | R⁴X | 110-53-2 | C₁₇H₂₈NBr | 326.320 | 29.7 |
| 83 | R¹ + R² = IN^{w} | | ⁿPentyl | ⁿPentyl | Br⁻ | NR¹R²R³ | 496-15-1 | R⁴X | 110-53-2 | C₁₈H₃₀NBr | 340.347 | 32.9 |
| 84 | R¹ + R² = IN^{w} | | ⁿHexyl | ⁿPentyl | Br⁻ | NR¹R²R³ | 593281-15-3 | R⁴X | 110-53-2 | C₁₉H₃₂NBr | 354.374 | 35.9 |
| 85 | R¹ + R² = IN^{w} | | ⁿHexyl | ⁿHexyl | Br⁻ | HNR¹R² | 496-15-1 | 2xR⁴X + base | 111-25-1 | C₂₀H₃₄NBr | 368.401 | 38.7 |
| 86 | R¹ + R² = IN^{w} | | ⁿHexyl | ⁿHeptyl | Br⁻ | NR¹R²R³ | 593281-15-3 | R⁴X | 629-04-9 | C₂₁H₃₆NBr | 382.428 | 41.4 |
| 87 | R¹ + R² = IN^{w} | | ⁿHeptyl | ⁿHeptyl | Br⁻ | NR¹R²R³ | 496-15-1 | 2xR⁴X + base | 629-04-9 | C₂₂H₃₈NBr | 396.448 | 43.9 |
| 88 | R¹ + R² = IN^{w} | | ⁿHeptyl | ⁿHeptyl | CF₃CO₂⁻ | — | — | — | — | C₂₄H₃₈NO₂F₃ | 429.566 | 43.9 |
| 89 | R¹ + R² = IN^{w} | | ⁿHeptyl | ⁿOctyl | Br⁻ | NR¹R²R³ | 157363-64-9 | R⁴X | 111-83-1 | C₂₃H₄₀NBr | 410.481 | 46.3 |
| 90 | R¹ + R² = IN^{w} | | ⁿOctyl | ⁿOctyl | Br⁻ | HNR¹R² | 496-15-1 | 2xR⁴X + base | 111-83-1 | C₂₄H₄₂NBr | 424.508 | 48.6 |
| 91 | R¹ + R² = IN^{w} | | Methyl | ⁿNonyl | Br⁻ | NR¹R²R³ | 824-21-5 | R⁴X | 693-58-3 | C₁₈H₃₀NBr | 340.347 | 36.5 |
| 92 | R¹ + R² = IN^{w} | | Methyl | ⁿDecyl | Br⁻ | NR¹R²R³ | 824-21-5 | R⁴X | 112-29-8 | C₁₉H₃₂NBr | 354.368 | 39.9 |
| 93 | R¹ + R² = IN^{w} | | Methyl | ⁿUndecyl | Br⁻ | NR¹R²R³ | 824-21-5 | R⁴X | 693-67-4 | C₂₀H₃₄NBr | 368.395 | 43.0 |
| 94 | R¹ + R² = THQ^{w} | | ⁿPentyl | ⁿButyl | Br⁻ | NR¹R²R³ | 63074-60-2 | R⁴X | 109-65-9 | C₁₈H₃₀NBr | 340.347 | 31.0 |
| 95 | R¹ + R² = THQ^{w} | | ⁿPentyl | ⁿPentyl | Br⁻ | NR¹R²R³ | 635-46-1 | 2xR⁴X + base | 110-53-2 | C₁₉H₃₂NBr | 354.374 | 34.1 |
| 96 | R¹ + R² = THQ^{w} | | ⁿPentyl | ⁿHexyl | Br⁻ | NR¹R²R³ | 63074-60-2 | R⁴X | 111-25-1 | C₂₀H₃₄NBr | 368.401 | 37.1 |
| 97 | R¹ + R² = THQ^{w} | | ⁿHexyl | ⁿHexyl | Br⁻ | HNR¹R² | 635-46-1 | 2xR⁴X + base | 111-25-1 | C₂₁H₃₆NBr | 382.428 | 39.7 |
| 98 | R¹ + R² = THQ^{w} | | ⁿHexyl | ⁿHeptyl | Br⁻ | NR¹R²R³ | 593281-16-4 | R⁴X | 629-04-9 | C₂₂H₃₈NBr | 396.454 | 42.6 |
| 99 | R¹ + R² = THQ^{w} | | ⁿHeptyl | ⁿHeptyl | Br⁻ | NR¹R²R³ | 635-46-1 | 2xR⁴X + base | 629-04-9 | C₂₃H₄₀NBr | 410.481 | 44.6 |
| 100 | R¹ + R² = THQ^{w} | | ⁿHeptyl | ⁿHeptyl | CF₃CO₂⁻ | — | — | — | — | C₂₅H₄₀NO₂F₃ | 443.593 | 44.6 |
| 101 | R¹ + R² = THQ^{w} | | ⁿOctyl | ⁿHeptyl | Br⁻ | NR¹R²R³ | 912546-48-6 | R⁴X | 629-04-9 | C₂₄H₄₂NBr | 424.508 | 47.0 |
| 102 | R¹ + R² = THQ^{w} | | ⁿOctyl | ⁿOctyl | Br⁻ | HNR¹R² | 635-46-1 | 2xR⁴X + base | 111-83-1 | C₂₅H₄₄NBr | 438.535 | 49.2 |
| 103 | R¹ + R² = THQ^{w} | | Methyl | ⁿNonyl | Br⁻ | NR¹R²R³ | 491-34-9 | R⁴X | 693-58-3 | C₁₉H₃₂NBr | 354.368 | 37.6 |
| 104 | R¹ + R² = THQ^{w} | | Methyl | ⁿDecyl | Br⁻ | NR¹R²R³ | 491-34-9 | R⁴X | 112-29-8 | C₂₀H₃₄NBr | 368.395 | 40.8 |
| 105 | R¹ + R² = THQ^{w} | | Methyl | ⁿUndecyl | Br⁻ | NR¹R²R³ | 491-34-9 | R⁴X | 693-67-4 | C₂₁H₃₆NBr | 382.421 | 43.9 |
| 106 | Benzyl | Methyl | ⁿPentyl | ⁿButyl | Br⁻ | NR¹R²R³ | 77223-58-6 | R⁴X | 109-65-9 | C₁₇H₃₀NBr | 328.336 | 32.0 |
| 107 | Benzyl | Methyl | ⁿPentyl | ⁿPentyl | Br⁻ | NR¹R²R³ | 77223-58-6 | R⁴X | 110-53-2 | C₁₈H₃₂NBr | 342.363 | 34.8 |
| 108 | Benzyl | Methyl | ⁿPentyl | ⁿHexyl | Br⁻ | NR¹R²R³ | 77223-58-6 | R⁴X | 111-25-1 | C₁₉H₃₄NBr | 356.390 | 37.4 |
| 109 | Benzyl | Methyl | ⁿPentyl | ⁿHeptyl | Br⁻ | NR¹R²R³ | 77223-58-6 | R⁴X | 629-04-9 | C₂₀H₃₆NBr | 370.417 | 40.3 |
| 110 | Benzyl | Methyl | ⁿHexyl | ⁿHexyl | Br⁻ | HNR¹R² | 100-6108 | 2xR⁴X + base | 111-25-1 | C₂₀H₃₆NBr | 370.417 | 40.0 |
| 111 | Benzyl | Methyl | ⁿHexyl | ⁿHexyl | Cl⁻ | NR²R³R⁴ | 37615-53-5 | R¹X | 100-44-7 | C₂₀H₃₆NCl | 325.965 | 40.0 |
| 112 | Benzyl | Methyl | ⁿHexyl | ⁿHexyl | CF₃CO₂⁻ | — | — | — | — | C₂₂H₃₆NO₂F₃ | 403.529 | 40.0 |
| 113 | Benzyl | Methyl | Cyclohexyl | Cyclohexyl | Br⁻ | NR²R³R⁴ | 7560-83-0 | R¹X | 100-39-0 | C₂₀H₃₂NBr | 366.385 | 30.7 |
| 114 | PhC(O)CH₂— | Methyl | ⁿHexyl | ⁿHexyl | Cl⁻ | NR²R³R⁴ | 37615-53-5 | R¹X | 532-27-4 | C₂₁H₃₆NOCl | 353.976 | 41.5 |
| 115 | 2-FC₆H₄CH₂— | Methyl | ⁿHexyl | ⁿHexyl | Cl⁻ | NR²R³R⁴ | 37615-53-5 | R¹X | 345-35-7 | C₂₀H₃₅NClF | 343.956 | 40.1 |
| 116 | 3-FC₆H₄CH₂— | Methyl | ⁿHexyl | ⁿHexyl | Cl⁻ | NR²R³R⁴ | 37615-53-5 | R¹X | 456-42-8 | C₂₀H₃₅NClF | 343.956 | 40.1 |
| 117 | 4-FC₆H₄CH₂— | Methyl | ⁿHexyl | ⁿHexyl | Cl⁻ | NR²R³R⁴ | 37615-53-5 | R¹X | 352-11-4 | C₂₀H₃₅NClF | 343.956 | 40.2 |
| 118 | 4-FC₆H₄CH₂— | Methyl | ⁿHexyl | ⁿHexyl | Br⁻ | NR²R³R⁴ | 37615-53-5 | R¹X | 23915-07-3 | C₂₀H₃₅NBrF | 388.407 | 40.2 |
| 119 | 4-FC₆H₄CH₂— | Methyl | ⁿHexyl | ⁿHexyl | OH⁻ | — | — | — | — | C₂₀H₃₆NOF | 325.510 | 40.2 |
| 120 | 4-FC₆H₄CH₂— | Methyl | ⁿHexyl | ⁿHexyl | CF₃CO₂⁻ | — | — | — | — | C₂₂H₃₅NO₂F₄ | 421.519 | 40.2 |
| 121 | 2-ClC₆H₄CH₂— | Methyl | ⁿHexyl | ⁿHexyl | Cl⁻ | NR²R³R⁴ | 37615-53-5 | R¹X | 611-19-8 | C₂₀H₃₅NCl₂ | 360.410 | 41.7 |
| 122 | 3-ClC₆H₄CH₂— | Methyl | ⁿHexyl | ⁿHexyl | Cl⁻ | NR²R³R⁴ | 37615-53-5 | R¹X | 620-20-2 | C₂₀H₃₅NCl₂ | 360.410 | 41.8 |
| 123 | 3-ClC₆H₄CH₂— | Methyl | ⁿHexyl | ⁿHexyl | Br⁻ | NR²R³R⁴ | 37615-53-5 | R¹X | 766-80-3 | C₂₀H₃₅NBrCl | 404.861 | 41.8 |
| 124 | 4-ClC₆H₄CH₂— | Methyl | ⁿHexyl | ⁿHexyl | Cl⁻ | NR²R³R⁴ | 37615-53-5 | R¹X | 104-83-6 | C₂₀H₃₅NCl₂ | 360.410 | 42.1 |
| 125 | 4-F-2-ClC₆H₃CH₂— | Methyl | ⁿHexyl | ⁿHexyl | Cl⁻ | NR²R³R⁴ | 37615-53-5 | R¹X | 93286-22-7 | C₂₀H₃₄NCl₂F | 378.401 | 42.3 |
| 126 | 6-F-2-ClC₆H₃CH₂— | Methyl | ⁿHexyl | ⁿHexyl | Cl⁻ | NR²R³R⁴ | 37615-53-5 | R¹X | 55117-15-2 | C₂₀H₃₄NCl₂F | 378.401 | 41.8 |
| 127 | 2-F-3-ClC₆H₃CH₂— | Methyl | ⁿHexyl | ⁿHexyl | Br⁻ | NR²R³R⁴ | 37615-53-5 | R¹X | 85070-47-9 | C₂₀H₃₄NBrClF | 422.846 | 42.3 |
| 128 | 4-F-3-ClC₆H₃CH₂— | Methyl | ⁿHexyl | ⁿHexyl | Br⁻ | NR²R³R⁴ | 37615-53-5 | R¹X | 192702-01-5 | C₂₀H₃₄NBrClF | 422.846 | 42.7 |
| 129 | 2,3-F₂C₆H₃CH₂— | Methyl | ⁿHexyl | ⁿHexyl | Br⁻ | NR²R³R⁴ | 37615-53-5 | R¹X | 113211-94-2 | C₂₀H₃₄NBrF₂ | 406.398 | 41.0 |
| 130 | 2,4-F₂C₆H₃CH₂— | Methyl | ⁿHexyl | ⁿHexyl | Cl⁻ | NR²R³R⁴ | 37615-53-5 | R⁴X | 452-07-3 | C₂₀H₃₄NClF₂ | 361.941 | 41.1 |
| 131 | 2,5-F₂C₆H₃CH₂— | Methyl | ⁿHexyl | ⁿHexyl | Cl⁻ | NR²R³R⁴ | 37615-53-5 | R¹X | 495-07-8 | C₂₀H₃₄NClF₂ | 361.941 | 40.8 |
| 132 | 2,6-F₂C₆H₃CH₂— | Methyl | ⁿHexyl | ⁿHexyl | Cl⁻ | NR²R³R⁴ | 37615-53-5 | R¹X | 697-73-4 | C₂₀H₃₄NClF₂ | 361.941 | 40.9 |
| 133 | 3,4-F₂C₆H₃CH₂— | Methyl | ⁿHexyl | ⁿHexyl | Cl⁻ | NR²R³R⁴ | 37615-53-5 | R¹X | 698-80-6 | C₂₀H₃₄NClF₂ | 361.941 | 41.2 |
| 134 | 3,5-F₂C₆H₃CH₂— | Methyl | ⁿHexyl | ⁿHexyl | Cl⁻ | NR²R³R⁴ | 37615-53-5 | R¹X | 220141-71-9 | C₂₀H₃₄NClF₂ | 361.941 | 41.4 |
| 135 | 2,4,6-F₃C₆H₂CH₂— | Methyl | ⁿHexyl | ⁿHexyl | Br⁻ | NR²R³R⁴ | 37615-53-5 | R¹X | 151411-98-2 | C₂₀H₃₃NBrF₃ | 424.388 | 41.3 |
| 136 | 3,4,5-F₃C₆H₂CH₂— | Methyl | ⁿHexyl | ⁿHexyl | Cl⁻ | NR¹R²R³ | 37615-53-5 | R¹X | 732306-27-3 | C₂₀H₃₃NClF₃ | 379.937 | 42.2 |
| 137 | 3-BrC₆H₄CH₂— | Methyl | ⁿHexyl | ⁿHexyl | Cl⁻ | NR²R³R⁴ | 37615-53-5 | R¹X | 932-77-4 | C₂₀H₃₅NBrCl | 404.861 | 42.2 |
| 138 | 3-BrC₆H₄CH₂— | Methyl | ⁿHexyl | ⁿHexyl | Br⁻ | NR²R³R⁴ | 37615-53-5 | R¹X | 823-78-9 | C₂₀H₃₅NBr₂ | 449.313 | 42.7 |
| 139 | 4-BrC₆H₄CH₂— | Methyl | ⁿHexyl | ⁿHexyl | Br⁻ | NR²R³R⁴ | 37615-53-5 | R¹X | 589-15-1 | C₂₀H₃₅NBr₂ | 449.313 | 43.1 |
| 140 | Ph(CH₂)₂— | Methyl | ⁿHexyl | ⁿHexyl | Br⁻ | HNR¹R² | 589-08-2 | 2xR⁴X + base | 111-25-1 | C₂₁H₃₈NBr | 384.443 | 41.6 |
| 141 | 4-CF₃C₆H₄CH₂— | Methyl | ⁿHexyl | ⁿHexyl | Br⁻ | NR²R³R⁴ | 37615-53-5 | R¹X | 939-99-1 | C₂₁H₃₅NBrF₃ | 438.415 | 43.4 |
| 142 | Benzyl | Ethyl | ⁿHexyl | ⁿHexyl | Cl⁻ | NR²R³R⁴ | 1097732-09-6 | R¹X | 100-44-7 | C₂₁H₃₈NCl | 339.992 | 41.3 |
| 143 | Benzyl | Ethyl | ⁿHexyl | ⁿHexyl | CF₃CO₂⁻ | — | — | — | — | C₂₃H₃₈NO₂F₃ | 417.555 | 41.3 |
| 144 | 4-FC₆H₄CH₂— | Ethyl | ⁿHexyl | ⁿHexyl | Cl⁻ | NR²R³R⁴ | 1097732-09-6 | R¹X | 352-11-4 | C₂₁H₃₇NClF | 357.983 | 41.5 |
| 145 | 4-FC₆H₄CH₂— | Ethyl | ⁿHexyl | ⁿHexyl | CF₃CO₂⁻ | — | — | — | — | C₂₃H₃₇NO₂F₄ | 435.546 | 41.5 |
| 146 | Benzyl | Methyl | ⁿHeptyl | ⁿPentyl | Br⁻ | NR¹R²R³ | 8140453-7 | R⁴X | 110-53-2 | C₂₀H₃₆NBr | 370.417 | 40.1 |
| 147 | Benzyl | Methyl | ⁿHeptyl | ⁿHexyl | Br⁻ | NR¹R²R³ | 8140453-7 | R⁴X | 111-25-1 | C₂₁H₃₈NBr | 384.443 | 42.5 |
| 147b | 4-FC₆H₄CH₂— | Methyl | ⁿHeptyl | ⁿHexyl | Cl⁻ | NR¹R²R³ | 8140453-7 | R⁴X | 352-11-4 | C₂₁H₃₇NClF | 357.985 | 42.7 |
| 148 | Benzyl | Methyl | ⁿHeptyl | ⁿHeptyl | Br⁻ | NR¹R²R³ | 8140453-7 | R⁴X | 629-04-9 | C₂₂H₄₀NBr | 398.470 | 45.0 |
| 149 | Benzyl | Methyl | ⁿHeptyl | ⁿHeptyl | CF₃CO₂⁻ | — | — | — | — | C₂₄H₄₀NO₂F₃ | 431.582 | 45.0 |
| 150 | 4-FC₆H₄CH₂— | Methyl | ⁿHeptyl | ⁿHeptyl | Br⁻ | HNR¹R² | 405-66-3 | 2xR⁴X + base | 629-04-9 | C₂₂H₃₉NBrF | 416.461 | 45.2 |
| 151 | 4-FC₆H₄CH₂— | Methyl | ⁿHeptyl | ⁿHeptyl | CF₃CO₂⁻ | — | — | — | — | C₂₄H₃₉NO₂F₄ | 449.573 | 45.2 |
| 152 | Benzyl | Ethyl | ⁿHeptyl | ⁿHeptyl | Cl⁻ | NR²R³R⁴ | 1097732-10-9 | R¹X | 100-44-7 | C₂₃H₄₂NCl | 368.046 | 46.2 |
| 153 | Benzyl | Ethyl | ⁿHeptyl | ⁿHeptyl | CF₃CO₂⁻ | — | — | — | — | C₂₅H₄₂NO₂F₃ | 445.609 | 46.2 |
| 154 | 4-FC₆H₄CH₂— | Ethyl | ⁿHeptyl | ⁿHeptyl | Cl⁻ | NR²R³R⁴ | 1097732-10-9 | R¹X | 352-11-4 | C₂₃H₄₁NClF | 386.036 | 46.4 |
| 155 | 4-FC₆H₄CH₂— | Ethyl | ⁿHeptyl | ⁿHeptyl | CF₃CO₂⁻ | — | — | — | — | C₂₅H₄₁NO₂F₄ | 463.600 | 46.4 |
| 156 | Benzyl | Methyl | ⁿHeptyl | ⁿOctyl | Br⁻ | NR¹R²R³ | 71404-53-7 | R⁴X | 111-83-1 | C₂₃H₄₂NBr | 412.497 | 47.4 |
| 157 | Benzyl | Methyl | ⁿOctyl | ⁿOctyl | Br⁻ | HNR¹R² | 103-67-3 | 2xR⁴X + base | 111-83-1 | C₂₄H₄₄NBr | 426.524 | 49.8 |
| 158 | Benzyl | Methyl | ⁿOctyl | ⁿOctyl | Cl⁻ | NR²R³R⁴ | 4455-26-9 | R¹X | 100-44-7 | C₂₄H₄₄NCl | 382.073 | 50.0 |
| 159 | 4-FC₆H₄CH₂— | Methyl | ⁿOctyl | ⁿOctyl | Cl⁻ | NR²R³R⁴ | 4455-26-9 | R¹X | 352-11-4 | C₂₄H₄₃NClF | 400.063 | 50.2 |
| 160 | R¹ + R² = iIN^{w} | | ⁿPentyl | ⁿButyl | Br⁻ | NR¹R²R³ | 1197914-56-9 | R⁴X | 109-65-9 | C₁₇H₂₈NBr | 326.320 | 30.3 |
| 161 | R¹ + R² = iIN^{w} | | ⁿPentyl | ⁿPentyl | Br⁻ | HNR¹R² | 496-12-8 | 2xR⁴X + base | 110-53-2 | C₁₈H₃₀NBr | 340.347 | 33.5 |
| 161b | R¹ + R² = iIN^{w} | | Ph(CH₂)₃— | Ph(CH₂)₃— | Br⁻ | HNR¹R² | 496-12-8 | 2xR⁴X + base | 637-59-2 | C₂₆H₃₀NBr | 436.427 | 39.6 |
| 161c | R¹ + R² = iIN^{w} | | Ph(CH₂)₃— | Ph(CH₂)₃— | CF₃CO₂⁻ | — | — | — | — | C₂₈H₃₀NO₂F₃ | 469.539 | 39.6 |
| 162 | R¹ + R² = iIN^{w} | | ⁿPentyl | ⁿHexyl | Br⁻ | NR¹R²R³ | 1197914-56-9 | R⁴X | 111-25-1 | C₁₉H₃₂NBr | 354.374 | 36.5 |
| 163 | R¹ + R² = iIN^{w} | | ⁿPentyl | ⁿOctyl | Br⁻ | HNR³R⁴ | 6835-13-8 | o-(XCH₂)₂C₆H₄ + base | 91-13-4 | C₂₁H₃₆NBr | 382.428 | 42.1 |
| 164 | R¹ + R² = iIN^{w} | | ⁿHexyl | ⁿHexyl | Br⁻ | HNR¹R² | 496-12-8 | 2xR⁴X + base | 111-25-1 | C₂₀H₃₄NBr | 368.401 | 39.3 |
| 165 | R¹ + R² = iIN^{w} | | ⁿHeptyl | ⁿHexyl | Br⁻ | NR¹R²R³ | 1197914-59-2 | R⁴X | 111-25-1 | C₂₁H₃₆NBr | 382.428 | 42.0 |
| 166 | R¹ + R² = iIN^{w} | | ⁿHeptyl | ⁿHeptyl | Br⁻ | HNR¹R² | 496-12-8 | 2xR⁴X + base | 629-04-9 | C₂₂H₃₈NBr | 396.454 | 44.4 |
| 167 | R¹ + R² = iIN^{w} | | ⁿHeptyl | ⁿHeptyl | CF₃CO₂⁻ | — | — | — | — | C₂₄H₃₈NO₂F₃ | 429.566 | 44.4 |
| 168 | R¹ + R² = iIN^{w} | | ⁿHeptyl | ⁿOctyl | Br⁻ | NR¹R²R³ | 1197914-59-2 | R⁴X | 111-83-1 | C₂₃H₄₀NBr | 410.481 | 46.8 |
| 169 | R¹ + R² = iIN^{w} | | ⁿHeptyl | ⁿOctyl | Br⁻ | HNR³R⁴ | 26627-77-0 | o-(XCH₂)₂C₆H₄ + base | 91-13-4 | C₂₃H₄₀NBr | 410.481 | 46.8 |
| 170 | R¹ + R² = iIN^{w} | | ⁿOctyl | ⁿOctyl | Br⁻ | HNR¹R² | 496-12-8 | 2xR⁴X + base | 111-83-1 | C₂₄H₄₂NBr | 424.508 | 49.1 |
| 171 | R¹ + R² = iIN^{w} | | Methyl | ⁿNonyl | Br⁻ | NR¹R²R³ | 3474-87-1 | R⁴X | 693-58-3 | C₁₈H₃₀NBr | 340.347 | 37.0 |
| 172 | R¹ + R² = iIN^{w} | | Methyl | ⁿNonyl | CF₃CO₂⁻ | — | — | — | — | C₂₀H₃₀NO₂F₃ | 373.459 | 37.0 |
| 173 | R¹ + R² = iIN^{w} | | Methyl | ⁿDecyl | Br⁻ | NR¹R²R³ | 3474-87-1 | R⁴X | 112-29-8 | C₁₉H₃₂NBr | 354.374 | 40.4 |
| 174 | R¹ + R² = iIN^{w} | | Methyl | ⁿDecyl | CF₃CO₂⁻ | — | — | — | — | C₂₁H₃₂NO₂F₃ | 387.486 | 40.4 |
| 175 | R¹ + R² = iIN^{w} | | Methyl | ⁿUndecyl | Br⁻ | NR¹R²R³ | 3474-87-1 | R⁴X | 693-67-4 | C₂₀H₃₄NBr | 368.401 | 43.5 |
| 176 | R¹ + R² = iIN^{w} | | Methyl | ⁿUndecyl | CF₃CO₂⁻ | — | — | — | — | C₂₂H₃₄NO₂F₃ | 401.513 | 43.5 |
| 177 | R¹ + R² = THiQ^{w} | | ⁿPentyl | ⁿButyl | Br⁻ | NR¹R²R³ | 170964-25-7 | R⁴X | 109-65-9 | C₁₈H₃₀NBr | 340.347 | 31.3 |
| 178 | R¹ + R² = THiQ^{w} | | ⁿPentyl | ⁿPentyl | Br⁻ | HNR¹R² | 91-21-4 | 2xR⁴X + base | 110-53-2 | C₁₉H₃₂NBr | 354.374 | 34.5 |
| 179 | R¹ + R² = THiQ^{w} | | ⁿPentyl | ⁿHexyl | Br⁻ | NR¹R²R³ | 170964-25-7 | R⁴X | 111-25-1 | C₂₀H₃₄NBr | 368.401 | 37.5 |
| 180 | R¹ + R² = THiQ^{w} | | ⁿPentyl | ⁿOctyl | Br⁻ | HNR³R⁴ | 6835-13-8 | o-(XCH₂)—C₆H₄—(CH₂CH₂X) + base | 38256-56-3 | C₂₂H₃₈NBr | 396.454 | 42.8 |
| 181 | R¹ + R² = THiQ^{w} | | ⁿHexyl | ⁿHexyl | Br⁻ | HNR¹R² | 91-21-4 | 2xR⁴X + base | 111-25-1 | C₂₁H₃₆NBr | 382.428 | 40.2 |
| 182 | R¹ + R² = THiQ^{w} | | ⁿHexyl | ⁿHexyl | CF₃CO₂⁻ | — | — | — | — | C₂₃H₃₆NO₂F₃ | 415.542 | 40.2 |
| 182b | R¹ + R² = THiQ^{w} | | Ph(CH₂)₃— | Ph(CH₂)₃— | Br⁻ | HNR¹R² | 91-21-4 | 2xR⁴X + base | 637-59-2 | C₂₇H₃₂NBr | 450.454 | 40.5 |
| 182c | R¹ + R² = THiQ^{w} | | Ph(CH₂)₃— | Ph(CH₂)₃— | CF₃CO₂⁻ | — | — | — | — | C₂₉H₃₂NO₂F₃ | 483.565 | 40.5 |
| 183 | R¹ + R² = THiQ^{w} | | ⁿHeptyl | ⁿHexyl | Br⁻ | NR¹R²R³ | 170964-26-8 | R⁴X | 111-25-1 | C₂₂H₃₈NBr | 396.454 | 42.7 |
| 184 | R¹ + R² = THiQ^{w} | | ⁿHeptyl | ⁿHeptyl | Br⁻ | HNR¹R² | 91-21-4 | 2xR⁴X + base | 629-04-9 | C₂₃H₄₀NBr | 410.481 | 45.1 |
| 185 | R¹ + R² = THiQ^{w} | | ⁿHeptyl | ⁿOctyl | Br⁻ | NR¹R²R³ | 170964-26-8 | R⁴X | 111-83-1 | C₂₄H₄₂NBr | 424.508 | 47.4 |
| 186 | R¹ + R² = THiQ^{w} | | ⁿHeptyl | ⁿOctyl | Br⁻ | HNR³R⁴ | 26627-77-0 | o-(XCH₂)—C₆H₄—(CH₂CH₂X) + base | 38256-56-3 | C₂₄H₄₂NBr | 424.508 | 47.4 |
| 187 | R¹ + R² = THiQ^{w} | | ⁿOctyl | ⁿOctyl | Br⁻ | HNR¹R² | 91-21-4 | 2xR⁴X + base | 111-83-1 | C₂₅H₄₄NBr | 438.535 | 49.6 |
| 188 | R¹ + R² = THiQ^{w} | | Methyl | ⁿNonyl | Br⁻ | NR¹R²R³ | 1612-65-3 | R⁴X | 693-58-3 | C₁₉H₃₂NBr | 354.374 | 37.9 |
| 189 | R¹ + R² = THiQ^{w} | | Methyl | ⁿNonyl | CF₃CO₂⁻ | — | — | — | — | C₂₁H₃₂NO₂F₃ | 387.486 | 37.9 |
| 190 | R¹ + R² = THiQ^{w} | | Methyl | ⁿDecyl | Br⁻ | NR¹R²R³ | 1612-65-3 | R⁴X | 112-29-8 | C₂₀H₃₄NBr | 368.401 | 41.2 |
| 191 | R¹ + R² = THiQ^{w} | | Methyl | ⁿDecyl | CF₃CO₂⁻ | — | — | — | — | C₂₂H₃₄NO₂F₃ | 401.513 | 41.2 |
| 192 | R¹ + R² = THiQ^{w} | | Methyl | ⁿUndecyl | Br⁻ | NR¹R²R³ | 1612-65-3 | R⁴X | 693-67-4 | C₂₁H₃₆NBr | 382.428 | 44.3 |
| 193 | R¹ + R² = THiQ^{w} | | Methyl | ⁿUndecyl | CF₃CO₂⁻ | — | — | — | — | C₂₃H₃₆NO₂F₃ | 415.540 | 44.3 |
| 194 | ⁿDecyl | Methyl | Methyl | PhC(O)CH₂— | Cl⁻ | NR¹R²R³ | 1120-24-7 | R⁴X | 532-27-4 | C₂₀H₃₄NOCl | 339.943 | 42.7 |
| 195 | ⁿDecyl | Methyl | Methyl | PhC(O)CH₂— | Br⁻ | NR¹R²R³ | 1120-24-7 | R⁴X | 70-11-1 | C₂₀H₃₄NOBr | 384.394 | 42.7 |
| 196 | ⁿDecyl | Methyl | Methyl | PhC(O)CH₂— | CF₃CO₂⁻ | — | — | — | — | C₂₂H₃₄NO₃F₃ | 417.512 | 42.7 |
| 197 | ⁿDecyl | Methyl | Methyl | 4-FC₆H₄C(O)CH₂— | Cl⁻ | NR¹R²R³ | 1120-24-7 | R⁴X | 456-04-2 | C₂₀H₃₃NOClF | 357.939 | 42.9 |
| 198 | ⁿDecyl | Methyl | Methyl | 4-FC₆H₄C(O)CH₂— | CF₃CO₂⁻ | — | — | — | — | C₂₂H₃₃NO₃F₄ | 435.503 | 42.9 |
| 199 | ⁿDecyl | Methyl | Methyl | 4-CH₃C₆H₄C(O)CH₂— | Br⁻ | NR¹R²R³ | 1120-24-7 | R⁴X | 619-41-0 | C₂₁H₃₆NOBr | 398.421 | 44.5 |
| 200 | ⁿDecyl | Methyl | Methyl | 4-CF₃C₆H₄C(O)CH₂— | Br⁻ | NR¹R²R³ | 1120-24-7 | R⁴X | 383-53-9 | C₂₁H₃₃NOBrF₃ | 452.398 | 45.9 |
| 201 | ⁿDecyl | Methyl | Methyl | 4-ClC₆H₄C(O)CH₂— | Cl⁻ | NR¹R²R³ | 1120-24-7 | R⁴X | 937-20-2 | C₂₀H₃₃NOCl₂ | 374.394 | 45.2 |
| 202 | ⁿDecyl | Methyl | Methyl | 4-BrC₆H₄C(O)CH₂— | Br⁻ | NR¹R²R³ | 1120-24-7 | R⁴X | 99-73-0 | C₂₀H₃₃NOBr₂ | 463.296 | 45.7 |
| 203 | ⁿDecyl | Methyl | Methyl | dl-PhC(O)CH(Ph)— | Cl⁻ | NR¹R²R³ | 1120-24-7 | R⁴X | 447-31-4 | C₂₆H₃₈NOCl | 416.047 | 46.2 |
| 204 | ⁿDecyl | Methyl | Methyl | Ph(CH₂)₄— | Br⁻ | NR¹R²R³ | 1120-24-7 | R⁴X | 13633-25-5 | C₂₂H₄₀NBr | 398.470 | 46.0 |
| 205 | ⁿDecyl | Methyl | Methyl | Ph(CH₂)₃— | Br⁻ | NR¹R²R³ | 1120-24-7 | R⁴X | 673-59-2 | C₂₁H₃₈NBr | 384.443 | 44.4 |
| 206 | ⁿDecyl | Methyl | Methyl | dl-PhCH₂CH(OH)CH₂— | Cl⁻ | HNR¹R²R³Cl | 10237-16-8 | 2-benzyloxirane | 4436-24-2 | C₂₁H₃₈NOCl | 355.992 | 40.9 |
| 207 | ⁿDecyl | Methyl | Methyl | t-PhCH═CHCH₂— | Cl⁻ | NR¹R²R³ | 1120-24-7 | R⁴X | 2687-12-9 | C₂₁H₃₆NCl | 337.970 | 44.9 |
| 208 | ⁿDecyl | Methyl | Methyl | Ph(CH₂)₂— | Br⁻ | NR²R³R⁴ | 1126-71-2 | R¹X | 112-29-8 | C₂₀H₃₆NBr | 370.417 | 42.8 |
| 209 | ⁿDecyl | Methyl | Methyl | 1-(CH₂)naphthylene | Cl⁻ | NR¹R²R³ | 1120-24-7 | R⁴X | 86-52-2 | C₂₄H₃₈NCl | 376.018 | 44.8 |
| 210 | ⁿDecyl | Methyl | Methyl | 9-(CH₂)anthracene | Cl⁻ | NR¹R²R³ | 1120-24-7 | R⁴X | 24463-19-2 | C₂₇H₃₈NCl | 412.058 | 48.2 |
| 211 | ⁿNonyl | Methyl | Methyl | PhC(O)CH₂— | Cl⁻ | NR¹R²R³ | 17373-27-2 | R⁴X | 532-27-4 | C₁₉H₃₂NOCl | 325.922 | 39.6 |
| 212 | ⁿNonyl | Methyl | Methyl | PhC(O)CH₂— | Br⁻ | NR¹R²R³ | 17373-27-2 | R⁴X | 70-11-1 | C₁₉H₃₂NOBr | 370.373 | 39.6 |
| 213 | ⁿNonyl | Methyl | Methyl | PhC(O)CH₂— | CF₃CO₂⁻ | — | — | — | — | C₂₁H₃₂NO₃F₃ | 403.485 | 39.6 |
| 214 | ⁿNonyl | Methyl | Methyl | 4-FC₆H₄C(O)CH₂— | Cl⁻ | NR¹R²R³ | 17373-27-2 | R⁴X | 456-04-2 | C₁₉H₃₁NOClF | 343.912 | 39.8 |
| 215 | ⁿNonyl | Methyl | Methyl | 4-FC₆H₄C(O)CH₂— | CF₃CO₂⁻ | — | — | — | — | C₂₁H₃₁NO₃F₄ | 421.476 | 39.8 |
| 216 | ⁿNonyl | Methyl | Methyl | 4-CH₃C₆H₄C(O)CH₂— | Br⁻ | NR¹R²R³ | 17373-27-2 | R⁴X | 619-41-0 | C₂₀H₃₄NOBr | 384.400 | 41.9 |
| 217 | ⁿOctyl | Ethyl | Ethyl | Benzyl | Cl⁻ | NR¹R²R³ | 4088-37-3 | R⁴X | 100-44-7 | C₁₉H₃₄NCl | 311.938 | 37.1 |
| 218 | ⁿOctyl | Ethyl | Ethyl | Benzyl | CF₃CO₂⁻ | — | — | — | — | C₂₁H₃₄NO₂F₃ | 389.502 | 37.1 |
| 219 | ⁿOctyl | Ethyl | Ethyl | 4-FC₆H₄CH₂— | Cl⁻ | NR¹R²R³ | 4088-37-3 | R⁴X | 352-11-4 | C₁₉H₃₃NClF | 329.929 | 37.3 |
| 220 | ⁿOctyl | Ethyl | Ethyl | 4-FC₆H₄CH₂— | CF₃CO₂⁻ | — | — | — | — | C₂₁H₃₃NO₂F₄ | 407.492 | 37.3 |
| 221 | ⁿNonyl | Ethyl | Ethyl | Benzyl | Cl⁻ | NR¹R²R³ | 45124-35-4 | R⁴X | 100-44-7 | C₂₀H₃₆NCl | 325.965 | 40.1 |
| 222 | ⁿNonyl | Ethyl | Ethyl | Benzyl | CF₃CO₂⁻ | — | — | — | — | C₂₂H₃₆NO₂F₃ | 403.529 | 40.1 |
| 223 | ⁿNonyl | Ethyl | Ethyl | Benzyl | Br⁻ | NR¹R²R³ | 45124-35-4 | R⁴X | 100-39-0 | C₂₀H₃₆NBr | 370.417 | 40.1 |
| 224 | ⁿNonyl | Ethyl | Ethyl | Benzyl | Br⁻ | NR²R³R⁴ | 772-54-3 | R¹X | 693-58-3 | C₂₀H₃₆NBr | 370.417 | 40.1 |
| 225 | ⁿNonyl | Ethyl | Ethyl | PhC(O)CH₂— | Cl⁻ | NR¹R²R³ | 45124-35-4 | R⁴X | 532-27-4 | C₂₁H₃₆NOCl | 353.976 | 41.8 |
| 226 | ⁿNonyl | Ethyl | Ethyl | 4-FC₆H₄CH₂— | Cl⁻ | NR¹R²R³ | 45124-35-4 | R⁴X | 352-11-4 | C₂₀H₃₅NFCl | 343.950 | 40.4 |
| 227 | ⁿNonyl | Ethyl | Ethyl | 4-FC₆H₄CH₂— | CF₃CO₂⁻ | — | — | — | — | C₂₂H₃₅NO₂F₄ | 421.519 | 40.4 |
| 228 | ⁿDecyl | Ethyl | Ethyl | Benzyl | Cl⁻ | NR¹R²R³ | 6308-94-7 | R⁴X | 100-44-7 | C₂₁H₃₈NCl | 339.986 | 43.3 |
| 229 | ⁿDecyl | Ethyl | Ethyl | Benzyl | CF₃CO₂⁻ | — | — | — | — | C₂₃H₃₈NO₂F₃ | 417.549 | 43.3 |
| 230 | ⁿDecyl | Ethyl | Ethyl | Benzyl | Br⁻ | NR¹R²R³ | 6308-94-7 | R⁴X | 100-39-0 | C₂₁H₃₈NBr | 384.437 | 43.3 |
| 231 | ⁿDecyl | Ethyl | Ethyl | Benzyl | Br⁻ | NR²R³R⁴ | 6308-94-7 | R¹X | 100-39-0 | C₂₁H₃₈NBr | 384.437 | 43.3 |
| 232 | ⁿDecyl | Ethyl | Ethyl | 4-FC₆H₄CH₂— | Cl⁻ | NR¹R²R³ | 6308-94-7 | R⁴X | 352-11-4 | C₂₁H₃₇NClF | 357.983 | 43.5 |
| 233 | ⁿDecyl | Ethyl | Ethyl | 4-FC₆H₄CH₂— | CF₃CO₂⁻ | — | — | — | — | C₂₃H₃₇NO₂F₄ | 435.546 | 43.5 |
| 234 | ⁿUndecyl | Ethyl | Ethyl | Benzyl | Cl⁻ | NR¹R²R³ | 54334-64-4 | R⁴X | 100-44-7 | C₂₂H₄₀NCl | 354.019 | 46.3 |
| 235 | ⁿUndecyl | Ethyl | Ethyl | Benzyl | CF₃CO₂⁻ | — | — | — | — | C₂₄H₄₀NO₂F₃ | 431.582 | 46.3 |
| 236 | ⁿUndecyl | Ethyl | Ethyl | 4-FC₆H₄CH₂— | Cl⁻ | NR¹R²R³ | 54334-64-4 | R⁴X | 352-11-4 | C₂₂H₃₉NClF | 372.010 | 46.5 |
| 237 | ⁿUndecyl | Ethyl | Ethyl | 4-FC₆H₄CH₂— | CF₃CO₂⁻ | — | — | — | — | C₂₄H₃₉NO₂F₄ | 449.573 | 46.5 |
| 238 | ⁿHeptyl | ⁿPropyl | ⁿPropyl | Benzyl | Cl⁻ | NR¹R²R³ | New^{d} | R⁴X | 100-44-7 | C₂₀H₃₆NCl | 325.965 | 37.9 |
| 239 | ⁿHeptyl | ⁿPropyl | ⁿPropyl | Benzyl | CF₃CO₂⁻ | — | — | — | — | C₂₂H₃₆NO₂F₃ | 403.529 | 37.9 |
| 240 | ⁿHeptyl | ⁿPropyl | ⁿPropyl | 4-FC₆H₄CH₂— | Cl⁻ | NR¹R²R³ | New^{d} | R⁴X | 352-11-4 | C₂₀H₃₅NClF | 343.956 | 38.1 |
| 241 | ⁿHeptyl | ⁿPropyl | ⁿPropyl | 4-FC₆H₄CH₂— | CF₃CO₂⁻ | — | — | — | — | C₂₂H₃₅NO₂F₄ | 421.519 | 38.1 |
| 242 | ⁿOctyl | ⁿPropyl | ⁿPropyl | Benzyl | Cl⁻ | NR¹R²R³ | 99209-95-7 | R⁴X | 100-44-7 | C₂₁H₃₈NCl | 339.992 | 41.0 |
| 243 | ⁿOctyl | ⁿPropyl | ⁿPropyl | Benzyl | CF₃CO₂⁻ | — | — | — | — | C₂₃H₃₈NO₂F₃ | 417.555 | 41.0 |
| 244 | ⁿOctyl | ⁿPropyl | ⁿPropyl | 4-FC₆H₄CH₂— | Cl⁻ | NR¹R²R³ | 99209-95-7 | R⁴X | 352-11-4 | C₂₁H₃₇NClF | 357.983 | 41.2 |
| 245 | ⁿOctyl | ⁿPropyl | ⁿPropyl | 4-FC₆H₄CH₂— | CF₃CO₂⁻ | — | — | — | — | C₂₃H₃₇NO₂F₄ | 435.546 | 41.2 |
| 246 | ⁿNonyl | ⁿPropyl | ⁿPropyl | Benzyl | Cl⁻ | NR¹R²R³ | 90105-55-8 | R⁴X | 100-44-7 | C₂₂H₄₀NCl | 354.019 | 44.1 |
| 247 | ⁿNonyl | ⁿPropyl | ⁿPropyl | Benzyl | CF₃CO₂⁻ | — | — | — | — | C₂₄H₄₀NO₂F₃ | 431.582 | 44.1 |
| 248 | ⁿNonyl | ⁿPropyl | ⁿPropyl | 4-FC₆H₄CH₂— | Cl⁻ | NR¹R²R³ | 90105-55-8 | R⁴X | 352-11-4 | C₂₂H₃₉NClF | 372.010 | 44.3 |
| 249 | ⁿNonyl | ⁿPropyl | ⁿPropyl | 4-FC₆H₄CH₂— | CF₃CO₂⁻ | — | — | — | — | C₂₄H₃₉NO₂F₄ | 449.573 | 44.3 |
| 250 | ⁿDecyl | ⁿPropyl | ⁿPropyl | Benzyl | Cl⁻ | NR¹R²R³ | 88090-10-2 | R⁴X | 100-44-7 | C₂₃H₄₂NCl | 368.046 | 47.2 |
| 251 | ⁿDecyl | ⁿPropyl | ⁿPropyl | Benzyl | CF₃CO₂⁻ | — | — | — | — | C₂₅H₄₂NO₂F₃ | 445.609 | 47.2 |
| 252 | ⁿDecyl | ⁿPropyl | ⁿPropyl | 4-FC₆H₄CH₂— | Cl⁻ | NR¹R²R³ | 88090-10-2 | R⁴X | 352-11-4 | C₂₃H₄₁NClF | 386.036 | 47.4 |
| 253 | ⁿDecyl | ⁿPropyl | ⁿPropyl | 4-FC₆H₄CH₂— | CF₃CO₂⁻ | — | — | — | — | C₂₅H₄₁NO₂F₄ | 463.600 | 47.4 |
| 254 | ⁿUndecyl | ⁿPropyl | ⁿPropyl | Benzyl | Cl⁻ | NR¹R²R³ | 220644-99-1 | R⁴X | 100-44-7 | C₂₄H₄₄NCl | 382.073 | 50.2 |
| 255 | ⁿUndecyl | ⁿPropyl | ⁿPropyl | Benzyl | CF₃CO₂⁻ | — | — | — | — | C₂₆H₄₄NO₂F₃ | 459.636 | 50.2 |
| 256 | ⁿUndecyl | ⁿPropyl | ⁿPropyl | 4-FC₆H₄CH₂— | Cl⁻ | NR¹R²R³ | 220644-99-1 | R⁴X | 352-11-4 | C₂₄H₄₃NClF | 400.063 | 50.4 |
| 257 | ⁿUndecyl | ⁿPropyl | ⁿPropyl | 4-FC₆H₄CH₂— | CF₃CO₂⁻ | — | — | — | — | C₂₆H₄₃NO₂F₄ | 477.627 | 50.4 |
| 258 | ⁿHexyl | ⁿButyl | ⁿButyl | Benzyl | Cl⁻ | NR¹R²R³ | 23601-43-6 | R⁴X | 100-44-7 | C₂₁H₃₈NCl | 339.992 | 40.2 |
| 259 | ⁿHexyl | ⁿButyl | ⁿButyl | Benzyl | CF₃CO₂⁻ | — | — | — | — | C₂₃H₃₈NO₂F₃ | 417.555 | 40.2 |
| 260 | ⁿHexyl | ⁿButyl | ⁿButyl | 4-FC₆H₄CH₂— | Cl⁻ | NR¹R²R³ | 23601-43-6 | R⁴X | 352-11-4 | C₂₁H₃₇NClF | 357.983 | 40.4 |
| 261 | ⁿHexyl | ⁿButyl | ⁿButyl | 4-FC₆H₄CH₂— | CF₃CO₂⁻ | — | — | — | — | C₂₃H₃₇NO₂F₄ | 435.546 | 40.4 |
| 262 | ⁿHeptyl | ⁿButyl | ⁿButyl | Benzyl | Cl⁻ | NR¹R²R³ | 3553-87-5 | R⁴X | 100-44-7 | C₂₂H₄₀NCl | 354.019 | 42.7 |
| 263 | ⁿHeptyl | ⁿButyl | ⁿButyl | Benzyl | CF₃CO₂⁻ | — | — | — | — | C₂₄H₄₀NO₂F₃ | 431.582 | 42.7 |
| 264 | ⁿHeptyl | ⁿButyl | ⁿButyl | 4-FC₆H₄CH₂— | Cl⁻ | NR¹R²R³ | 3553-87-5 | R⁴X | 351-11-4 | C₂₂H₃₉NClF | 372.010 | 42.9 |
| 265 | ⁿHeptyl | ⁿButyl | ⁿButyl | 4-FC₆H₄CH₂— | CF₃CO₂⁻ | — | — | — | — | C₂₄H₃₉NO₂F₄ | 449.573 | 42.9 |
| 266 | ⁿOctyl | ⁿButyl | ⁿButyl | Benzyl | Cl⁻ | NR¹R²R³ | 41145-51-1 | R⁴X | 100-44-7 | C₂₃H₄₂NCl | 368.046 | 45.6 |
| 267 | ⁿOctyl | ⁿButyl | ⁿButyl | Benzyl | CF₃CO₂⁻ | — | — | — | — | C₂₅H₄₂NO₂F₃ | 445.609 | 45.6 |
| 268 | ⁿOctyl | ⁿButyl | ⁿButyl | 4-FC₆H₄CH₂— | Cl⁻ | NR¹R²R³ | 41145-51-1 | R⁴X | 352-11-4 | C₂₃H₄₁NClF | 386.036 | 45.8 |
| 269 | ⁿOctyl | ⁿButyl | ⁿButyl | 4-FC₆H₄CH₂— | CF₃CO₂⁻ | — | — | — | — | C₂₅H₄₁NO₂F₄ | 463.600 | 45.8 |
| 270 | ⁿNonyl | ⁿButyl | ⁿButyl | Benzyl | Cl⁻ | NR¹R²R³ | 93658-58-3 | R⁴X | 100-44-7 | C₂₄H₄₄NCl | 382.073 | 48.7 |
| 271 | ⁿNonyl | ⁿButyl | ⁿButyl | Benzyl | CF₃CO₂⁻ | — | — | — | — | C₂₆H₄₄NO₂F₃ | 459.636 | 48.7 |
| 272 | ⁿNonyl | ⁿButyl | ⁿButyl | 4-FC₆H₄CH₂— | Cl⁻ | NR¹R²R³ | 93658-58-3 | R⁴X | 352-11-4 | C₂₄H₄₃NClF | 400.063 | 48.9 |
| 273 | ⁿNonyl | ⁿButyl | ⁿButyl | 4-FC₆H₄CH₂— | CF₃CO₂⁻ | — | — | — | — | C₂₆H₄₃NO₂F₄ | 477.627 | 48.9 |
| 274 | ⁿDecyl | ⁿButyl | ⁿButyl | Benzyl | Cl⁻ | NR¹R²R³ | 13573-55-2 | R⁴X | 100-44-7 | C₂₅H₄₆NCl | 396.100 | 51.8 |
| 275 | ⁿDecyl | ⁿButyl | ⁿButyl | Benzyl | CF₃CO₂⁻ | — | — | — | — | C₂₇H₄₆NO₂F₃ | 473.663 | 51.8 |
| 276 | ⁿDecyl | MeO(CH₂)₂ | MeO(CH₂)₂ | Benzyl | Cl⁻ | NR¹R²R³ | New^{g} | R⁴X | 100-44-7 | C₂₃H₄₂NO₂Cl | 400.045 | 46.7 |
| 277 | ⁿDecyl | ⁿButyl | ⁿButyl | 4-FC₆H₄CH₂— | Cl⁻ | NR¹R²R³ | 13573-55-2 | R⁴X | 352-11-4 | C₂₅H₄₅NClF | 414.090 | 52.0 |
| 278 | ⁿDecyl | ⁿButyl | ⁿButyl | 4-FC₆H₄CH₂— | CF₃CO₂⁻ | — | — | — | — | C₂₇H₄₅NO₂F₄ | 491.653 | 52.0 |
| 279 | ⁿUndecyl | ⁿButyl | ⁿButyl | Benzyl | Cl⁻ | NR¹R²R³ | 220645-00-1 | R⁴X | 100-44-7 | C₂₆H₄₈NCl | 410.127 | 54.8 |
| 280 | ⁿUndecyl | ⁿButyl | ⁿButyl | Benzyl | CF₃CO₂⁻ | — | — | — | — | C₂₈H₄₈NO₂F₃ | 487.690 | 54.8 |
| 281 | ⁿUndecyl | ⁿButyl | ⁿButyl | 4-FC₆H₄CH₂— | Cl⁻ | NR¹R²R³ | 220645-00-1 | R⁴X | 352-11-4 | C₂₆H₄₇NClF | 428.117 | 60.0 |
| 282 | ⁿUndecyl | ⁿButyl | ⁿButyl | 4-FC₆H₄CH₂— | CF₃CO₂⁻ | — | — | — | — | C₂₈H₄₇NO₂F₄ | 505.680 | 60.0 |
| 282b | Ph(CH₂)₃— | R² + R³ = —(CH₂)₄— | | same as R¹ | Br⁻ | HNR²R³ | 123-75-1 | 2xR¹X + base | 637-59-2 | C₂₂H₃₀NBr | 388.384 | 34.4 |
| 282c | Ph(CH₂)₃— | R² + R³ = —(CH₂)₄— | | same as R¹ | CF₃CO₂⁻ | — | — | — | — | C₂₄H₃₀NO₂F₃ | 421.496 | 34.4 |
| 282d | Ph(CH₂)₄— | R² + R³ = —(CH₂)₄— | | Ph(CH₂)₃— | Br⁻ | NR¹R²R³ | 163675-54-5 | R⁴X | 637-59-2 | C₂₃H₃₂NBr | 402.411 | 36.7 |
| 282e | Ph(CH₂)₄— | R² + R³ = —(CH₂)₄— | | Ph(CH₂)₃— | CF₃CO₂⁻ | — | — | — | — | C₂₅H₃₂NO₂F₃ | 435.522 | 36.7 |
| 282f | Ph(CH₂)₄— | R² + R³ = —(CH₂)₄— | | same as R¹ | Br⁻ | HNR²R³ | 123-75-1 | 2xR¹X + base | 13633-25-5 | C₂₄H₃₄NBr | 416.438 | 39.0 |
| 282g | Ph(CH₂)₄— | R² + R³ = —(CH₂)₄— | | same as R¹ | CF₃CO₂⁻ | — | — | — | — | C₂₆H₃₄NO₂F₃ | 449.549 | 39.0 |
| 283 | ⁿHeptyl | R² + R³ = —(CH₂)₄— | | Benzyl | Cl⁻ | NR¹R²R³ | 121409-85-6 | R⁴X | 100-44-7 | C₁₈H₃₀NCl | 295.887 | 33.3 |
| 283b | ⁿHeptyl | R² + R³ = —(CH₂)₄— | | Benzyl | CF₃CO₂⁻ | — | — | — | — | C₂₀H₃₀NO₂F₃ | 373.450 | 33.3 |
| 283c | ⁿHeptyl | R² + R³ = —(CH₂)₄— | | 4-FC₆H₄CH₂— | Cl⁻ | NR¹R²R³ | 121409-85-6 | R⁴X | 352-11-4 | C₁₈H₂₉NClF | 313.877 | 33.5 |
| 283d | ⁿHeptyl | R² + R³ = —(CH₂)₄— | | 4-FC₆H₄CH₂— | CF₃CO₂⁻ | — | — | — | — | C₂₀H₂₉NO₂F₄ | 391.441 | 33.5 |
| 284 | ⁿOctyl | R² + R³ = —(CH₂)₄— | | Benzyl | Cl⁻ | NR¹R²R³ | 7335-08-2 | R⁴X | 100-44-7 | C₁₉H₃₂NCl | 309.923 | 36.5 |
| 284b | ⁿOctyl | R² + R³ = —(CH₂)₄— | | Benzyl | CF₃CO₂⁻ | — | — | — | — | C₂₁H₃₂NO₂F₃ | 387.486 | 36.5 |
| 285 | ⁿOctyl | R² + R³ = —(CH₂)₄— | | 4-FC₆H₄CH₂— | Cl⁻ | NR¹R²R³ | 7335-08-2 | R⁴X | 352-11-4 | C₁₉H₃₁NClF | 327.913 | 36.4 |
| 286 | ⁿOctyl | R² + R³ = —(CH₂)₄— | | 4-FC₆H₄CH₂— | CF₃CO₂⁻ | — | — | — | — | C₂₁H₃₁NO₂F₄ | 405.476 | 36.4 |
| 287 | ⁿOctyl | R² + R³ = —(CH₂)₄— | | PhC(O)CH₂— | Cl⁻ | NR¹R²R³ | 7335-08-2 | R⁴X | 532-27-4 | C₂₀H₃₂NOCl | 337.927 | 38.1 |
| 288 | ⁿOctyl | R² + R³ = —(CH₂)₄— | | PhC(O)CH₂— | CF₃CO₂⁻ | — | — | — | — | C₂₂H₃₂NO₃F₃ | 415.496 | 38.1 |
| 289 | ⁿOctyl | R² + R³ = —(CH₂)₄— | | 4-FC₆H₄C(O)CH₂— | Cl⁻ | NR¹R²R³ | 7335-08-2 | R⁴X | 456-04-2 | C₂₀H₃₁NOClF | 355.923 | 38.3 |
| 290 | ⁿOctyl | R² + R³ = —(CH₂)₄— | | 4-FC₆H₄C(O)CH₂— | CF₃CO₂⁻ | — | — | — | — | C₂₂H₃₁NO₃F₄ | 433.487 | 38.3 |
| 291 | ⁿNonyl | R² + R³ = —(CH₂)₄— | | Benzyl | Cl⁻ | NR¹R²R³ | 74673-25-9 | R⁴X | 100-44-7 | C₂₀H₃₄NCl | 323.949 | 39.5 |
| 292 | ⁿNonyl | R² + R³ = —(CH₂)₄— | | Benzyl | CF₃CO₂⁻ | — | — | — | — | C₂₂H₃₄NO₂F₃ | 401.513 | 39.5 |
| 293 | ⁿNonyl | R² + R³ = —(CH₂)₄— | | 4-FC₆H₄CH₂— | Cl⁻ | NR¹R²R³ | 74673-25-9 | R⁴X | 352-11-4 | C₂₀H₃₃NClF | 341.940 | 39.7 |
| 294 | ⁿNonyl | R² + R³ = —(CH₂)₄— | | 4-FC₆H₄CH₂— | CF₃CO₂⁻ | — | — | — | — | C₂₂H₃₃NO₂F₄ | 419.503 | 39.7 |
| 294b | Ph(CH₂)₆— | R² + R³ = —(CH₂)₄— | | 4-FC₆H₄CH₂— | Cl⁻ | NR¹R²R³ | New | R⁴X | 352-11-4 | C₂₃H₃₁NClF | 375.950 | 40.1 |
| 294c | Ph(CH₂)₆— | R² + R³ = —(CH₂)₄— | | 4-FC₆H₄CH₂— | CF₃CO₂⁻ | — | — | — | — | C₂₅H₃₁NO₂F₄ | 453.513 | 40.1 |
| 295 | ⁿNonyl | R² + R³ = —(CH₂)₅— | | Benzyl | Cl⁻ | NR¹R²R³ | 30538-80-8 | R⁴X | 100-44-7 | C₂₁H₃₆NCl | 337.970 | 41.4 |
| 296 | ⁿNonyl | R² + R³ = —(CH₂)₅— | | 4-FC₆H₄CH₂— | Cl⁻ | NR¹R²R³ | 30538-80-8 | R⁴X | 352-11-4 | C₂₁H₃₅NClF | 355.961 | 41.6 |
| 297 | ⁿNonyl | R² + R³ = —(CH₂)₄— | | PhC(O)CH₂— | Cl⁻ | NR¹R²R³ | 74673-25-9 | R⁴X | 532-27-4 | C₂₁H₃₄NOCl | 351.960 | 41.2 |
| 298 | ⁿNonyl | R² + R³ = —(CH₂)₄— | | PhC(O)CH₂— | CF₃CO₂⁻ | — | — | — | — | C₂₃H₃₄NO₃F₃ | 429.523 | 41.2 |
| 299 | ⁿNonyl | R² + R³ = —(CH₂)₄— | | 4-FC₆H₄C(O)CH₂— | Cl⁻ | NR¹R²R³ | 74673-25-9 | R⁴X | 456-04-2 | C₂₁H₃₃NOClF | 369.950 | 41.4 |
| 300 | ⁿNonyl | R² + R³ = —(CH₂)₄— | | 4-FC₆H₄C(O)CH₂— | CF₃CO₂⁻ | — | — | — | — | C₂₃H₃₃NO₃F₄ | 447.514 | 41.4 |
| 301 | ⁿUndecyl | R² + R³ = —(CH₂)₄— | | Benzyl | Cl⁻ | NR¹R²R³ | 74673-27-1 | R⁴X | 100-44-7 | C₂₂H₃₈NCl | 352.003 | 45.8 |
| 302 | ⁿUndecyl | R² + R³ = —(CH₂)₄— | | Benzyl | CF₃CO₂⁻ | — | — | — | — | C₂₄H₃₈NO₂F₃ | 429.566 | 45.8 |
| 303 | ⁿUndecyl | R² + R³ = —(CH₂)₄— | | 4-FC₆H₄CH₂— | Cl⁻ | NR¹R²R³ | 74673-27-1 | R⁴X | 352-11-4 | C₂₂H₃₇NClF | 369.994 | 46.0 |
| 304 | ⁿUndecyl | R² + R³ = —(CH₂)₄— | | 4-FC₆H₄CH₂— | CF₃CO₂⁻ | — | — | — | — | C₂₄H₃₇NO₂F₄ | 447.557 | 46.0 |
| 305 | ⁿUndecyl | R² + R³ = —(CH₂)₄— | | PhC(O)CH₂— | Cl⁻ | NR¹R²R³ | 74673-27-1 | R⁴X | 532-27-4 | C₂₃H₃₈NOCl | 380.007 | 47.4 |
| 306 | ⁿUndecyl | R² + R³ = —(CH₂)₄— | | PhC(O)CH₂— | CF₃CO₂⁻ | — | — | — | — | C₂₅H₃₈NO₃F₃ | 457.577 | 47.4 |
| 307 | ⁿUndecyl | R² + R³ = —(CH₂)₄— | | 4-FC₆H₄C(O)CH₂— | Cl⁻ | NR¹R²R³ | 74673-27-1 | R⁴X | 456-04-2 | C₂₃H₃₇NOClF | 398.004 | 47.6 |
| 308 | ⁿUndecyl | R² + R³ = —(CH₂)₄— | | 4-FC₆H₄C(O)CH₂— | CF₃CO₂⁻ | — | — | — | — | C₂₅H₃₇NO₃F₄ | 475.567 | 47.6 |
| 309 | ⁿDecyl | R² + R³ = —(CH₂)₄— | | Benzyl | Cl⁻ | NR¹R²R³ | 74673-26-0 | R⁴X | 100-44-7 | C₂₁H₃₆NCl | 337.976 | 42.7 |
| 310 | ⁿDecyl | R² + R³ = —(CH₂)₄— | | Benzyl | Br⁻ | NR¹R²R³ | 74673-26-0 | R⁴X | 100-39-0 | C₂₁H₃₆NBr | 382.428 | 42.7 |
| 311 | ⁿDecyl | R² + R³ = —(CH₂)₄— | | Benzyl | OH⁻ | — | — | — | — | C₂₁H₃₇NO | 319.531 | 42.7 |
| 312 | ⁿDecyl | R² + R³ = —(CH₂)₄— | | Benzyl | CF₃CO₂⁻ | — | — | — | — | C₂₃H₃₆NO₂F₃ | 415.540 | 42.7 |
| 313 | ⁿDecyl | R² + R³ = —(CH₂)₄— | | 2-FC₆H₄CH₂— | Cl⁻ | NR¹R²R³ | 74673-26-0 | R⁴X | 345-35-7 | C₂₁H₃₅NClF | 355.967 | 42.8 |
| 314 | ⁿDecyl | R² + R³ = —(CH₂)₄— | | 3-FC₆H₄CH₂— | Cl⁻ | NR¹R²R³ | 74673-26-0 | R⁴X | 456-42-8 | C₂₁H₃₅NClF | 355.967 | 42.8 |
| 315 | ⁿDecyl | R² + R³ = —(CH₂)₄— | | 4-FC₆H₄CH₂— | Cl⁻ | NR¹R²R³ | 74673-26-0 | R⁴X | 352-11-4 | C₂₁H₃₅NClF | 355.967 | 42.9 |
| 316 | ⁿDecyl | R² + R³ = —(CH₂)₄— | | 4-FC₆H₄CH₂— | Br⁻ | NR¹R²R³ | 74673-26-0 | R⁴X | 459-46-1 | C₂₁H₃₅NBrF | 400.418 | 42.9 |
| 317 | ⁿDecyl | R² + R³ = —(CH₂)₄— | | 4-FC₆H₄CH₂— | OH⁻ | — | — | — | — | C₂₁H₃₆NOF | 337.521 | 42.9 |
| 318 | ⁿDecyl | R² + R³ = —(CH₂)₄— | | 4-FC₆H₄CH₂— | CF₃CO₂⁻ | — | — | — | — | C₂₃H₃₅NO₂F₄ | 433.530 | 42.9 |
| 319 | ⁿDecyl | R² + R³ = —(CH₂)₄— | | 4-FC₆H₄CH₂— | HCO₂⁻ | — | — | — | — | C₂₂H₃₆NO₂F | 365.532 | 42.9 |
| 320 | ⁿDecyl | R² + R³ = —(CH₂)₄— | | 4-FC₆H₄CH₂— | CH₃CO₂⁻ | — | — | — | — | C₂₃H₃₈NO₂F | 379.559 | 42.9 |
| 321 | ⁿDecyl | R² + R³ = —(CH₂)₄— | | 4-FC₆H₄CH₂— | CH₃SO₃⁻ | — | — | — | — | C₂₂H₃₈NO₃FS | 415.607 | 42.9 |
| 322 | ⁿDecyl | R² + R³ = —(CH₂)₄— | | 4-FC₆H₄CH₂— | CF₃SO₃⁻ | — | — | — | — | C₂₂H₃₅NO₃F₄S | 469.578 | 42.9 |
| 323 | ⁿDecyl | R² + R³ = —(CH₂)₄— | | 3-ClC₆H₄CH₂— | Cl⁻ | NR¹R²R³ | 74673-26-0 | R⁴X | 620-20-2 | C₂₁H₃₅NCl₂ | 372.421 | 44.5 |
| 324 | ⁿDecyl | R² + R³ = —(CH₂)₄— | | 2,6-F₂C₆H₃CH₂— | Cl⁻ | NR¹R²R³ | 74673-26-0 | R⁴X | 697-73-4 | C₂₁H₃₄NClF₂ | 373.957 | 43.2 |
| 325 | ⁿDecyl | R² + R³ = —(CH₂)₄— | | 3,5-F₂C₆H₃CH₂— | Cl⁻ | NR¹R²R³ | 74673-26-0 | R⁴X | 220141-71-9 | C₂₁H₃₄NClF₂ | 373.957 | 43.6 |
| 326 | ⁿDecyl | R² + R³ = —(CH₂)₄— | | 4-MeC₆H₄CH₂— | Cl⁻ | NR¹R²R³ | 74673-26-0 | R⁴X | 104-82-5 | C₂₂H₃₈NCl | 352.003 | 45.7 |
| 327 | ⁿDecyl | R² + R³ = —(CH₂)₄— | | 4-EtC₆H₄CH₂— | Cl⁻ | NR¹R²R³ | 74673-26-0 | R⁴X | 1467-05-6 | C₂₃H₄₀NCl | 366.030 | 47.9 |
| 328 | ⁿDecyl | R² + R³ = —(CH₂)₄— | | 4-MeOC₆H₄CH₂— | Cl⁻ | NR¹R²R³ | 74673-26-0 | R⁴X | 824-94-2 | C₂₂H₃₈NOCl | 368.003 | 43.8 |
| 329 | ⁿDecyl | R² + R³ = —(CH₂)₄— | | PhC(O)CH₂— | Cl⁻ | NR¹R²R³ | 74673-26-0 | R⁴X | 532-27-4 | C₂₂H₃₆NOCl | 365.987 | 44.3 |
| 330 | ⁿDecyl | R² + R³ = —(CH₂)₄— | | PhC(O)CH₂— | Br⁻ | NR¹R²R³ | 74673-26-0 | R⁴X | 70-11-1 | C₂₂H₃₆NOBr | 410.438 | 44.3 |
| 331 | ⁿDecyl | R² + R³ = —(CH₂)₄— | | PhC(O)CH₂— | CF₃CO₂⁻ | — | — | — | — | C₂₄H₃₆NO₃F₃ | 443.550 | 44.3 |
| 332 | ⁿDecyl | R² + R³ = —(CH₂)₄— | | 4-FC₆H₄C(O)CH₂— | Cl⁻ | NR¹R²R³ | 74673-26-0 | R⁴X | 456-04-2 | C₂₂H₃₅NOClF | 383.977 | 44.5 |
| 333 | ⁿDecyl | R² + R³ = —(CH₂)₄— | | 4-FC₆H₄C(O)CH₂— | CF₃CO₂⁻ | — | — | — | — | C₂₄H₃₅NO₃F₄ | 461.540 | 44.5 |
| 334 | ⁿDecyl | R² + R³ = —(CH₂)₄— | | Ph(CH₂)₄— | Br⁻ | NR¹R²R³ | 74673-26-0 | R⁴X | 13633-25-5 | C₂₄H₄₂NBr | 424.508 | 47.5 |
| 335 | ⁿDecyl | R² + R³ = —(CH₂)₄— | | Ph(CH₂)₃— | Br⁻ | NR¹R²R³ | 74673-26-0 | R⁴X | 673-59-2 | C₂₃H₄₀NBr | 410.481 | 45.9 |
| 336 | ⁿDecyl | R² + R³ = —(CH₂)₄— | | Ph(CH₂)₂— | Br⁻ | NR²R³R⁴ | 6908-75-4 | R¹X | 112-29-8 | C₂₂H₃₈NBr | 396.454 | 45.3 |
| 337 | ⁿDecyl | R² + R³ = —(CH₂)₄— | | t-PhCH═CHCH₂— | Cl⁻ | NR¹R²R³ | 74673-26-0 | R⁴X | 2687-12-9 | C₂₃H₃₈NCl | 364.008 | 46.4 |
| 338 | ⁿDecyl | R² + R³ = —(CH₂)₄— | | Me₂NC(O)CH₂— | Cl⁻ | NR¹R²R³ | 74673-26-0 | R⁴X | 2675-89-0 | C₁₈H₃₇N₂OCl | 332.957 | 36.8 |
| 339 | ⁿDecyl | R² + R³ = —(CH₂)₄— | | Et₂NC(O)CH₂— | Cl⁻ | NR¹R²R³ | 74673-26-0 | R⁴X | 2315-36-8 | C₂₀H₄₁N₂OCl | 361.011 | 41.5 |
| 339b | 4-FC₆H₄CH₂— | ⁿPropyl | ⁿPropyl | 4-FC₆H₄CH₂— | Cl⁻ | HNR²R³ | 142-84-7 | 2xR⁴X + base | 352-11-4 | C₂₀H₂₆NClF₂ | 353.877 | 30.9 |
| 340 | ⁿButyl | ⁿButyl | ⁿButyl | Ph(CH₂)₄— | Br⁻ | NR¹R²R³ | 102-82-9 | R⁴X | 13633-25-5 | C₂₂H₄₀NBr | 398.470 | 40.2 |
| 341 | ⁿButyl | ⁿButyl | ⁿButyl | 4-PhC₆H₄CH₂— | Cl⁻ | NR¹R²R³ | 102-82-9 | R⁴X | 1667-11-4 | C₂₅H₃₈NCl | 388.036 | 43.3 |
| 342 | Benzyl | ⁿButyl | ⁿButyl | Benzyl | Cl⁻ | HNR²R³ | 111-92-2 | 2xR⁴X + base | 100-44-7 | C₂₂H₃₂NCl | 345.956 | 36.6 |
| 343 | Benzyl | ⁿButyl | ⁿButyl | Benzyl | CF₃CO₂⁻ | — | — | — | — | C₂₄H₃₂NO₂F₃ | 423.519 | 36.6 |
| 344 | 4-FC₆H₄CH₂— | ⁿButyl | ⁿButyl | 4-FC₆H₄CH₂— | Cl⁻ | HNR²R³ | 111-92-2 | 2xR⁴X + base | 352-11-4 | C₂₂H₃₀NClF₂ | 381.936 | 36.8 |
| 345 | 4-FC₆H₄CH₂— | ⁿButyl | ⁿButyl | 4-FC₆H₄CH₂— | CF₃CO₂⁻ | — | — | — | — | C₂₄H₃₀NO₂F₅ | 459.500 | 36.8 |
| 346 | Benzyl | ⁿPentyl | ⁿPentyl | Benzyl | Cl⁻ | HNR²R³ | 2050-92-2 | 2xR⁴X + base | — | C₂₄H₃₆NCl | 374.009 | 41.6 |
| 347 | Benzyl | ⁿPentyl | ⁿPentyl | Benzyl | CF₃CO₂⁻ | — | — | — | — | C₂₆H₃₆NO₂F₃ | 451.573 | 41.6 |
| 348 | 4-FC₆H₄CH₂— | ⁿPentyl | ⁿPentyl | 4-FC₆H₄CH₂— | Cl⁻ | HNR²R³ | 2050-92-2 | 2xR⁴X + base | 352-11-4 | C₂₄H₃₄NClF₂ | 409.990 | 41.8 |
| 349 | 4-FC₆H₄CH₂— | ⁿPentyl | ⁿPentyl | 4-FC₆H₄CH₂— | CF₃CO₂⁻ | — | — | — | — | C₂₆H₃₄NO₂F₅ | 487.554 | 41.8 |
| 350 | Benzyl | ⁿHexyl | ⁿHexyl | Benzyl | Cl⁻ | HNR²R³ | 143-16-8 | 2xR⁴X + base | 100-44-7 | C₂₆H₄₀NCl | 402.063 | 46.6 |
| 351 | Benzyl | ⁿHexyl | ⁿHexyl | Benzyl | CF₃CO₂⁻ | — | — | — | — | C₂₈H₄₀NO₂F₃ | 479.626 | 46.6 |
| 352 | 4-FC₆H₄CH₂— | ⁿHexyl | ⁿHexyl | 4-FC₆H₄CH₂— | Cl⁻ | HNR²R³ | 143-16-8 | 2xR⁴X + base | 352-11-4 | C₂₆H₃₈NClF₂ | 438.044 | 46.8 |
| 353 | 4-FC₆H₄CH₂— | ⁿHexyl | ⁿHexyl | 4-FC₆H₄CH₂— | CF₃CO₂⁻ | — | — | — | — | C₂₈H₃₈NO₂F₅ | 515.607 | 46.8 |
| 354 | ⁿButyl | ⁿButyl | ⁿButyl | Benzyl | Cl⁻ | NR¹R²R³ | 102-82-9 | R⁴X | 100-44-7 | C₁₉H₃₄NCl | 311.938 | 35.4 |
| 355 | ⁿButyl | ⁿButyl | ⁿButyl | Benzyl | CF₃CO₂⁻ | — | — | — | — | C₂₁H₃₄NO₂F₃ | 389.502 | 35.4 |
| 356 | ⁿButyl | ⁿButyl | ⁿButyl | 4-FC₆H₄CH₂— | Cl⁻ | NR¹R²R³ | 102-82-9 | R⁴X | 352-11-4 | C₁₉H₃₃NClF | 329.929 | 35.1 |
| 357 | ⁿButyl | ⁿButyl | ⁿButyl | 4-FC₆H₄CH₂— | CF₃CO₂⁻ | — | — | — | — | C₂₁H₃₃NO₂F₄ | 407.492 | 35.1 |
| 358 | ⁿPentyl | ⁿPentyl | ⁿPentyl | Benzyl | Cl⁻ | NR¹R²R³ | 621-77-2 | R⁴X | 100-44-7 | C₂₂H₄₀NCl | 354.019 | 42.8 |
| 359 | ⁿPentyl | ⁿPentyl | ⁿPentyl | Benzyl | Br⁻ | NR¹R²R³ | 621-77-2 | R⁴X | 100-39-0 | C₂₂H₄₀NBr | 398.470 | 42.8 |
| 360 | ⁿPentyl | ⁿPentyl | ⁿPentyl | Benzyl | CF₃CO₂⁻ | — | — | — | — | C₂₄H₄₀NO₂F₃ | 431.582 | 42.8 |
| 361 | ⁿPentyl | ⁿPentyl | ⁿPentyl | 4-FC₆H₄CH₂— | Cl⁻ | NR¹R²R³ | 621-77-2 | R⁴X | 352-11-4 | C₂₂H₃₉NClF | 372.010 | 43.0 |
| 362 | ⁿPentyl | ⁿPentyl | ⁿPentyl | 4-FC₆H₄CH₂— | Br⁻ | NR¹R²R³ | 621-77-2 | R⁴X | 452-07-3 | C₂₂H₃₉NBrF | 416.461 | 43.0 |
| 363 | ⁿPentyl | ⁿPentyl | ⁿPentyl | 4-FC₆H₄CH₂— | CF₃CO₂⁻ | — | — | — | — | C₂₄H₃₉NO₂F₄ | 449.573 | 43.0 |
| 364 | ⁿPentyl | ⁿPentyl | ⁿPentyl | 4-CF₃C₆H₄CH₂— | Cl⁻ | NR¹R²R³ | 621-77-2 | R⁴X | 939-99-1 | C₂₃H₃₉NClF₃ | 422.017 | 45.0 |
| 365 | ⁿPentyl | ⁿPentyl | ⁿPentyl | PhC(O)CH₂— | Cl⁻ | NR¹R²R³ | 621-77-2 | R⁴X | 532-27-4 | C₂₃H₄₀NOCl | 382.029 | 44.4 |
| 366 | ⁿPentyl | ⁿPentyl | ⁿPentyl | 4-FC₆H₄C(O)CH₂— | Cl⁻ | NR¹R²R³ | 621-77-2 | R⁴X | 456-04-2 | C₂₃H₃₉NOClF | 400.020 | 44.6 |
| 367 | ⁿPentyl | ⁿPentyl | ⁿPentyl | 4-PhC₆H₄C(O)CH₂— | Br⁻ | NR¹R²R³ | 621-77-2 | R⁴X | 135-73-9 | C₂₉H₄₄NOBr | 502.579 | 50.9 |
| 368 | ⁿPentyl | ⁿPentyl | ⁿPentyl | 4-PhC₆H₄CH₂— | Cl⁻ | NR¹R²R³ | 621-77-2 | R⁴X | 1667-11-4 | C₂₈H₄₄NCl | 430.117 | 49.9 |
| 369 | ⁿButyl | ⁿButyl | ⁿButyl | 4-PhC₆H₄CH₂— | Cl⁻ | NR¹R²R³ | 102-82-9 | R⁴X | 1667-11-4 | C₂₅H₃₈NCl | 388.036 | 43.2 |
| 370 | ⁿHexyl | ⁿHexyl | ⁿHexyl | Benzyl | Cl⁻ | NR¹R²R³ | 102-86-3 | R⁴X | 100-44-7 | C₂₅H₄₈NCl | 396.100 | 49.5 |
| 371 | ⁿHexyl | ⁿHexyl | ⁿHexyl | 4-FC₆H₄CH₂— | Cl⁻ | NR¹R²R³ | 102-86-3 | R⁴X | 352-11-4 | C₂₅H₄₅NClF | 414.083 | 49.7 |
| 372 | ⁿHexyl | ⁿHexyl | ⁿHexyl | naphthylene-1-CH₂— | Cl⁻ | NR¹R²R³ | 102-86-3 | R⁴X | 86-52-2 | C₂₉H₄₈NCl | 446.151 | 52.3 |
| 373 | ⁿHexyl | ⁿHexyl | ⁿHexyl | anthracene-9-CH₂— | Cl⁻ | NR¹R²R³ | 102-86-3 | R⁴X | 24463-19-2 | C₃₃H₅₀NCl | 496.219 | 55.4 |
| 374 | ⁿHexyl | ⁿHexyl | ⁿHexyl | 4-FC₆H₄CH₂— | CF₃CO₂⁻ | — | — | — | — | C₂₇H₄₅NO₂F₄ | 491.653 | 50.0 |
| 375 | ⁿHexyl | ⁿHexyl | EtOC₂^{a} | Benzyl | Cl⁻ | NR¹R²R³ | New^{f} | R⁴X | 100-44-7 | C₂₃H₄₂NOCl | 384.045 | 45.4 |
| 376 | ⁿHexyl | ⁿHexyl | MeOC₂OC₂ | Benzyl | Cl⁻ | NR¹R²R³ | New^{e} | R⁴X | 100-44-7 | C₂₄H₄₄NO₂C₁ | 414.072 | 42.4 |
| 377 | ⁿHeptyl | ⁿHeptyl | ⁿHeptyl | Benzyl | CF₃CO₂⁻ | — | 2411-36-1 | — | — | C₃₀H₅₂NO₂F₃ | 515.744 | 55.2 |
| 378 | ⁿHeptyl | ⁿHeptyl | ⁿHeptyl | 4-FC₆H₄CH₂— | Cl⁻ | NR¹R²R³ | 2411-36-1 | R⁴X | 352-11-4 | C₂₈H₅₁NClF | 456.171 | 55.4 |
| 379 | ⁿHeptyl | ⁿHeptyl | ⁿHeptyl | 4-FC₆H₄CH₂— | CF₃CO₂⁻ | — | — | — | — | C₃₀H₅₁NO₂F₄ | 533.734 | 55.4 |
| 380 | ⁿOctyl | ⁿOctyl | ⁿOctyl | Benzyl | Cl⁻ | NR¹R²R³ | 1116-76-3 | — | 100-44-7 | C₃₁H₅₈NCl | 480.261 | 60.3 |
| 381 | ⁿOctyl | ⁿOctyl | ⁿOctyl | Benzyl | CF₃CO₂⁻ | — | — | — | — | C₃₃H₅₈NO₂F₃ | 557.824 | 60.3 |
| 382 | ⁿOctyl | ⁿOctyl | EtOC₂OC₂^{a} | Benzyl | Br⁻ | NR¹R²R³ | New^{b} | R⁴X | 100-39-0 | C₂₉H₅₄NO₂Br | 528.649 | 53.7 |
| 383 | ⁿOctyl | ⁿOctyl | ⁿOctyl | 4-FC₆H₄CH₂— | Cl⁻ | NR¹R²R³ | 1116-76-3 | R⁴X | 352-11-4 | C₃₁H₅₈NClF | 499.250 | 60.5 |
| 384 | ⁿOctyl | ⁿOctyl | ⁿOctyl | 4-FC₆H₄CH₂— | CF₃CO₂⁻ | — | — | — | — | C₃₃H₅₈NO₂F₄ | 576.813 | 60.5 |
| 385 | ⁿPentyl | Methyl | Methyl | Ph(CH₂)₅— | Br⁻ | NR¹R²R³ | 26153-88-8 | R⁴X | 14469-83-1 | C₁₈H₃₂NBr | 342.363 | 34.9 |
| 386 | ⁿPentyl | Methyl | Methyl | Ph(CH₂)₆— | Br⁻ | NR¹R²R³ | 26153-88-8 | R⁴X | 27976-27-8 | C₁₉H₃₄NBr | 356.385 | 37.6 |
| 387 | ⁿHexyl | Methyl | Methyl | Ph(CH₂)₅— | Br⁻ | NR¹R²R³ | 4385-04-0 | R⁴X | 14469-83-1 | C₁₉H₃₄NBr | 356.385 | 37.6 |
| 388 | ⁿHexyl | Methyl | Methyl | Ph(CH₂)₆— | Br⁻ | NR¹R²R³ | 4385-04-0 | R⁴X | 27976-27-8 | C₂₀H₃₆NBr | 370.417 | 40.2 |
| 389 | ⁿHexyl | Methyl | Methyl | Ph(CH₂)₇— | Br⁻ | NR¹R²R³ | 5277-11-2 | R⁴X | 78573-85-0 | C₂₁H₃₈NBr | 384.443 | 42.7 |
| 390 | ⁿHeptyl | Methyl | Methyl | Ph(CH₂)₆— | Br⁻ | NR¹R²R³ | 4385-04-0 | R⁴X | 27976-27-8 | C₂₁H₃₈NBr | 384.443 | 42.7 |
| 391 | ⁿHeptyl | Methyl | Methyl | Ph(CH₂)₇— | Br⁻ | NR¹R²R³ | 5277-11-2 | R⁴X | 78573-85-0 | C₂₂H₄₀NBr | 398.470 | 45.1 |
| 392 | ⁿHeptyl | Methyl | Methyl | Ph(CH₂)₆— | Br⁻ | NR¹R²R³ | 7378-99-6 | R⁴X | 54646-75-2 | C₂₃H₄₂NBr | 412.497 | 47.3 |
| 393 | ⁿOctyl | Methyl | Methyl | Ph(CH₂)₇— | Br⁻ | NR¹R²R³ | 5277-11-2 | R⁴X | 78573-85-0 | C₂₃H₄₂NBr | 412.497 | 47.4 |
| 394 | ⁿOctyl | Methyl | Methyl | Ph(CH₂)₆— | Br⁻ | NR¹R²R³ | 7378-99-6 | R⁴X | 54646-75-2 | C₂₄H₄₄NBr | 426.524 | 49.5 |
| 394b | HOCH₂CH₂— | Ph(CH₂)₃— | Ph(CH₂)₃— | Ph(CH₂)₃— | Br⁻ | H₂NR¹ | 141-43-5 | 3xR⁴X + 2xbase | 637-59-2 | C₂₉H₃₈NOBr | 496.522 | 40.4 |
| 394c | HOCH₂CH₂— | Ph(CH₂)₃— | Ph(CH₂)₃— | Ph(CH₂)₃— | CF₃CO₂⁻ | — | — | — | — | C₃₁H₃₈NO₃F₃ | 529.634 | 40.4 |
| 394d | MeOCH₂CH₂— | Ph(CH₂)₃— | Ph(CH₂)₃— | Ph(CH₂)₃— | Br⁻ | H₂NR¹ | 109-85-3 | 3xR⁴X + 2xbase | 637-59-2 | C₃₀H₄₀NOBr | 510.549 | 43.8 |
| 394e | MeOCH₂CH₂— | Ph(CH₂)₃— | Ph(CH₂)₃— | Ph(CH₂)₃— | CF₃CO₂⁻ | — | — | — | — | C₃₂H₄₀NO₃F₃ | 543.660 | 43.8 |

^{a}Me = CH₃—, Et = C₂H₅, Pr = C₇H₇—, Bu = C₄H₉—, Ph = C₆H₅—, Bz = C₆H₅CH₂—, Ac = CH₃C(O)—, MeOC₂ = CH₃OCH₂CH₂—, EtOC₂ = EtOCH₂CH₂—, MeOC₂OC₂ = Me(OCH₂CH₂)₂—, EtOC₂OC₂ = EtOCH₂CH₂OCH₂CH₂—
^{b}New compound; prepared by method in Example 1 from di-n-octylamine [1120-48-5] and slight excess (1.1X) of 2-(2-ethoxyethoxy)ethyl bromide [54550-36-6] in the presence of excess (1.5X) base (N-ethyl-di-isopropylamine).
^{c}Chemical names and chemical structures associated with abbreviations are given below.
^{d}New compound; prepared pure in good yield by method in Example 1 from 1-bromoheptane [629-04-9] and excess (3X) di-n-propylamine [142-84-7] .
^{e}New compound; prepared by method in Example 1 from di-n-hexylamine [143-16-8] and slight excess (1.1X) of 2-(2-methoxyethoxy)ethyl bromide [54149-17-6] in the presence of excess (1.5X) base (N-ethyl-di-isopropylamine).
^{f}New compound; prepared by method in Example 1 from di-n-hexylamine [143-16-8] and slight excess (1.1X) of 2-ethoxyethyl bromide [592-55-2] in the presence of excess (2.0X) base (N-ethyl-di-isopropylamine). The tertiary amine product is not isolated but allowed to react in a second step with benzyl bromide.
^{g}New compound; prepared by method in Example 1 from bis(2-methoxyethyl)amine [111-95-5] and slight excess (1.1X) of 1-bromodecane [112-28-9] in the presence of excess (1.5X) base (N-ethyl-di-isopropylamine).
^{r}CAS number for racemic amine. Pure enantiomers of N,N-dimethylphenylalanine N,N-dimethylamide are prepared from N,N-dimethylphenylalanine methylester (CAS# l-enantiomer, 27720-05-4; CAS# d-enantiomer, 1268357-63-6) and dimethylamine.
^{s}Limited solubility.
^{t}Undergoes slow transalkylation reactions at elevated temperature.

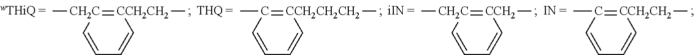

TABLE VI
[(R¹R²R³NCH₂)₂C₆H₃G]²⁺ 2[X]⁻ (G = H, F) and
[R¹R²R³NCH₂C₆H₄—C₆H₄CH₂NR¹R²R³]²⁺ 2[X]⁻

| Nu. | R¹ | R² | R³ | C₆H₃G or C₆H₄—C₆H₄ | X⁻ | Amine |
|---|---|---|---|---|---|---|
| 395 | ⁿUndecyl | Methyl | Methyl | 1,2-C₆H₄ | Cl⁻ | 2xNR¹R²R³ |
| 396 | ⁿUndecyl | Methyl | Methyl | 1,2-C₆H₄ | Br⁻ | 2xNR¹R²R³ |
| 397 | ⁿUndecyl | Methyl | Methyl | 1,2-C₆H₄ | CF₃CO₂⁻ | — |
| 398 | ⁿUndecyl | Methyl | Methyl | 1,3-C₆H₄ | Cl⁻ | 2xNR¹R²R³ |
| 399 | ⁿUndecyl | Methyl | Methyl | 1,3-C₆H₄ | Br⁻ | 2xNR¹R²R³ |
| 400 | ⁿUndecyl | Methyl | Methyl | 1,3-C₆H₄ | CF₃CO₂⁻ | — |
| 401 | ⁿUndecyl | Methyl | Methyl | 1,4-C₆H₄ | Cl⁻ | 2xNR¹R²R³ |
| 402 | ⁿUndecyl | Methyl | Methyl | 1,4-C₆H₄ | Br⁻ | 2xNR¹R²R³ |
| 403 | ⁿUndecyl | Methyl | Methyl | 1,4-C₆H₄ | CF₃CO₂⁻ | — |
| 404 | ⁿDecyl | Methyl | Methyl | 1,2-C₆H₄ | Cl⁻ | 2xNR¹R²R³ |
| 405 | ⁿDecyl | Methyl | Methyl | 1,2-C₆H₄ | Br⁻ | 2xNR¹R²R³ |
| 406 | ⁿDecyl | Methyl | Methyl | 1,2-C₆H₄ | CF₃CO₂⁻ | — |
| 407 | ⁿDecyl | Methyl | Methyl | 1,3-C₆H₄ | Cl⁻ | 2xNR¹R²R³ |
| 408 | ⁿDecyl | Methyl | Methyl | 1,3-C₆H₄ | Br⁻ | 2xNR¹R²R³ |
| 409 | ⁿDecyl | Methyl | Methyl | 1,3-C₆H₄ | CF₃CO₂⁻ | — |
| 410 | ⁿDecyl | Methyl | Methyl | 2-F-1,3-C₆H₃ | Br⁻ | 2xNR¹R²R³ |
| 411 | ⁿDecyl | Methyl | Methyl | 2-F-1,3-C₆H₃ | CF₃CO₂⁻ | — |
| 412 | ⁿDecyl | Methyl | Methyl | 5-F-1,3-C₆H₃ | Br⁻ | 2xNR¹R²R³ |
| 413 | ⁿDecyl | Methyl | Methyl | 5-F-1,3-C₆H₃ | CF₃CO₂⁻ | — |
| 414 | ⁿDecyl | Methyl | Methyl | 1,4-C₆H₄ | Cl⁻ | 2xNR¹R²R³ |
| 415 | ⁿDecyl | Methyl | Methyl | 1,4-C₆H₄ | Br⁻ | 2xNR¹R²R³ |
| 416 | ⁿDecyl | Methyl | Methyl | 1,4-C₆H₄ | CF₃CO₂⁻ | — |
| 417 | ⁿDecyl | R² + R³ = —(CH₂)₄— | | 1,2-C₆H₄ | Cl⁻ | 2xNR¹R²R³ |
| 418 | ⁿDecyl | R² + R³ = —(CH₂)₄— | | 1,3-C₆H₄ | Cl⁻ | 2xNR¹R²R³ |
| 419 | ⁿDecyl | R² + R³ = —(CH₂)₄— | | 1,3-C₆H₄ | Br⁻ | 2xNR¹R²R³ |
| 420 | ⁿDecyl | R² + R³ = —(CH₂)₄— | | 1,3-C₆H₄ | CF₃CO₂⁻ | — |
| 421 | ⁿDecyl | R² + R³ = —(CH₂)₄— | | 2-F-1,3-C₆H₃ | Br⁻ | 2xNR¹R²R³ |
| 422 | ⁿDecyl | R² + R³ = —(CH₂)₄— | | 2-F-1,3-C₆H₃ | CF₃CO₂⁻ | — |
| 423 | ⁿDecyl | R² + R³ = —(CH₂)₄— | | 5-F-1,3-C₆H₃ | Br⁻ | 2xNR¹R²R³ |
| 424 | ⁿDecyl | R² + R³ = —(CH₂)₄— | | 5-F-1,3-C₆H₃ | CF₃CO₂⁻ | — |
| 425 | ⁿDecyl | R² + R³ = —(CH₂)₄— | | 1,4-C₆H₄ | Cl⁻ | 2xNR¹R²R³ |
| 426 | ⁿNonyl | Methyl | Methyl | 1,2-C₆H₄ | Cl⁻ | 2xNR¹R²R³ |
| 427 | ⁿNonyl | Methyl | Methyl | 1,2-C₆H₄ | Br⁻ | 2xNR¹R²R³ |
| 428 | ⁿNonyl | Methyl | Methyl | 1,2-C₆H₄ | CF₃CO₂⁻ | — |
| 429 | ⁿNonyl | Methyl | Methyl | 1,3-C₆H₄ | Cl⁻ | 2xNR¹R²R³ |
| 430 | ⁿNonyl | Methyl | Methyl | 1,3-C₆H₄ | Br⁻ | 2xNR¹R²R³ |
| 431 | ⁿNonyl | Methyl | Methyl | 1,3-C₆H₄ | CF₃CO₂⁻ | — |
| 432 | ⁿNonyl | Methyl | Methyl | 5-F-1,3-C₆H₃ | Br⁻ | 2xNR¹R²R³ |
| 433 | ⁿNonyl | Methyl | Methyl | 5-F-1,3-C₆H₃ | CF₃CO₂⁻ | — |
| 434 | ⁿNonyl | R² + R³ = —(CH₂)₄— | | 1,3-C₆H₄ | Cl⁻ | 2xNR¹R²R³ |
| 435 | ⁿNonyl | R² + R³ = —(CH₂)₄— | | 1,3-C₆H₄ | Br⁻ | 2xNR¹R²R³ |
| 436 | ⁿNonyl | R² + R³ = —(CH₂)₄— | | 1,3-C₆H₄ | CF₃CO₂⁻ | — |
| 437 | ⁿNonyl | R² + R³ = —(CH₂)₄— | | 2-F-1,3-C₆H₃ | Br⁻ | 2xNR¹R²R³ |
| 438 | ⁿNonyl | R² + R³ = —(CH₂)₄— | | 2-F-1,3-C₆H₃ | CF₃CO₂⁻ | — |
| 439 | ⁿNonyl | R² + R³ = —(CH₂)₄— | | 5-F-1,3-C₆H₃ | Br⁻ | 2xNR¹R²R³ |
| 440 | ⁿNonyl | R² + R³ = —(CH₂)₄— | | 5-F-1,3-C₆H₃ | CF₃CO₂⁻ | — |
| 441 | ⁿNonyl | Methyl | Methyl | 1,4-C₆H₄ | Cl⁻ | 2xNR¹R²R³ |
| 442 | ⁿNonyl | Methyl | Methyl | 1,4-C₆H₄ | Br⁻ | 2xNR¹R²R³ |
| 443 | ⁿNonyl | Methyl | Methyl | 1,4-C₆H₄ | CF₃CO₂⁻ | — |
| 444 | ⁿOctyl | Methyl | Methyl | 1,2-C₆H₄ | Cl⁻ | 2xNR¹R²R³ |
| 445 | ⁿOctyl | Methyl | Methyl | 1,2-C₆H₄ | Br⁻ | 2xNR¹R²R³ |
| 446 | ⁿOctyl | Methyl | Methyl | 1,2-C₆H₄ | CF₃CO₂⁻ | — |
| 447 | ⁿOctyl | Methyl | Methyl | 1,3-C₆H₄ | Cl⁻ | 2xNR¹R²R³ |
| 448 | ⁿOctyl | Methyl | Methyl | 1,3-C₆H₄ | Br⁻ | 2xNR¹R²R³ |
| 449 | ⁿOctyl | Methyl | Methyl | 1,3-C₆H₄ | CF₃CO₂⁻ | — |
| 450 | ⁿOctyl | Methyl | Methyl | 1,4-C₆H₄ | Cl⁻ | 2xNR¹R²R³ |
| 451 | ⁿOctyl | Methyl | Methyl | 1,4-C₆H₄ | Br⁻ | 2xNR¹R²R³ |
| 452 | ⁿOctyl | Methyl | Methyl | 1,4-C₆H₄ | CF₃CO₂⁻ | — |
| 453 | ⁿHexyl | ⁿHexyl | Methyl | 1,3-C₆H₄ | Cl⁻ | 2xNR¹R²R³ |
| 454 | ⁿHexyl | ⁿHexyl | Methyl | 1,3-C₆H₄ | Br⁻ | 2xNR¹R²R³ |
| 455 | ⁿPentyl | ⁿPentyl | ⁿPentyl | 1,2-C₆H₄ | Br⁻ | 2xNR¹R²R³ |
| 456 | ⁿPentyl | ⁿPentyl | ⁿPentyl | 1,3-C₆H₄ | Br⁻ | 2xNR¹R²R³ |
| 457 | ⁿPentyl | ⁿPentyl | ⁿPentyl | 1,3-C₆H₄ | CF₃CO₂⁻ | — |
| 458 | ⁿPentyl | ⁿPentyl | ⁿPentyl | 1,4-C₆H₄ | Br⁻ | 2xNR¹R²R³ |
| 459 | ⁿButyl | ⁿButyl | ⁿButyl | 1,3-C₆H₄ | Br⁻ | 2xNR¹R²R³ |
| 460 | ⁿButyl | ⁿButyl | ⁿButyl | 1,3-C₆H₄ | CF₃CO₂⁻ | — |
| 461 | ⁿNonyl | Methyl | Methyl | 4,4′-C₆H₄—C₆H₄ | Br⁻ | 2xNR¹R²R³ |
| 462 | ⁿNonyl | Methyl | Methyl | 3,3′-C₆H₄—C₆H₄ | Br⁻ | 2xNR¹R²R³ |
| 463 | ⁿNonyl | Methyl | Methyl | 2,2′-C₆H₄—C₆H₄ | Br⁻ | 2xNR¹R²R³ |

| | | Alkyating | | | HPLC Method 9a | |
|---|---|---|---|---|---|---|
| Nu. | CAS Num. | Agent | CAS Num. | Formula | Weight | Time |
| 395 | 17373-28-3 | o-(XCH₂)₂C₆H₄ | 612-12-4 | C₃₄H₆₆N₂Cl₂ | 573.817 | 48.6 |
| 396 | 17373-28-3 | o-(XCH₂)₂C₆H₄ | 91-13-4 | C₃₄H₆₆N₂Br₂ | 662.720 | 48.6 |
| 397 | — | — | — | C₃₈H₆₆N₂O₄F₆ | 728.944 | 48.6 |
| 398 | 17373-28-3 | m-(XCH₂)₂C₆H₄ | 626-16-4 | C₃₄H₆₆N₂Cl₂ | 573.817 | 47.3 |
| 399 | 17373-28-3 | m-(XCH₂)₂C₆H₄ | 626-15-3 | C₃₄H₆₆N₂Br₂ | 662.720 | 47.3 |
| 400 | — | — | — | C₃₈H₆₆N₂O₄F₆ | 728.944 | 47.3 |
| 401 | 17373-28-3 | p-(XCH₂)₂C₆H₄ | 623-25-6 | C₃₄H₆₆N₂Cl₂ | 573.817 | 46.7 |
| 402 | 17373-28-3 | p-(XCH₂)₂C₆H₄ | 623-24-5 | C₃₄H₆₆N₂Br₂ | 662.720 | 46.7 |
| 403 | — | — | — | C₃₈H₆₆N₂O₄F₆ | 728.944 | 46.7 |
| 404 | 1120-24-7 | o-(XCH₂)₂C₆H₄ | 612-12-4 | C₃₂H₆₂N₂Cl₂ | 545.763 | 44.4 |
| 405 | 1120-24-7 | o-(XCH₂)₂C₆H₄ | 91-13-4 | C₃₂H₆₂N₂Br₂ | 634.666 | 44.4 |
| 406 | — | — | — | C₃₆H₆₂N₂O₄F₆ | 700.890 | 44.4 |
| 407 | 1120-24-7 | m-(XCH₂)₂C₆H₄ | 626-16-4 | C₃₂H₆₂N₂Cl₂ | 545.763 | 43.4 |
| 408 | 1120-24-7 | m-(XCH₂)₂C₆H₄ | 626-15-3 | C₃₂H₆₂N₂Br₂ | 634.666 | 43.5 |
| 409 | — | — | — | C₃₆H₆₂N₂O₄F₆ | 700.890 | 43.4 |
| 410 | 1120-24-7 | 2-F-1,3-(XCH₂)₂C₆H₃ | 25006-86-4 | C₃₂H₆₁N₂Br₂F | 652.656 | 43.5 |
| 411 | — | — | — | C₃₆H₆₁N₂O₄F₇ | 718.880 | 43.5 |
| 412 | 1120-24-7 | 5-F-1,3-(XCH₂)₂C₆H₃ | 19252-80-9 | C₃₂H₆₁N₂Br₂F | 652.656 | 43.6 |
| 413 | — | — | — | C₃₆H₆₁N₂O₄F₇ | 718.880 | 43.6 |
| 414 | 1120-24-7 | p-(XCH₂)₂C₆H₄ | 623-25-6 | C₃₂H₆₂N₂Cl₂ | 545.763 | 42.9 |
| 415 | 1120-24-7 | p-(XCH₂)₂C₆H₄ | 626-15-3 | C₃₂H₆₂N₂Br₂ | 634.666 | 42.9 |
| 416 | — | — | — | C₃₆H₆₂N₂O₄F₆ | 700.890 | 42.9 |
| 417 | 74673-26-0 | p-(XCH₂)₂C₆H₄ | 612-12-4 | C₃₆H₆₆N₂Cl₂ | 597.839 | 45.9 |
| 418 | 74673-26-0 | p-(XCH₂)₂C₆H₄ | 626-16-4 | C₃₆H₆₆N₂Cl₂ | 597.839 | 44.9 |
| 419 | 74673-26-0 | p-(XCH₂)₂C₆H₄ | 626-15-3 | C₃₆H₆₆N₂Br₂ | 686.742 | 44.9 |
| 420 | — | — | — | C₄₀H₆₆N₂O₄F₆ | 752.966 | 44.9 |
| 421 | 74673-26-0 | 2-F-1,3-(XCH₂)₂C₆H₃ | 25006-86-4 | C₃₆H₆₅N₂Br₂F | 704.732 | 45.0 |
| 422 | — | — | — | C₄₀H₆₅N₂O₄F₇ | 770.956 | 45.0 |
| 423 | 74673-26-0 | 5-F-1,3-(XCH₂)₂C₆H₃ | 19252-80-9 | C₃₆H₆₅N₂Br₂F | 704.732 | 45.1 |
| 424 | — | — | — | C₄₀H₆₅N₂O₄F₇ | 770.956 | 45.1 |
| 425 | 74673-26-0 | p-(XCH₂)₂C₆H₄ | 623-25-6 | C₃₆H₆₆N₂Cl₂ | 597.839 | 44.4 |
| 426 | 17373-27-2 | o-(XCH₂)₂C₆H₄ | 612-12-4 | C₃₀H₅₈N₂Cl₂ | 517.709 | 40.1 |
| 427 | 17373-27-2 | o-(XCH₂)₂C₆H₄ | 91-13-4 | C₃₀H₅₈N₂Br₂ | 606.612 | 40.1 |
| 428 | — | — | — | C₃₄H₅₈N₂O₄F₆ | 672.836 | 40.1 |
| 429 | 17373-27-2 | m-(XCH₂)₂C₆H₄ | 626-16-4 | C₃₀H₅₈N₂Cl₂ | 517.709 | 39.3 |
| 430 | 17373-27-2 | m-(XCH₂)₂C₆H₄ | 626-15-3 | C₃₀H₅₈N₂Br₂ | 606.612 | 39.2 |
| 431 | — | — | — | C₃₄H₅₈N₂O₄F₆ | 672.836 | 39.3 |
| 432 | 17373-27-2 | 5-F-1,3-(XCH₂)₂C₆H₃ | 19252-80-9 | C₃₂H₅₇N₂Br₂F | 624.602 | 39.5 |
| 433 | — | — | — | C₃₆H₅₇N₂O₄F₇ | 714.838 | 39.5 |
| 434 | 74673-25-9 | p-(XCH₂)₂C₆H₄ | 626-16-4 | C₃₄H₆₂N₂Cl₂ | 569.785 | 40.8 |
| 435 | 74673-25-9 | p-(XCH₂)₂C₆H₄ | 626-15-3 | C₃₄H₆₂N₂Br₂ | 658.688 | 40.8 |
| 436 | — | — | — | C₃₈H₆₂N₂O₄F₆ | 724.912 | 40.8 |
| 437 | 74673-25-9 | 2-F-1,3-(XCH₂)₂C₆H₃ | 25006-86-4 | C₃₄H₆₁N₂Br₂F | 676.678 | 40.9 |
| 438 | — | — | — | C₃₈H₆₁N₂O₄F₇ | 742.902 | 40.9 |
| 439 | 74673-25-9 | 5-F-1,3-(XCH₂)₂C₆H₃ | 19252-80-9 | C₃₄H₆₁N₂Br₂F | 676.678 | 41.0 |
| 440 | — | — | — | C₃₈H₆₁N₂O₄F₇ | 742.902 | 41.0 |
| 441 | 17373-27-2 | p-(XCH₂)₂C₆H₄ | 623-25-6 | C₃₀H₅₈N₂Cl₂ | 517.709 | 39.0 |
| 442 | 17373-27-2 | p-(XCH₂)₂C₆H₄ | 624-24-5 | C₃₀H₅₈N₂Br₂ | 606.612 | 39.0 |
| 443 | — | — | — | C₃₄H₅₈N₂O₄F₆ | 672.836 | 39.0 |
| 444 | 7378-99-6 | o-(XCH₂)₂C₆H₄ | 612-12-4 | C₂₈H5₄N₂Cl₂ | 489.656 | 35.8 |
| 445 | 7378-99-6 | o-(XCH₂)₂C₆H₄ | 91-13-4 | C₂₈H₅₄N₂Br₂ | 578.558 | 35.8 |
| 446 | — | — | — | C₃₂H₅₄N₂O₄F₆ | 644.782 | 35.8 |
| 447 | 7378-99-6 | m-(XCH₂)₂C₆H₄ | 626-16-4 | C₂₈H₅₄N₂Cl₂ | 489.656 | 35.3 |
| 448 | 7378-99-6 | m-(XCH₂)₂C₆H₄ | 626-15-3 | C₂₈H₅₄N₂Br₂ | 578.558 | 35.3 |
| 449 | — | — | — | C₃₂H₅₄N₂O₄F₆ | 644.782 | 35.3 |
| 450 | 7378-99-6 | p-(XCH₂)₂C₆H₄ | 623-25-6 | C₂₈H₅₄N₂Cl₂ | 489.656 | 35.1 |
| 451 | 7378-99-6 | p-(XCH₂)₂C₆H₄ | 624-24-5 | C₂₈H₅₄N₂Br₂ | 578.558 | 35.1 |
| 452 | — | — | — | C₃₂H₅₄N₂O₄F₆ | 644.782 | 35.1 |
| 453 | 37615 | m-(XCH₂)₂C₆H₄ | 626-16-4 | C₃₄H₆₆N₂Cl₂ | 573.817 | 40.0 |
| 454 | 37615 | m-(XCH₂)₂C₆H₄ | 626-15-3 | C₃₄H₆₆N₂Br₂ | 662.720 | 40.0 |
| 455 | 621-77-2 | o-(XCH₂)₂C₆H₄ | 91-13-4 | C₃₈H₇₄N₂Br₂ | 718.827 | 42.3 |
| 456 | 621-77-2 | o-(XCH₂)₂C₆H₄ | 626-15-3 | C₃₈H₇₄N₂Br₂ | 718.827 | 42.6 |
| 457 | — | — | — | C₄₂H₇₄N₂O₄F₆ | 785.051 | 42.6 |
| 458 | 621-77-2 | o-(XCH₂)₂C₆H₄ | 624-24-5 | C₃₈H₇₄N₂Br₂ | 718.827 | 42.2 |
| 459 | 102-82-9 | o-(XCH₂)₂C₆H₄ | 626-15-3 | C₃₂H₆₂N₂Br₂ | 634.666 | 32.7 |
| 460 | — | — | — | C₃₆H₆₂N₂O₄F₆ | 700.879 | 32.7 |
| 461 | 17373-27-2 | 4,4′-(XCH₂C₆H₄)₂ | 20248-86-6 | C₃₆H₆₂N₂Br₂ | 682.713 | 42.7 |
| 462 | 17373-27-2 | 3,3′-(XCH₂C₆H₄)₂ | 24656-53-9 | C₃₆H₆₂N₂Br₂ | 682.713 | 43.0 |
| 463 | 17373-27-2 | 2,2′-(XCH₂C₆H₄)₂ | 38274-15-5 | C₃₆H₆₂N₂Br₂ | 682.713 | 42.4 |

TABLE VII
[R¹R²R³R⁴P]⁺[X]⁻ and [R¹R²R³S]⁺[X]⁻ and [R¹R²R³S═O]⁺[X]⁻

| Nu. | Salt Type | R¹ | R² | R³ | R⁴ | X⁻ | Phosphine |
|---|---|---|---|---|---|---|---|
| 464 | Phosphonium | ⁿPentyl | ⁿPentyl | Phenyl | Methyl | Cl⁻ | PR²R²R³ |
| 465 | Phosphonium | ⁿPentyl | ⁿPentyl | Phenyl | Methyl | CF₃CO₂⁻ | — |
| 466 | Phosphonium | ⁿHexyl | ⁿHexyl | Phenyl | Methyl | Cl⁻ | PR¹R²R³ |
| 467 | Phosphonium | ⁿHexyl | ⁿHexyl | Phenyl | Methyl | CF₃CO₂⁻ | — |
| 468 | Phosphonium | ⁿHeptyl | ⁿHeptyl | Phenyl | Methyl | Cl⁻ | PR¹R²R³ |
| 469 | Phosphonium | ⁿHeptyl | ⁿHeptyl | Phenyl | Methyl | CF₃CO₂⁻ | — |
| 470 | Phosphonium | ⁿOctyl | ⁿOctyl | Phenyl | Methyl | Cl⁻ | PR¹R²R³ |
| 471 | Phosphonium | ⁿNonyl | Methyl | Phenyl | Methyl | Cl⁻ | PR²R³R⁴ |
| 472 | Phosphonium | ⁿNonyl | Methyl | Phenyl | Methyl | CF₃CO₂⁻ | — |
| 473 | Phosphonium | ⁿNonyl | Methyl | 4-FC₆H₄— | Methyl | Cl⁻ | PR²R³R⁴ |
| 474 | Phosphonium | ⁿNonyl | Methyl | 4-FC₆H₄— | Methyl | CF₃CO₂⁻ | — |
| 475 | Phosphonium | ⁿDecyl | Methyl | Phenyl | Methyl | Cl⁻ | PR²R³R⁴ |
| 476 | Phosphonium | ⁿDecyl | Methyl | Phenyl | Methyl | CF₃CO₂⁻ | — |
| 477 | Phosphonium | ⁿDecyl | Methyl | 4-FC₆H₄— | Methyl | Cl⁻ | PR²R³R⁴ |
| 478 | Phosphonium | ⁿDecyl | Methyl | 4-FC₆H₄— | Methyl | CF₃CO₂⁻ | — |
| 479 | Phosphonium | ⁿUndecyl | Methyl | Phenyl | Methyl | Cl⁻ | PR²R³R⁴ |
| 480 | Phosphonium | ⁿUndecyl | Methyl | Phenyl | Methyl | CF₃CO₂⁻ | — |
| 481 | Phosphonium | ⁿUndecyl | Methyl | 4-FC₆H₄— | Methyl | Cl⁻ | PR²R³R⁴ |
| 482 | Phosphonium | ⁿUndecyl | Methyl | 4-FC₆H₄— | Methyl | CF₃CO₂⁻ | — |
| 483 | Sulfonium | Ph(CH₂)₁₀— | Methyl | Methyl | — | Br⁻ | SR²R³ |
| 484 | Sulfonium | ⁿDecyl | 4-FC₆H₄CH₂— | Methyl | — | Br⁻ | SR¹R³ |
| 485 | Sulfonium | ⁿDecyl | 4-FC₆H₄— | Methyl | — | Br⁻ | SR¹R² |
| 486 | Sulfonium | ⁿDecyl | 4-FC₆H₄— | Methyl | — | CF₃CO₂⁻ | — |
| 487 | Sulfonium | Q ^{a} | Methyl | Methyl | — | Br⁻ | SR²R³ |
| 488 | Sulfoxonium | ⁿDecyl | 4-FC₆H₄CH₂— | Methyl | — | Br⁻ | O═SR¹R³ |
| 489 | Sulfoxonium | Q ^{a} | Methyl | Methyl | — | Br⁻ | O═SR²R³ |

| | | Alkylating | | | HPLC Method 9a | |
|---|---|---|---|---|---|---|
| Nu. | CAS Num. | Agent | CAS Num. | Formula | Weight | Time |
| 464 | 71501-08-1 | R⁴X | 74-87-3 | C₁₇H₃₀PCl | 300.852 | 32.7 |
| 465 | — | — | — | C₁₉H₃₀O₂F₃P | 378.415 | 32.7 |
| 466 | 18297-98-8 | R⁴X | 74-87-3 | C₁₉H₃₄PCl | 328.905 | 37.9 |
| 467 | — | — | — | C₂₁H₃₄O₂F₃P | 406.469 | 37.6 |
| 468 | 109706-36-7 | R⁴X | 74-87-3 | C₂₁H₃₈PCl | 356.959 | 42.9 |
| 469 | — | — | — | C₂₃H₃₈O₂F₃P | 434.522 | 42.9 |
| 470 | 14086-46-5 | R⁴X | 74-87-3 | C₂₃H₄₂PCl | 385.013 | 47.7 |
| 471 | 672-66-2 | R¹X | 2473-01-0 | C₁₇H₃₀PCl | 300.852 | 36.0 |
| 472 | — | — | — | C₁₉H₃₀O₂F₃P | 378.415 | 36.0 |
| 473 | 7217-34-7 | R¹X | 2473-01-0 | C₁₇H₂₉FPCl | 318.842 | 36.2 |
| 474 | — | — | — | C₁₉H₂₉O₂F₄P | 396.405 | 36.2 |
| 475 | 672-66-2 | R¹X | 1002-69-3 | C₁₈H₃₂PCl | 314.879 | 39.1 |
| 476 | — | — | — | C₂₀H₃₂O₂F₃P | 392.442 | 39.1 |
| 477 | 7217-34-7 | R¹X | 1002-69-3 | C₁₈H₃₁FPCl | 332.869 | 39.3 |
| 478 | — | — | — | C₂₀H₃₁O₂F₄P | 410.432 | 39.3 |
| 479 | 672-66-2 | R¹X | 2473-03-2 | C₁₉H₃₄PCl | 328.905 | 42.2 |
| 480 | — | — | — | C₂₁H₃₄O₂F₃P | 406.469 | 42.2 |
| 481 | 7217-34-7 | R¹X | 2473-03-2 | C₁₉H₃₃FPCl | 346.896 | 42.4 |
| 482 | — | — | — | C₂₁H₃₃O₂F₄P | 424.459 | 42.4 |
| 483 | 75-18-3 | R¹X | 7757-83-7 | C₁₈H₃₁SBr | 359.416 | 40.3 |
| 484 | 22438-39-2 | R²X | 459-46-1 | C₁₈H₃₀FSBr | 377.406 | 40.6 |
| 485 | 61671-40-7 | R³X | 74-83-9 | C₁₇H₂₈FSBr | 363.379 | 38.5 |
| 486 | — | — | — | C₁₉H₂₈O₂F₄S | 396.492 | 38.5 |
| 487 | 75-18-3 | R¹X | 80563-37-7 | C₂₀H₂₇SBr | 379.406 | 34.9 |
| 488 | 3079-28-5 | R²X | 459-46-1 | C₁₈H₃₀OFSBr | 393.406 | 39.5 |
| 489 | 67-68-5 | R¹X | 80563-37-7 | C₂₀H₂₇OSBr | 395.406 | 33.8 |

^{a} Q = 4,4′-CH₃(CH₂)₄C₆H₄—C₆H₄CH₂—

TABLE VIII
[N—R¹Z]⁺ [X]⁻ and [N,N′—R¹Z~Z′R¹]²⁺ 2[X]⁻

| Nu. | Z or Z~Z′ | R¹ | CAS# known product | X⁻ | N-Base | CAS Num. |
|---|---|---|---|---|---|---|
| 490 | 4-Picolinium | ⁿUndecyl | New | Br⁻ | 4-picoline | 108-89-4 |
| 491 | 4-Picolinium | ⁿUndecyl | New | CF₃CO₂⁻ | — | — |
| 492 | 4-Picolinium | ⁿDecyl | [70850-62-3] | Br⁻ | 4-picoline | 108-89-4 |
| 493 | 4-Picolinium | ⁿDecyl | New | CF₃CO₂⁻ | — | — |
| 494 | 4-Picolinium | ⁿNonyl | New | Br⁻ | 4-picoline | 108-89-4 |
| 495 | 4-Picolinium | ⁿNonyl | New | CF₃CO₂⁻ | — | — |
| 496 | Quinolinium | ⁿUndecyl | | Br⁻ | 4-picoline | 91-22-5 |
| 497 | Quinolinium | ⁿUndecyl | | CF₃CO₂⁻ | — | — |
| 498 | Quinolinium | ⁿDecyl | [15001-43-1] | Br⁻ | quinoline | 91-22-5 |
| 499 | Quinolinium | ⁿDecyl | New | CF₃CO₂⁻ | — | — |
| 500 | Quinolinium | ⁿNonyl | New | Br⁻ | quinoline | 91-22-5 |
| 501 | Quinolinium | ⁿNonyl | New | CF₃CO₂⁻ | — | — |
| 502 | Quinolinium | ⁿOctyl | | Br⁻ | quinoline | 91-22-5 |
| 503 | Quinolinium | ⁿOctyl | | CF₃CO₂⁻ | — | — |
| 504 | Isoquinolinium | ⁿUndecyl | | Br⁻ | isoquinoline | 119-65-3 |
| 505 | Isoquinolinium | ⁿUndecyl | | CF₃CO₂⁻ | — | — |
| 506 | Isoquinolinium | ⁿDecyl | [51808-86-7] | Br⁻ | isoquinoline | 119-65-3 |
| 507 | Isoquinolinium | ⁿDecyl | New | CF₃CO₂⁻ | — | — |
| 508 | Isoquinolinium | ⁿNonyl | New | Br⁻ | isoquinoline | 119-65-3 |
| 509 | Isoquinolinium | ⁿNonyl | New | CF₃CO₂⁻ | — | — |
| 510 | Isoquinolinium | ⁿOctyl | | Br⁻ | isoquinoline | 119-65-3 |
| 511 | Isoquinolinium | ⁿOctyl | | CF₃CO₂⁻ | — | — |
| 512 | 1,2-Me₂imidazolium | ⁿUndecyl | | Br⁻ | DMIm^{c} | 1739-84-0 |
| 513 | 1,2-Me₂imidazolium | ⁿUndecyl | | CF₃CO₂⁻ | — | — |
| 514 | 1,2-Me₂imidazolium | ⁿDecyl | | Br⁻ | DMIm^{c} | 1739-84-0 |
| 515 | 1,2-Me₂imidazolium | ⁿDecyl | | CF₃CO₂⁻ | — | — |
| 516 | 1,2-Me₂imidazolium | ⁿNonyl | | Br⁻ | DMIm^{c} | 1739-84-0 |
| 517 | 1,2-Me₂imidazolium | ⁿNonyl | | CF₃CO₂⁻ | — | — |
| 518 | 1,2-Me₂-benzimidazolium | ⁿUndecyl | | Br⁻ | DMBIm^{c} | 2876-08-6 |
| 519 | 1,2-Me₂-benzimidazolium | ⁿUndecyl | | CF₃CO₂⁻ | — | — |
| 520 | 1,2-Me₂-benzimidazolium | ⁿDecyl | | Br⁻ | DMBIm^{c} | 2876-08-6 |
| 521 | 1,2-Me₂-benzimidazolium | ⁿDecyl | | CF₃CO₂⁻ | — | — |
| 522 | 1,2-Me₂-benzimidazolium | ⁿNonyl | | Br⁻ | DMBIm^{c} | 2876-08-6 |
| 523 | 1,2-Me₂-benzimidazolium | ⁿNonyl | | CF₃CO₂⁻ | — | — |
| 524 | 1,2-Me₂-benzimidazolium | ⁿOctyl | | Br⁻ | DMBIm^{c} | 2876-08-6 |
| 525 | 1,2-Me₂-benzimidazolium | ⁿOctyl | | CF₃CO₂⁻ | — | — |
| 526 | 1-R¹-2-Me-imidazolium | ⁿOctyl | | Br⁻ | MIm^{c} | 693-98-1 |
| 527 | 1-R¹-2-Me-imidazolium | ⁿOctyl | | CF₃CO₂⁻ | — | — |
| 528 | 1-R¹-2-Me-imidazolium | ⁿHeptyl | | Br⁻ | MIm^{c} | 693-98-1 |
| 529 | 1-R¹-2-Me-imidazolium | ⁿHeptyl | | CF₃CO₂⁻ | — | — |
| 530 | 1-R¹-2-Me-imidazolium | ⁿHexyl | | Br⁻ | MIm^{c} | 693-98-1 |
| 531 | 1-R¹-2-Me-imidazolium | ⁿHexyl | | CF₃CO₂⁻ | — | — |
| 532 | 1-R¹-2-Ph-imidazolium | ⁿOctyl | | Br⁻ | PIm^{c} | 670-96-2 |
| 533 | 1-R¹-2-Ph-imidazolium | ⁿHeptyl | | Br⁻ | PIm^{c} | 670-96-2 |
| 534 | 1-R¹-2-Ph-imidazolium | ⁿHexyl | | Br⁻ | PIm^{c} | 670-96-2 |
| 535 | 1-R¹-2-Ph-imidazolium | ⁿPentyl | | Br⁻ | PIm^{c} | 670-96-2 |
| 536 | 1-R¹-2-Me-benzimidazolium | ⁿOctyl | | Br⁻ | MBIm^{c} | 615-15-6 |
| 537 | 1-R¹-2-Me-benzimidazolium | ⁿHeptyl | | Br⁻ | MBIm^{c} | 615-15-6 |
| 537b | 1-R¹-2-Me-benzimidazolium | Ph(CH₂)₃— | | Br⁻ | MBIm^{c} | 615-15-6 |
| 537c | 1-R¹-2-Me-benzimidazolium | Ph(CH₂)₃— | | CF₃CO₂⁻ | — | — |
| 538 | 1-R¹-2-Me-benzimidazolium | ⁿHexyl | | Br⁻ | MBIm^{c} | 615-15-6 |
| 539 | 1-R¹-2-Me-benzimidazolium | ⁿPentyl | | Br⁻ | MBIm^{c} | 615-15-6 |
| 540 | 1-R¹-2-Me-imidazolinium | ⁿOctyl | | Br⁻ | MImN^{c} | 534-26-9 |
| 541 | 1-R¹-2-Me-imidazolinium | ⁿOctyl | | CF₃CO₂⁻ | — | — |
| 542 | 1-R¹-2-Me-imidazolinium | ⁿHeptyl | | Br⁻ | MImN^{c} | 534-26-9 |
| 543 | 1-R¹-2-Me-imidazolinium | ⁿHeptyl | | CF₃CO₂⁻ | — | — |
| 544 | 1-R¹-2-Me-imidazolinium | ⁿHexyl | | Br⁻ | MImN^{c} | 534-26-9 |
| 545 | 1-R¹-2-Me-imidazolinium | ⁿHexyl | | CF₃CO₂⁻ | — | — |
| 546 | 1-R¹-2-Ph-imidazolinium | ⁿOctyl | | Br⁻ | PImN^{c} | 936-49-2 |
| 547 | 1-R¹-2-Ph-imidazolinium | ⁿHeptyl | | Br⁻ | PImN^{c} | 936-49-2 |
| 548 | 1-R¹-2-Ph-imidazolinium | ⁿHexyl | | Br⁻ | PImN^{c} | 936-49-2 |
| 549 | 1-R¹-2-Ph-imidazolinium | ⁿPentyl | | Br⁻ | PImN^{c} | 936-49-2 |
| 550 | 5,5′-Me2-3,3′-bipyridinium | nUndecyl | | Br− | 5,5′-Me2-3,3′- | 856796-70-8 |
| | | | | | bipyc | |
| 551 | 3,3′-bipyridinium | ⁿUndecyl | | Br⁻ | 3,3′-bipy^{c} | 581-46-4 |
| 552 | 4-Me₂N-pyridinium^{d} | ⁿNonyl | | Br⁻ | DMAP^{c} | 1122-58-3 |
| 553 | 4-Me₂N-pyridinium^{d} | ⁿUndecyl | | Br⁻ | DMAP^{c} | 1122-58-3 |
| 554 | 4-(1-Pyrrolidino)pyridinium^{d} | ⁿNonyl | | Br⁻ | PyP^{c} | 2456-81-7 |
| 555 | 4-(1-Pyrrolidino)pyridinium^{d} | ⁿUndecyl | | Br⁻ | PyP^{c} | 2456-81-7 |
| 556 | 4-(4-ⁿHeptylphenyl)pyridinium | Methyl | New | Br⁻ | HePP^{c} | 153855-56-2 |

| | Alkylating | | | HPLC Method 9a | |
|---|---|---|---|---|---|
| Nu. | Agent | CAS Num. | Formula | Weight | Time |
| 490 | RⁿX | 693-67-4 | C₁₇H₃₀NBr | 328.336 | 40.3 |
| 491 | — | — | C₁₉H₃₀NO₂F₃ | 375.449 | 40.3 |
| 492 | R¹X | 112-29-8 | C₁₆H₂₈NBr | 314.309 | 37.0 |
| 493 | — | — | C₁₈H₂₈NO₂F₃ | 347.421 | 37.0 |
| 494 | R¹X | 693-58-3 | C₁₅H₂₆NBr | 300.282 | 33.5 |
| 495 | — | — | C₁₇H₂₆NO₂F₃ | 333.394 | 33.5 |
| 496 | R¹X | 693-67-4 | C₂₀H₃₀NBr | 364.371 | 43.0 |
| 497 | — | — | C₂2H₃₀NO₂F₃ | 397.483 | 43.0 |
| 498 | R¹X | 112-29-8 | C₁₉H₂₈NBr | 350.342 | 39.8 |
| 499 | — | — | C₂₁H₂₈NO₂F₃ | 383.454 | 39.8 |
| 500 | R¹X | 693-58-3 | C₁₈H₂₆NBr | 336.315 | 36.5 |
| 501 | — | — | C₂₀H₂₆NO₂F₃ | 369.427 | 36.5 |
| 502 | R¹X | 111-83-1 | C₁₇H₂₄NBr | 322.290 | 33.1 |
| 503 | — | — | C₁₉H₂₄NO₂F₃ | 355.402 | 33.1 |
| 504 | R¹X | 693-67-4 | C₂₀H₃₀NBr | 364.371 | 43.0 |
| 505 | — | — | C₂₂H₃₀NO₂F₃ | 397.483 | 43.0 |
| 506 | R¹X | 112-29-8 | C₁₉H₂₈NBr | 350.342 | 39.9 |
| 507 | — | — | C₂₁H₂₈NO₂F₃ | 383.454 | 39.9 |
| 508 | R¹X | 693-58-3 | C₁₈H₂₆NBr | 336.315 | 36.7 |
| 509 | — | — | C₂₀H₂₆NO₂F₃ | 369.427 | 36.7 |
| 510 | R¹X | 111-83-1 | C₁₇H₂₄NBr | 322.290 | 33.4 |
| 511 | — | — | C₁₉H₂₄NO₂F₃ | 355.402 | 33.4 |
| 512 | R¹X | 693-67-4 | C₁₆H₃₁N₂Br | 331.340 | 40.9 |
| 513 | — | — | C₁₈H₃₁N₂O₂F₃ | 364.452 | 40.9 |
| 514 | R¹X | 112-29-8 | C₁₅H₂₉N₂Br | 317.313 | 37.6 |
| 515 | — | — | C₁₇H₂₉N₂O₂F₃ | 350.425 | 37.6 |
| 516 | R¹X | 693-58-3 | C₁₄H₂₇N₂Br | 303.286 | 34.2 |
| 517 | — | — | C₁₆H₂₇N₂O₂F₃ | 336.398 | 34.2 |
| 518 | R¹X | 693-67-4 | C₂₀H₃₃N₂Br | 381.402 | 44.7 |
| 519 | — | — | C₂₂H₃₃N₂O₂F₃ | 414.514 | 44.7 |
| 520 | R¹X | 112-29-8 | C₁₉H₃₁N₂Br | 367.375 | 41.6 |
| 521 | — | — | C₂₁H₃₁N₂O₂F₃ | 400.487 | 41.6 |
| 522 | R¹X | 693-58-3 | C₁₈H₂₉N₂Br | 353.348 | 38.5 |
| 523 | — | — | C₂₀H₂₉N₂O₂F₃ | 386.460 | 38.5 |
| 524 | R¹X | 111-83-1 | C₁₇H₂₇N₂Br | 339.321 | 35.3 |
| 525 | — | — | C₁₉H₂₇N₂O₂F₃ | 372.433 | 35.3 |
| 526 | 2xR¹X + base | 111-83-1 | C₂₀H₃₉N₂Br | 387.447 | 47.1 |
| 527 | — | — | C₂₂H₃₉N₂O₂F₃ | 420.559 | 47.1 |
| 528 | 2xR¹X + base | 629-04-9 | C₁₈H₃₅N₂Br | 359.393 | 42.0 |
| 529 | — | — | C₂₀H₃₅N₂O₂F₃ | 392.505 | 42.0 |
| 530 | 2xR³X + base | 111-25-1 | C₁₆H₃₁N₂Br | 331.340 | 36.5 |
| 531 | — | — | C₁₈H₃₁N₂O₂F₃ | 364.452 | 36.5 |
| 532 | 2xR¹X + base | 111-83-1 | C₂₅H₄₁N₂Br | 449.518 | 51.9 |
| 533 | 2xR¹X + base | 629-04-9 | C₂₃H₃₇N₂Br | 421.464 | 47.3 |
| 534 | 2xR¹X + base | 111-25-1 | C₂₁H₃₃N₂Br | 393.411 | 42.9 |
| 535 | 2xR¹X + base | 110-53-2 | C₁₉H₂₉N₂Br | 365.357 | 37.5 |
| 536 | 2xR¹X + base | 111-83-1 | C₂₄H₄₁N₂Br | 437.509 | 50.7 |
| 537 | 2xR¹X + base | 629-04-9 | C₂₂H₃₇N₂Br | 409.456 | 45.9 |
| 537b | 2xR¹X + base | 637-59-2 | C₂₆H₂₉N₂Br | 449.426 | 41.0 |
| 537c | — | — | C₂₈H₂₉N₂O₂F₃ | 482.537 | 41.0 |
| 538 | 2xR¹X + base | 111-25-1 | C₂₀H₃₃N₂Br | 381.402 | 40.6 |
| 539 | 2xR¹X + base | 110-53-2 | C₁₈H₂₉N₂Br | 353.348 | 36.1 |
| 540 | 2xR¹X + base | 111-83-1 | C₂₀H₄₁N₂Br | 389.457 | 47.8 |
| 541 | — | — | C₂₂H₄₁N₂O₂F₃ | 422.568 | 47.8 |
| 542 | 2xR¹X + base | 629-04-9 | C₁₈H₃₇N₂Br | 361.404 | 42.7 |
| 543 | 2xR¹X + base | — | C₂₀H₃₇N₂O₂F₃ | 394.515 | 42.7 |
| 544 | 2xR¹X + base | 111-25-1 | C₁₆H₃₃N₂Br | 333.351 | 37.2 |
| 545 | — | — | C₁₈H₃₃N₂O₂F₃ | 366.462 | 37.2 |
| 546 | 2xR¹X + base | 111-83-1 | C₂₅H₄₃N₂Br | 451.526 | 52.8 |
| 547 | 2xR¹X + base | 629-04-9 | C₂₃H₃₉N₂Br | 423.473 | 48.1 |
| 548 | 2xR¹X + base | 111-25-1 | C₂₁H₃₅N₂Br | 395.420 | 43.2 |
| 549 | 2xR¹X + base | 110-53-2 | C₁₉H₃₁N₂Br | 367.367 | 38.1 |
| 550 | 2xR1X | 693-67-4 | C34H58N2Br2 | 654.659 | 46.4 |
| 551 | 2xR¹X | 693-67-4 | C₃₂H₅₄N₂Br₂ | 626.593 | 43.8 |
| 552 | R¹X | 693-58-3 | C₁₆H₂₉N₂Br | 329.325 | 37.2 |
| 553 | R¹X | 693-67-4 | C₁₈H₃₃N₂Br | 357.379 | 43.5 |
| 554 | R¹X | 693-58-3 | C₁₈H₃₁N₂Br | 355.363 | 39.9 |
| 555 | R¹X | 693-67-4 | C₂₀H₃₅N₂Br | 383.417 | 46.2 |
| 556 | R¹X | 74-83-9 | C₁₉H₂₆NBr | 348.328 | 37.3 |

^{c}MIm = 2-methylimidazole, DMIm = 1,2-dimethylimidazole, PIm = 2-phenylimidazole, MImN = 2-methylimidazoline, PImN = 2-phenylimidazoline, MBIm = 1-methylbenzimidazole, DMBIm = 1,2-Dimethylbenzimidazole, DMAP = 4-(dimethylamino)pyridine, PyP = 4-(1-pyrrolidino)pyridine, HePP = 4-(4-ⁿheptylphenyl)pyridine, bipy = bipyridine,
^{d}alkylation at pyridine nitrogen.

TABLE IX
Derivatives of Benzo-18-Crown-6•M⁺Cl⁻
M⁺ = Na⁺, K⁺, NH₄⁺, CH₃NH₃⁺
A

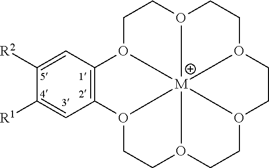

B

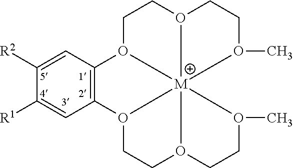

| | | | | | | | | | | | HPLC Method | |
|---|---|---|---|---|---|---|---|---|---|---|---|---|
| | | | CAS | | | | CAS | | CAS | | 9a | |
| Nu. | R¹ | R² | Num. | Cation | Comment | Reactant | Num. | Reactant | Num. | Formula^{b} | Weight^{b} | Time |
| 770 | 4′-H— | 5′-H— | 14098- | K⁺ | (A)Benzo | Catechol | 120- | Pentaethylene- | 57602- | C₁₆H₂₄O₆ | 312.356 | 25.8 |
| | | | 24-9 | | | | 80-9 | glycol dibromide | 02-5 | | | |
| 771 | 4′-Br— | 5′-H— | 75460- | K⁺ | (A) | Benzo-18- | 14098- | NBS | 128-08- | C₁₆H₂₃O₆Br | 391.252 | 32.7 |
| | | | 28-5 | | | Crown-6 | 24-9 | | 5 | | | |
| 772 | 4′Br— | 5′-Br— | 108695- | K⁺ | (A) | Benzo-18- | 14098- | NBS | 128-08- | C₁₆H₂₂O₆Br₂ | 470.148 | 37.4 |
| | | | 32-2 | | | Crown-6 | 24-9 | | 5 | | | |
| 773 | R¹ + R² = | | 17454- | K⁺ | 2,3- | 2,3- | 92-44- | Pentaethylene- | 57602- | C₂₀H₂₆O₆ | 362.414 | 35.4 |
| | 4′,5′-C₄H₄— | | 52-3 | | Nathpho | Naphthalenediol | 4 | glycol dibromide | 02-5 | | | |
| 774 | 4′-C₆H₅— | 5′-H— | New | K⁺ | (A) | 4′-Br-Benzo-18- | 75460- | C₆H₅B(OH)₂ | 98-80-6 | C₂₂H₂₈O₆ | 388.451 | 38.6 |
| | | | | | | C-6 | 28-5 | | | | | |
| 775 | 4′-(4- | 5′-H— | 85420- | K⁺ | (A) | 4′-Br-Benzo-18- | 75460- | p- | 5720- | C₂₃H₃₀O₆ | 402.477 | 41.7 |
| | CH₃C₆H₄)— | | 09-5 | | | C-6 | 28-5 | MeC₆H₄B(OH)₂ | 05-8 | | | |
| 776 | 4′-(4- | 5′-H— | New | — | (B) | 4′-Me-3,4- | New | 2 x | 54149- | C₂₃H₃₂O₆ | 404.493 | 40.5 |
| | CH₃C₆H₄)— | | | | | (OH)₂-biphenyl | | MeOC₂H₄O— | 17-6 | | | |
| | | | | | | | | C₂H₄Br | | | | |
| 777 | 4′-(4- | 5′-H— | New | K⁺ | (A) | 4′-Br-Benzo-18- | 75460- | p-EtC₆H₄B(OH)₂ | 63139- | C₂₄H₃₂O₆ | 416.504 | 44.8 |
| | C₂H₅C₆H₄)— | | | | | C-6 | 28-5 | | 21-9 | | | |
| 778 | 4′-(4- | 5′-H— | New | K⁺ | (A) | 4′-Br-Benzo-18- | 75460- | p- | 134150- | C₂₅H₃₄O₆ | 430.530 | 47.9 |
| | ⁿC₃H₇C₆H₄)— | | | | | C-6 | 28-5 | ⁿPrC₆H₄B(OH)₂ | 01-9 | | | |
| 779 | 4′-(4- | 5′-H— | New | K⁺ | (A) | 4′-Br-Benzo-18- | 75460- | p- | 145240- | C₂₆H₃₆O₆ | 444.557 | 51.0 |
| | ⁿC₄H₉C₆H₄)— | | | | | C-6 | 28-5 | ⁿBuC₆H₄B(OH)₂ | 28-4 | | | |
| 780 | 4′-(4- | 5′-H— | New | K⁺ | (A) | 4′-Br-Benzo-18- | 75460- | p-ⁿC₅H₁₁— | 121219- | C₂₇H₃₈O₆ | 458.583 | 54.0 |
| | ⁿC₅H₁₁C₆H₄)— | | | | | C-6 | 28-5 | C₆H₄B(OH)₂ | 12-3 | | | |

^{b}cation-free crown ether

1. A process for separating organic compounds from a mixture by reverse-phase displacement chromatography, comprising:
providing a hydrophobic stationary phase;
applying to the hydrophobic stationary phase a mixture comprising organic compounds to be separated;
displacing the organic compounds from the hydrophobic stationary phase by applying thereto an aqueous composition comprising a non-surface active hydrophobic cationic displacer molecule and about 10 wt % or less of an organic solvent; and
collecting a plurality of fractions eluted from the hydrophobic stationary phase containing the separated organic compounds;
wherein the non-surface active hydrophobic cationic displacer molecule comprises a hydrophobic cation and a counterion, CI, having the general formula A or B: 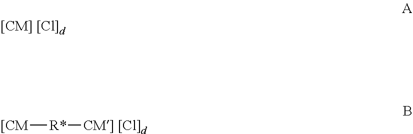
wherein in the general formulae A and B, each CM or CM′ is an independent hydrophobic chemical moiety with a formal charge selected from: quaternary ammonium (I), quaternary phosphonium (II), sulfonium (III), sulfoxonium (IV), imidazolinium (amidinium) (V), guanidinium (VI), imidazolium (VII), 1,2,3,4-tetrahydroisoquinolinium (VIII), 1,2,3,4-tetrahydroquinolinium (IX), isoindolinium (X), indolinium (XI), benzimidazolium (XII), pyridinium (XIIIa, XIIIb, XIIIc, XIIId), quinolinium (XIV), isoquinolinium (XV), carboxylate (XVI), N-acyl-α-amino acid (XVII), sulfonate (XVIII), sulfate monoester (XIX), phosphate monoester (XX), phosphate diester (XXI), phosphonate monoester (XXII), phosphonate (XXIII), tetraaryl borate (XXIV), boronate (XXV), boronate ester (XXVI); wherein the chemical moieties (I)-(XXVI) have the following chemical structures: 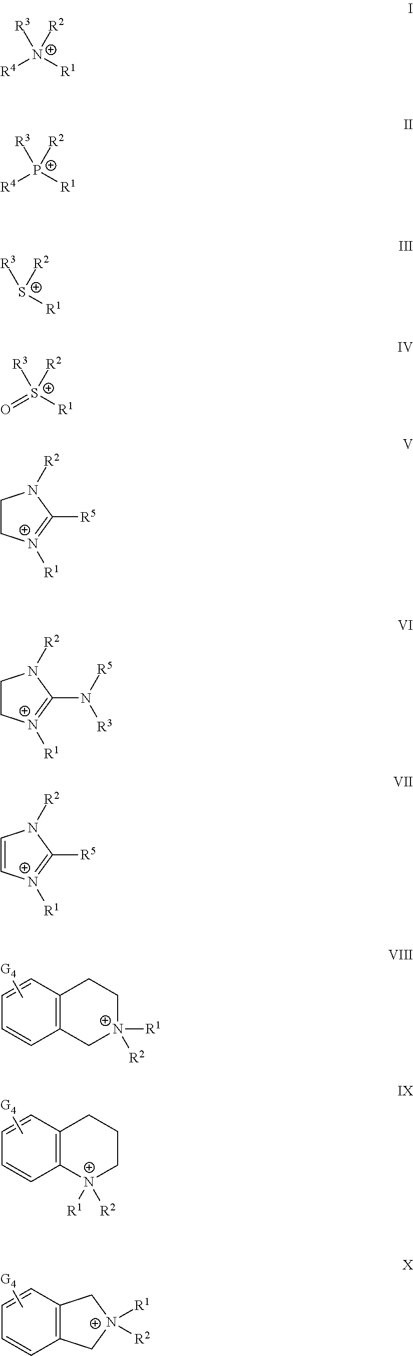 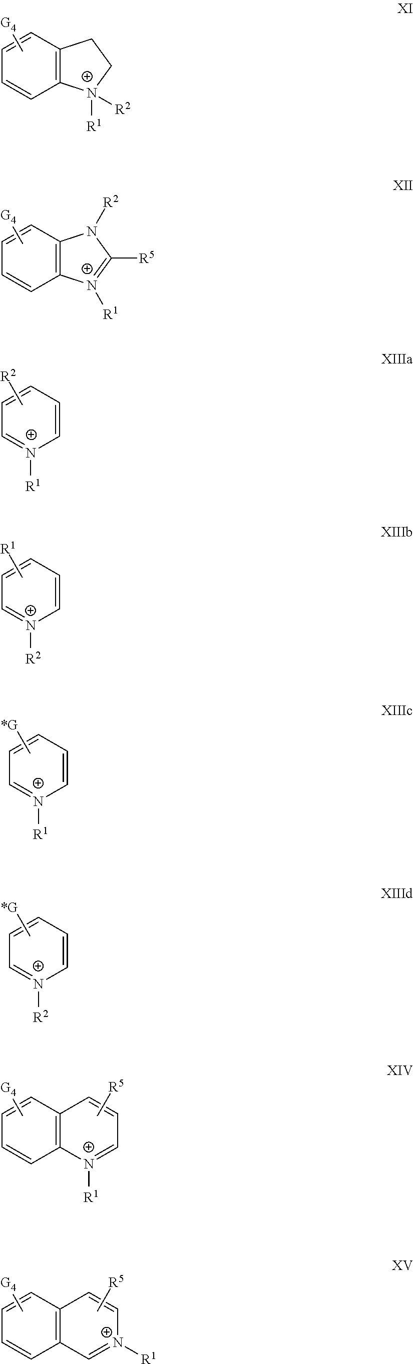 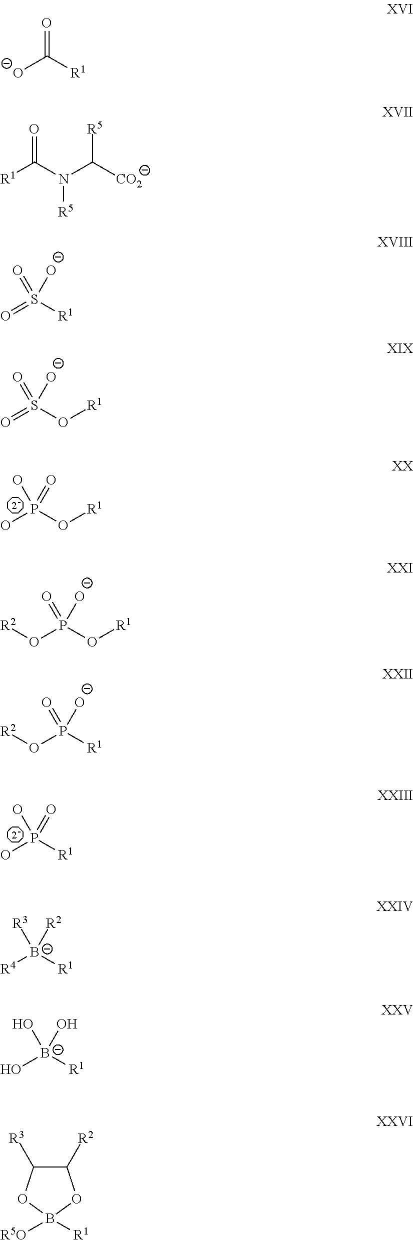
wherein in general formula B, CM and CM′ are independent charged chemical moieties having the same or opposite formal charge and are chemically attached to each other by a doubly connected chemical moiety, R*, which replaces one R¹, R² (if present), R³ (if present) or R⁴ (if present) chemical moiety on CM and replaces one R¹, R² (if present), R³ (if present) or R⁴ (if present) chemical moiety on CM′;
wherein each of R¹, R², R³ and R⁴ is a linear or branched chemical moiety independently defined by the formula,
—CₓX₂ₓ₋₂ᵣ-AR¹—CᵤX₂ᵤ₋₂ₛ-AR²,
R* is a direct chemical bond or is a doubly connected, linear or branched chemical moiety defined by the formula,
—CₓX₂ₓ₋₂ᵣAR¹—CᵤX₂ᵤ₋₂ₛ—,
and R⁵ is a linear or branched chemical moiety defined by the formula,
—CₓX₂ₓ₋₂ᵣ-AR²;
wherein each AR′ independently is a doubly connected methylene moiety (—CX¹X²—, from methane), a doubly connected phenylene moiety (—C₆G₄-, from benzene), a doubly connected naphthylene moiety (—C₁₀G₆-, from naphthalene) or a doubly connected biphenylene moiety (—C₁₂G₈-, from biphenyl);
wherein AR² independently is hydrogen (—H), fluorine (—F), a phenyl group (—C₆G₅), a naphthyl group (—C₁₀G₇) or a biphenyl group (—C₁₂G₉);
wherein each X, X¹ and X² is individually and independently —H, —F, —Cl or —OH;
wherein any methylene moiety (—CX¹X²—) within any —CₓX₂ₓ₋₂ᵣ— or within any —CᵤX₂ᵤ₋₂ₛ— or within any —(CX¹X²)ₚ— may be individually and independently replaced with an independent ether-oxygen atom, —O—, an independent thioether-sulfur atom, —S—, or an independent ketone-carbonyl group, —C(O)—, in such a manner that each ether-oxygen atom, each thioether-sulfur atom or each ketone-carbonyl group is bonded on each side to an aliphatic carbon atom or an aromatic carbon atom;
wherein not more than two ether-oxygen atoms, not more than two thioether-sulfur atoms and not more than two ketone-carbonyl groups may be replaced into any —CₓX₂ₓ₋₂ᵣ— or into any —CᵤX₂ᵤ₋₂ₛ—;
wherein mₓ is the total number of methylene groups in each —CₓX₂ₓ₋₂ᵣ— that are replaced with ether-oxygen atoms, thioether-sulfur atoms and ketone-carbonyl groups, and mᵤ is the total number of methylene groups in each —C—X₂ᵤ₋₂ₛ— that are replaced with ether-oxygen atoms, thioether-sulfur atoms and ketone-carbonyl groups;
wherein G is individually and independently any combination of —H, —F, —Cl, —CH₃, —OH, —OCH₃, —N(CH₃)₂, —CF₃, —CO₂Me, —CO₂NH₂; —CO₂NHMe, —CO₂NMe₂;
wherein G* is individually and independently any combination of —F, —Cl, —R², —OH, —OR², —NR²R³, —CF₃, —CO₂Me, —CO₂NH₂; —CO₂NHMe, —CO₂NMe₂;
wherein a pair of R², R³, and R⁴ may comprise a single chemical moiety such that R²/R³, R²/R⁴, R³/R⁴, R^{2′}/R^{3′}, R^{2′}/R^{4′} or R^{3′}/R^{4′} is individually and independently —(CX¹X²)ₚ— with p=3, 4, 5 or 6;
wherein the integer values of each of x, r, u, s, mₓ, mᵤ are independently selected for each R¹, R², R³, R⁴, R⁵ and R*, integer values r and s are the total number of contained, isolated cis/trans olefinic (alkene) groups plus the total number of contained simple monocyclic structures and fall in the ranges 0≦r≦2 and 0≦s≦2, the numeric quantity x+u−mₓ−mᵤ falls in the range 0≦x+u−mₓ−mᵤ≦11;
wherein at least one aromatic chemical moiety, heterocyclic aromatic chemical moiety, imidazoline chemical moiety, amidine chemical moiety or guanidine chemical moiety is contained within CM or CM′ of A or B;
wherein a group-hydrophobic-index for each R-chemical-moiety (n) is numerically equal to the sum of the number of aliphatic carbon atoms plus the number of olefinic carbon atoms plus the number of thioether-sulfur atoms plus the number of chlorine atoms plus one-fifth the number of fluorine atoms plus one-half the number of ether-oxygen atoms plus one-half the number of ketone-carbon atoms plus one-half the number of aromatic carbon atoms beyond the number six minus the number of hydroxyl-oxygen atoms beyond the number one;
wherein an overall-hydrophobic-index (N) for each [CM] or [CM-R*-CM] is numerically equal to the sum of the number of aliphatic carbon atoms plus the number of olefinic carbon atoms plus the number of thioether-sulfur atoms plus the number of chlorine atoms plus one-fifth the number of fluorine atoms plus one-half the number of ether-oxygen atoms plus one-half the number of ketone-carbon atoms plus one-half the number of aromatic carbon atoms beyond the number six minus the number of hydroxyl-oxygen atoms beyond the number one;
wherein the group-hydrophobic-indices (¹n and ^{1′}n) for R¹ and R^{1′} fall in the range 4.0<¹n, ^{1′}n<12.0, the group-hydrophobic-indices (²n, ^{2′}n, ³n, ^{3′}n, ⁵n, ^{5′}n and *n) for R², R^{2′}, R³, R^{3′}, R⁵, R^{5′}, R*, when present, fall in the range 0.0≦²n, ^{2′}n, ³n, ^{3′}n, ⁵n, ^{5′}n, *n<12.0 and the group-hydrophobic-indices (⁴n and ^{4′}n) for R⁴ and R^{4′}, when present, fall in the range 0.0≦⁴n, ^{4′}n≦5.0;
wherein the overall-hydrophobic-index (N) divided by the value of g falls in the range 10.0≦N/g<24.0;
wherein in A, when the charged moiety, CM, has a formal positive charge or a formal negative charge, g=1, and in B, when CM and CM′ have formal positive charges or when CM and CM′ have formal negative charges, g=2, and in B when CM has a formal positive charge and CM′ has a formal negative charge, g=1;
wherein the numeric value of the group-hydrophobic-index calculated for a cyclic chemical moiety is divided equally between the two respective R-chemical-moieties;
wherein R¹ is identified as that R-chemical-moiety when only one such chemical moiety is attached to CM or CM′; wherein R¹ is identified as that R-chemical-moiety having the largest value of the group-hydrophobic-index when there are more than one such chemical moieties attached to CM or CM′; wherein R⁴ is identified as that R-chemical-moiety having the smallest value of the group-hydrophobic-index when there are more than three such chemical moieties attached to CM or CM′; and
wherein CI is a non-interfering, oppositely-charged counter-ion or mixture of such counter-ions, and the value of d is zero, a positive whole number or a positive fraction such that electroneutrality of the overall hydrophobic compound is maintained.

2. The process of claim 1 wherein the aqueous composition comprising a non-surface active hydrophobic displacer molecule is free of added salt other than a pH buffer.

3. The process of claim 1 wherein CM has a general formula I or II: 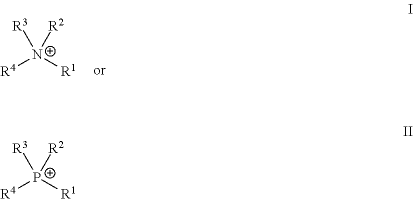
wherein in the general formula I or II, R¹ is a C₈-C₁₁ hydrocarbyl moiety, R² and R³ are independently a C₁-C₄ hydrocarbyl moiety or benzyl, and R⁴ is selected from benzyl, halo-substituted benzyl, 4-alkylbenzyl, 4-trifluoromethyl benzyl, 4-phenylbenzyl, 4-alkoxybenzyl, 4-acetamidobenzyl, H₂NC(O)CH₂—, PhHNC(O)CH₂—, dialkyl-NC(O)CH₂—, wherein alkyl is C₁-C₄, provided that no more than one benzyl group is present in the CM.

4. The process of claim 1 wherein CM has a general formula I or II: 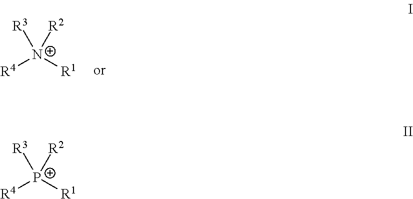
wherein in the general formula I or II, R¹ and R² are independently C₄-C₈ alkyl or cyclohexyl, R³ is C₁-C₄ alkyl, and R⁴ is phenyl, 2-, 3- or 4-halophenyl, benzyl, 2-, 3- or 4-halobenzyl, 2,3-, 2,4-, 2,5-, 2,6-, 3,4- or 3,5-dihalobenzyl, 2,4,6- or 3,4,5-trihalobenzyl, C₆H₅CH₂CH₂— or 2-, 3- or 4-trifluoromethylbenzyl.

5. The process of claim 1 wherein CM has a general formula VIII, IX, X or XI, R¹ is C₅-C₁₁ alkyl and R² is C₁-C₈ alkyl.

6. The process of claim 1 wherein CM has a general formula I or II: 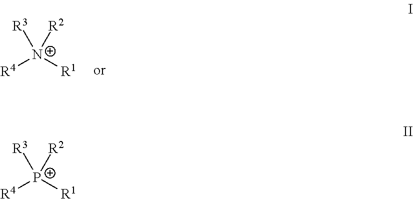
wherein in the general formula I or II, R¹ is C₆-C₁₁ alkyl, R² and R³ independently are C₁-C₄ alkyl, and R⁴ is PhC(O)CH₂—, 4-FC₆H₄C(O)CH₂—, 4-CH₃C₆H₄C(O)CH₂—, 4-CF₃C₆H₄C(O)CH₂—, 4-ClC₆H₄C(O)CH₂—, 4-BrC₆H₄C(O)CH₂—, dl-PhC(O)CH(Ph)-, Ph(CH₂)₂—, Ph(CH₂)₃—, Ph(CH₂)₄—, dl-PhCH₂CH(OF)CH₂—, t-PhCH═CHCH₂—, 1-(CH₂)naphthylene, 9-(CH₂)anthracene, 2-, 3- or 4-FC₆H₄CH₂— or benzyl.

7. The process of claim 1 wherein CM has a general formula I or II: 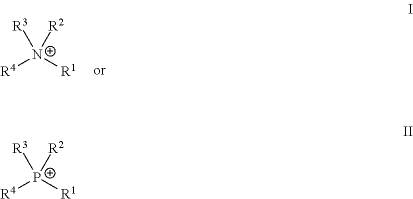
wherein in the general formula I or II, R¹ is C₆-C₁₁ alkyl, R² and R³ together are —(CH₂)₄—, and R⁴ is PhC(O)CH₂—, 4-FC₆H₄C(O)CH₂—, 4-CH₃C₆H₄C(O)CH₂—, 4-CF₃C₆H₄C(O)CH₂—, 4-ClC₆H₄C(O)CH₂—, 4-BrC₆H₄C(O)CH₂—, dl-PhC(O)CH(Ph)-, Ph(CH₂)₂—, Ph(CH₂)₃—, Ph(CH₂)₄—, dl-PhCH₂CH(OH)CH₂—, t-PhCH═CHCH₂—, 2-, 3- or 4-FC₆H₄CH₂—, benzyl, 3-ClC₆H₄CH₂—, 2,6-F₂C₆H₃CH₂—, 3,5-F₂C₆H₃CH₂—, 4-CH₃C₆H₄CH₂—, 4-CH₃CH₂C₆H₄CH₂—, 4-CH₃OC₆H₄CH₂—, (CH₃)₂NC(O)CH₂— or (CH₃CH₂)₂NC(O)CH₂—.

8. The process of claim 1 wherein CM has a general formula I or II: 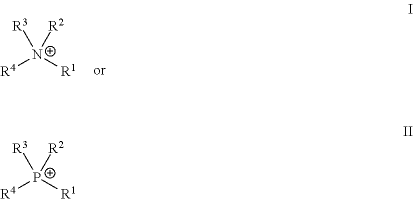
wherein in the general formula I or II, R¹ is C₄-C₆ alkyl, benzyl or 2-, 3- or 4-FC₆H₄CH₂—, R² and R³ independently are C₁-C₈ alkyl, CH₃(OCH₂CH₂)₂—, CH₃CH₂OCH₂CH₂OCH₂CH₂— or CH₃CH₂OCH₂CH₂—, and R⁴ is Ph(CH₂)₄—, 4-PhC₆H₄CH₂—, 4-FC₆H₄CH₂—, 4-CF₃C₆H₄CH₂—, PhC(O)CH₂—, 4-FC₆H₄C(O)CH₂—, 4-PhC₆H₄C(O)CH₂—, 4-PhC₆H₄CH₂—, naphthylene-1-CH₂—, anthracene-9-CH₂— or Ph(CH₂)ₙ—, where n=5-8.

9. The process of claim 1 wherein CM has a general formula [(R¹R²R³NCH₂)₂C₆H₃G]²⁺, wherein R¹ is C₄-C₁₁ alkyl, R² and R³ independently are C₁-C₆ alkyl or R² and R³ taken together are —(CH₂)₄—, and G is H or F.

10. The process of claim 1 wherein CM has a general formula [R¹R²R³NCH₂C₆H₄—C₆H₄CH₂NR¹R²R³]²⁺, wherein R¹ is C₄-C₁₁ alkyl, R² and R³ independently are C₁-C₆ alkyl or R² and R³ taken together are —(CH₂)₄—.

11. The process of claim 1 wherein CM has a general formula III or IV: 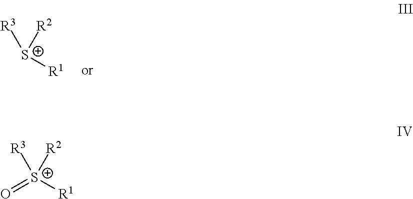
wherein in the general formula III or IV, R¹ is C₈-C₁₁ alkyl or 4,4′-CH₃(CH₂)₄C₆H₄—C₆H₄CH₂—, R² is C₁-C₆ alkyl or 4-FC₆H₄CH₂—, and R³ is C₁-C₆ alkyl.

12. The process of claim 1 wherein CM has a general formula XIV or XV: 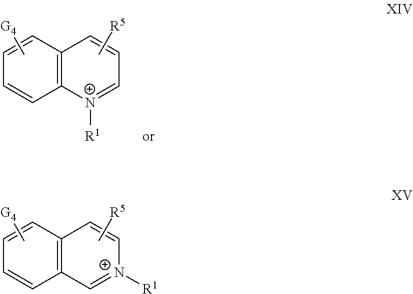
wherein in the general formula XIV or XV, R¹ is C₈-C₁₁ alkyl, and each G and R⁵ are as defined above.

13. The process of claim 1 wherein CM has a general formula XIIIa, XIIIb, XIIIc, XIIId or XIIIe: 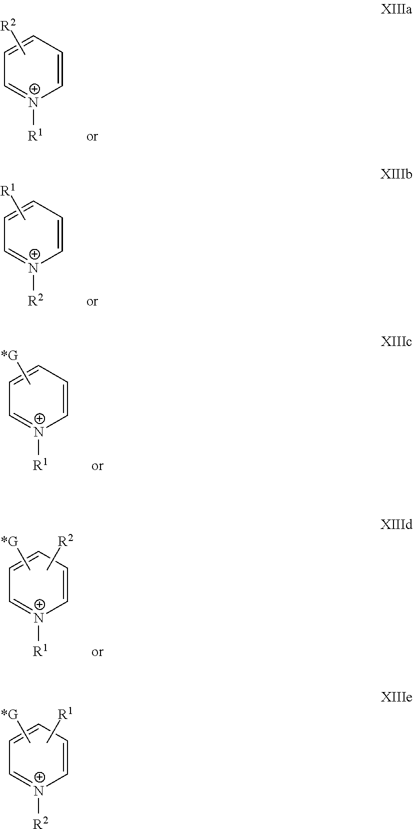
wherein in the general formula XIIIa, XIIIb, XIIIc, XIIId or XIIIe, R¹ is C₈-C₁₁ alkyl or C₈-C₁₁ 4-phenyl, R² is H, C₁-C₆ alkyl or alkoxy, 2-pyridyl, C₁-C₆ alkyl substituted 2-pyridyl, or pyrrolidinyl, and each G is as defined above.

14. The process of claim 1 wherein CM has a general formula VII: 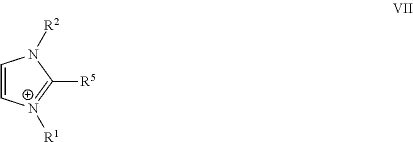
wherein in the general formula VII, R¹ is C₅-C₁₁ alkyl, R² and R⁵ are independently H or C₁-C₆ alkyl or phenyl.

15. The process of claim 1 wherein CM has a general formula XII: 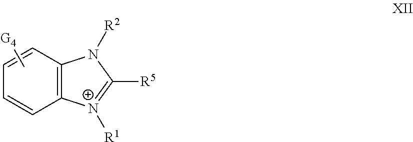
wherein in the general formula XII, R¹ is C₅-C₁₁ alkyl, R² and R⁵ are independently H or C₁-C₆ alkyl or phenyl, and G is as defined above.

16. The process of claim 1 wherein CM has a general formula XXIV or XXV: 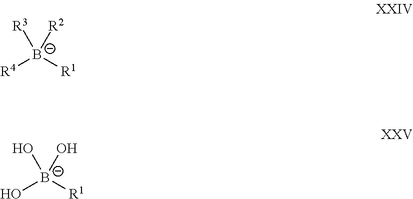
wherein in the general formula XXIV, R¹ is phenyl, 4-EtC₆H₄—, 4-ⁿPrC₆H₄—, 4-ⁿBuC₆H₄—, 4-MeOC₆H₄—, 4-FC₆H₄—, 4-MeOC₆H₄—, 4-MeOC₆H₄—, 4-EtC₆H₄—, 4-ClC₆H₄—, or C₆F₅—; and each of R2, R3 and R4 independently are phenyl, 4-FC₆H₄—, 4-MeC₆H₄—, 4-MeOC₆H₄—, 4-EtC₆H₄—, 4-ClC₆H₄— or C₆F₅—; and
wherein in the general formula XXV, R1 is 4-(4-ⁿBuC₆H₄)C₆H₄— or 4-(4-ⁿBuC₆H₄)-3-ClC₆H₃—

17. The process of claim 1 wherein CM has a general formula selected from 4-R¹C₆H₄SO₃H, 5-R¹-2-HO—C₆H₃SO₃H, 4-R¹—C₆H₄—C₆H₃X-4′-SO₃H, and 4-R¹—C₆H₄—C₆H₃X-3′-SO₃H, wherein R1 is CH₃(CH₂)ₙ, wherein n=4-10 and X is H or OH.

18. The process of claim 1 wherein CM has a general formula XVIII or XXIII: 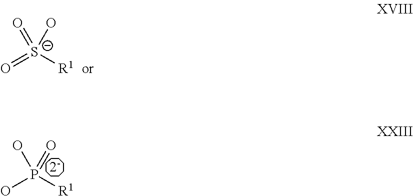
wherein in the general formula XVIII and in the general formula XXIII, R¹ is C₆H₅(CH₂)ₙ—, wherein n=5-11.

19. The process of claim 1 wherein CM has a general formula selected from 5-R¹-2-HO—C₆H₃CO₂H and R¹C(O)NHCH(C₆H₅)CO₂H, wherein R¹ is CH₃(CH₁₂)ₙ—, wherein n=4-10.

20. The process of claim 1 wherein CM has a general formula 4-R¹C₆H₄PO₃H₂ wherein R¹ is CH₃(CH₂)ₙ—, wherein n=4-10.

21. The process according to claim 1 wherein CI is a non-interfering anion or mixture of non-interfering anions selected from: Cl⁻, Br⁻, I⁻, OH⁻, F⁻, OCH₃⁻, d,l-HOCH₂CH(OH)CO₂⁻, HOCH₂CO₂⁻, HCO₂⁻, CH₃CO₂⁻, CHF₂CO₂⁻, CHCl₂CO₂⁻, CHBr₂CO₂⁻, C₂H₅CO₂⁻, C₂F₅CO₂⁻, ⁿC₃H₇CO₂⁻, ⁿC₃F₇CO₂⁻, CF₃CO₂⁻, CCl₃CO₂⁻, CBr₃CO₂⁻, NO₃⁻, ClO₄⁻, BF₄⁻, PF₆⁻, HSO₄⁻, HCO₃⁻, H₂PO₄⁻, CH₃OCO₂⁻, CH₃OSO₃⁻, CH₃SO₃⁻, C₂H₅SO₃⁻, NCS⁻, CF₃SO₃⁻, H₂PO₃⁻, CH₃PO₃H⁻, HPO₃²⁻, CH₃PO₃²⁻, CO₃²⁻, SO₄²⁻, HPO₄²⁻, PO₄³⁻.

22. The process according to claim 16 wherein CI is a non-interfering inorganic cation or mixture of such non-interfering cations selected from the groups: alkali metal ions (Li⁺, Na⁺, K⁺, Rb⁺, Cs⁺), alkaline earth metal ions (Mg²⁺, Ca²⁺, Sr²⁺, Ba²⁺), divalent transition metal ions (Mn²⁺, Zn²⁺) and NH₄⁺; wherein CI is a non-interfering organic cation or mixture of such non-interfering cations selected from the groups: protonated primary amines (1+), protonated secondary amines (1+), protonated tertiary amines (1+), protonated diamines (2+), quaternary ammonium ions (1+), sulfonium ions (1+), sulfoxonium ions (1+), phosphonium ions (1+), bis-quaternary ammonium ions (2+) that may contain C₁-C₆ alkyl groups and/or C₂-C₄ hydroxyalky groups.
